(19) United States
(12) Patent Application Publication
(10) Pub. No.: US 2026/0030590 A1
(43) Pub. Date: Jan. 29, 2026

(54) SYSTEMS AND METHODS FOR SPLITTING FOOD ORDERS BETWEEN USERS

(71) Applicant: Legacy of 3 Ventures LLC, San Antonio, TX (US)

(72) Inventor: Sameer Mehta, San Antonio, TX (US)

(73) Assignee: Legacy of 3 Ventures LLC, San Antonio, TX (US)

(21) Appl. No.: 19/279,463

(22) Filed: Jul. 24, 2025

Related U.S. Application Data
(60) Provisional application No. 63/675,373, filed on Jul. 25, 2024.

(51) Int. Cl. G06Q 10/087; G06Q 20/22

(52) U.S. Cl. CPC G06Q 10/0874; G06Q 20/22

(57) ABSTRACT

A computing system is disclosed for generating fulfillment-ready coordination sessions based on tokenized item data and user-submitted participation parameters. The system ingests structured, semi-structured, or unstructured item data from merchant sources and applies schema-aligned transformation logic to normalize the data into structured item representations. The normalized records are tokenized into machine-readable item tokens that encode fulfillment constraints and canonical attributes. The system receives user item selections and associated participation parameters, encodes the item tokens and participation data into structured vector embeddings, and applies compatibility scoring logic using vector comparison and rule-based threshold evaluation. Compatibility scores are evaluated against session eligibility constraints derived from the item tokens. When eligibility conditions are met, the system generates a coordination session payload comprising match outcomes, proportional pricing, and fulfillment metadata, and issues orchestration instructions to external fulfillment systems for group-based delivery or preparation execution.

### CROSS-REFERENCE TO RELATED APPLICATIONS

This application claims priority to U.S. Provisional Patent Application No. 63/675,373, entitled “Systems and Methods for Splitting Food Orders Between Users,” filed on Jul. 25, 2024, the entire disclosure of which is incorporated herein by reference in its entirety.

### FIELD OF THE ART

The systems and methods disclosed herein relate generally to distributed data processing systems and, more specifically, to systems and methods for multi-user compatibility modeling, structured item grouping, and fulfillment coordination across shared digital events.

### BACKGROUND

### Discussion of the State of the Art

Conventional ordering systems are architected for isolated, single-user transactions and lack the infrastructure to support asynchronous, multi-user coordination around item-level ordering decisions. These systems typically rely on static menus, fixed pricing models, and rigid workflows that do not accommodate shared consumption logic, collaborative input from distributed participants, or dynamic matching of partial orders across users. Existing food delivery and group-ordering systems—such as DoorDash, Uber Eats, or Grubhub—support shared carts or scheduled group delivery, but do not tokenize items, model partial alignment, or dynamically match independent users based on compatibility vectors. These systems are synchronous and dependent on participants interacting in real-time or through a single initiating account.

Existing platforms for digital ordering treat menu selection, payment, and fulfillment as linear processes bound to a single account or session. These implementations lack mechanisms to partition items into shareable portions, synchronize user intent across asynchronous sessions, or reconcile group selections against merchant-defined fulfillment constraints such as time windows, portion minimums, or routing directives. Further, platforms like FoodClique and MealPal lack flexibility in fulfillment modalities and do not support merchant-configurable logic such as splittability flags, scheduling constraints, or upsell prompts.

Current systems also fail to support compatibility modeling across user-defined participation parameters such as portion selection, fulfillment modality, or dietary constraints. Recommendation engines, if present, are focused on search filtering or individual scoring—not on compatibility evaluation for group-based item fulfillment. As a result, current systems cannot evaluate configuration compatibility across multiple submissions, resolve partial matches, or optimize session outcomes based on evolving fulfillment conditions. Social discovery is absent—users cannot join sessions based on taste vector similarity or geographic affinity.

Item ingestion workflows remain tightly coupled to structured API formats or fixed schema conventions. These systems cannot adapt to heterogeneous merchant records such as scanned menus, scraped catalogs, or semi-structured exports. No normalization layer exists to align portion definitions, naming conventions, splittability flags, or fulfillment metadata across inconsistent data sources.

Existing platforms do not integrate structured feedback into matching or fulfillment workflows. Session-level data—such as completion rates, configuration satisfaction, or modifier preferences—are not incorporated into adaptive ranking or matching logic. Similarly, there is no support for real-time upselling prompts, reward issuance tied to session behavior, or opt-in fallback modes when coordination thresholds are unmet.

Further, current systems do not support geo-taste clustering, influencer-driven broadcasts, or social coordination via taste vector alignment. There is no infrastructure for merchant-configurable revenue logic, public-private session handling, or tokenized item modeling for compatibility and orchestration. No known system integrates vector-based latent matching, asynchronous fulfillment thresholds, and token-level compatibility modeling in a way that supports deferred execution, fallback solo ordering, or structured session attribution for social and commercial incentives. Accordingly, there remains a need for computing systems that support distributed coordination, schema normalization, token-based fulfillment modeling, and adaptive session workflows across asynchronous, multi-user environments.

### SUMMARY

Systems and methods in accordance with various embodiments of the present disclosure may overcome one or more of the aforementioned and other deficiencies experienced in conventional approaches to order coordination, item-based fulfillment, and multi-user transaction processing. In particular, various embodiments describe systems and methods for structured compatibility resolution, tokenized item orchestration, and distributed fulfillment workflows in environments that support multi-user interaction and dynamic participation thresholds. In certain embodiments, the system further incorporates user segmentation, taste clustering, and reward issuance tied to session completion, enabling a feedback-driven loop for engagement, social coordination, and behavioral adaptation.

In various embodiments, a computing system receives item selection inputs from multiple users. These item inputs may be derived from structured menus, merchant interfaces, or dynamically generated product offerings. Each item is tokenized into a structured representation and associated with metadata attributes including availability, quantity limits, and compatibility markers. The system aggregates individual item inputs into a compatibility modeling layer, which evaluates whether the combined inputs satisfy a predefined fulfillment threshold, such as minimum item quantity or group price level. The system may further support user-defined fallback logic, including time-based auto-execution or solo conversion triggers if compatibility conditions are not met within a specified duration.

Upon reaching a fulfillment threshold, the system is operable to initiate orchestration workflows. In an embodiment, a fulfillment orchestration module generates execution instructions for routing, scheduling, and item handoff across delivery agents, merchant locations, or digital service endpoints. The system coordinates matched item groups by partitioning routing logic, synchronizing delivery resources, and issuing fulfillment triggers based on participant proximity, merchant constraints, and system load. The orchestration process is schema-aligned, enabling integration with external logistics platforms or modular routing services. Merchant-defined upsell prompts, availability overrides, and pricing modifiers may be dynamically injected into the orchestration instructions, supporting monetization logic and order value optimization.

In certain embodiments, a compatibility engine evaluates both direct item overlap and latent preference alignment. For example, user embeddings may be generated using historical item vectors, enabling the system to surface matches even when user selections are only partially aligned. A partial match handler can defer execution until additional compatible users join, while a preference synthesis module evaluates inferred compatibility for users with incomplete or ambiguous preferences. These embeddings may also be clustered by geolocation, dietary preference, or cuisine affinity, enabling taste-based group discovery and targeted coordination among regionally-aligned users.

In various embodiments, the system supports merchant-defined fulfillment constraints. These may include splittability flags, fulfillment modality restrictions (e.g., dine-in only), and schedule windows. Merchants may configure rules via schema-conformant configuration interfaces, which are enforced during item matching and fulfillment planning. For example, a merchant may define that a specific item can be split by up to four users only on weekends during lunch hours. These constraints are evaluated in real time by the system before issuing fulfillment instructions. Additionally, merchants may define minimum pricing thresholds for shared fulfillment, override logic for excess inventory specials, or dynamic eligibility controls to promote specific dish combinations based on system telemetry.

In an embodiment, the system includes feedback ingestion modules that incorporate ranked reviews, external reputation signals, and observed delivery performance. These signals may be semantically parsed, aligned with structured schemas, and used to reweight item compatibility scores or influence future match logic. For example, poor delivery reliability for a given location may trigger automatic exclusion from candidate matches. Reweighted vectors may influence real-time prioritization during orchestration. Dish-level feedback may include structured data on group satisfaction, portion consistency, or modifier quality, supporting reinforcement modeling and match re-ranking across future coordination sessions.

Embodiments further support event creation, promotion logic, and social match routing, enabling the creation of private or public ordering sessions. Events can include user-defined or merchant-defined constraints such as time windows, minimum group sizes, and item locks. Social engagement may be facilitated by match broadcasting, notification triggers, or incentive unlocks once participation thresholds are met. In some embodiments, publicly promoted coordination sessions may include influencer-sourced sessions, taste-based user matching, and optional opt-in channels for in-person meetups facilitated by fulfillment context and user preferences.

The system architecture accommodates ingestion from external merchant systems, promotional metadata APIs, social recommendation graphs, and real-time delivery logistics networks. Each ingestion channel is normalized through schema-conformant data adapters and routed through modular enrichment workflows. These ingestion channels allow the system to operate across industries, including food services, retail group buys, digital subscriptions, and shared service offerings. Cross-industry support may further leverage session token telemetry and reward system state to customize campaign strategies or fulfillment promotions.

Further, by decoupling item selection from traditional linear ordering flows, the system introduces a dynamic data exchange model that enables deferred execution, partial resolution, and shared fulfillment workflows—all within a unified resource management framework. The system supports a pipeline of ingesting real-world project offerings, structuring those offerings into tokenized elements, resolving compatibility across users, and translating matches into distributed fulfillment instructions. In certain embodiments, reward allocation, referral chains, or user streak incentives are generated during this pipeline, and stored as session-bound metadata.

Advantageously, the disclosed systems improve the technical field of distributed coordination and item-level fulfillment in multi-user environments. The system uses schema-aligned item transformation, match resolution workflows, and fulfillment synchronization logic to orchestrate distributed consumption of shared item groupings. This includes runtime orchestration logic that tracks telemetry, adjusts thresholds, and reassigns logistics assignments in response to system state. When coupled with data clustering, reliability scoring, and social discovery workflows, these orchestration mechanics further enable reinforcement-based adaptation and market-specific optimization.

Additionally, machine-executed matching and cost allocation logic relieves user devices from managing individual coordination tasks and replaces ad hoc matching with deterministic compatibility evaluation. System performance metadata and routing adjustments based on runtime telemetry enable fine-tuned orchestration and dynamic adjustment across multiple order sessions. Session-specific feedback, reward state, and vector-based rankings may be applied to improve subsequent match quality, retention, and engagement.

By enabling tokenization of item offerings, structured compatibility resolution, and distributed coordination across user groups, the disclosed system overcomes limitations associated with conventional, siloed ordering processes and supports broader platform applicability across industries requiring flexible group fulfillment. These features, in aggregate, enable fulfillment architectures that integrate monetization workflows, social participation models, and adaptive control logic across both merchant and user interfaces.

Various other functions and advantages are described and suggested below as may be provided in accordance with the various embodiments.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting of the scope of the invention or the claims herein in any way.

FIG. 1 illustrates a system architecture for coordinating item-based fulfillment sessions using tokenized item data and user participation inputs, in accordance with various embodiments.

FIG. 2 illustrates components used to ingest, standardize, and structure merchant-provided item data, in accordance with various embodiments.

FIG. 3 illustrates system behavior for generating coordination sessions based on item data and user inputs, in accordance with various embodiments.

FIG. 4 illustrates components for extracting, tagging, and transforming merchant item data into structured representations, in accordance with various embodiments.

FIG. 5 illustrates components for managing merchant integration, payload generation, and orchestration triggers, in accordance with various embodiments.

FIG. 6 illustrates a process for evaluating user participation, computing compatibility, and initiating fulfillment, in accordance with various embodiments.

FIG. 7 illustrates a process for normalizing item data and generating structured item tokens, in accordance with various embodiments.

FIG. 8 illustrates a process for grouping user selections, applying match scoring, and finalizing session parameters, in accordance with various embodiments.

FIG. 9 illustrates a process for managing hosted or event-based group ordering experiences, in accordance with various embodiments.

FIG. 10 illustrates one embodiment of the computing architecture that supports an embodiment of the inventive disclosure.

FIG. 11 illustrates components of a system architecture that supports an embodiment of the inventive disclosure.

FIG. 12 illustrates components of a computing device that supports an embodiment of the inventive disclosure.

FIG. 13 illustrates components of a computing device that supports an embodiment of the inventive disclosure.

### DETAILED DESCRIPTION

The embodiments described herein relate to systems and methods for distributed compatibility modeling, tokenized item orchestration, and multi-user fulfillment coordination. The system is operable to receive structured and unstructured representations of item offerings, tokenize and normalize item records into a schema-aligned data model, evaluate multi-user compatibility based on runtime compatibility metrics and predefined thresholds, and generate distributed fulfillment instructions based on matched groupings. In various embodiments, the system includes components for ingestion and transformation of merchant-provided item data, real-time coordination of user-submitted selections, compatibility scoring and deferred resolution, schema-conformant rule enforcement, and fulfillment orchestration across delivery, pickup, or localized service environments. The system supports asynchronous, distributed interactions between users and external services, enabling dynamic allocation, conditional execution, and enriched feedback propagation based on fulfillment outcome telemetry, user preference signals, and item-specific constraints.

Accordingly, in accordance with various embodiments, the system is operable to coordinate distributed item selection and fulfillment across multiple participants by transforming user-submitted selection data—such as candidate item records, quantity parameters, and fulfillment preferences—into schema-aligned, matchable item tokens. A user operating a user device 110 may interact with a front-end interface to initiate a distributed group selection workflow. The user interface exposes schema-aligned item records sourced from merchant-side structured data ingestion system 112, each tokenized to reflect fulfillment modality, splittability, scheduling rules, and compatibility constraints.

In an embodiment, the user selects one or more items of interest and submits availability, quantity thresholds, and preferred fulfillment modality (e.g., pickup, dine-in, delivery). These submissions are received by the multi-user coordination and data processing system 103, which instantiates a session state and applies compatibility matching logic to evaluate item alignment across other user submissions. A match scoring and prioritization engine 308 executes real-time evaluation of user-submitted vectors (e.g., vectors derived from selection preferences and interaction histories) and schema attributes, identifying whether any current or pending user profiles meet the compatibility threshold for shared fulfillment.

Upon determining a match, the system invokes orchestration logic to allocate cost shares, route fulfillment instructions, and finalize the match state and bind user allocations. A price allocation and cost-splitting engine 212 evaluates portion shares, system-defined price boundaries, and merchant-specified split constraints. The order sequencing and fulfillment orchestration module 214 arranges delivery sequencing, scheduling constraints, and triggers downstream notifications. The system then transmits structured order payloads to fulfillment routing and logistics interface system 111, which interacts with external delivery APIs or merchant platforms to execute the fulfillment path.

Throughout the process, the system maintains compatibility logs, preference vectors, and fulfillment outcomes for future feedback processing. A feedback integration and signal reweighing module 310 incorporates post-order review data, reputation signals, and delivery timing performance into updated compatibility weights. In an embodiment, the system supports latent matching by deferring execution until participation thresholds are met, or by inferring user alignment based on historical signal patterns across item groupings.

Alternative configurations support merchant-defined scheduling rules, item restrictions, and promotional constraints. For instance, merchants may specify that an item can only be split by up to four users, only during defined service windows. These rules are ingested through schema-conformant merchant configuration interfaces and enforced during compatibility and orchestration workflows. In certain embodiments, social coordination features allow users to join public or private sessions, opt into match broadcasting, or trigger promotions based on participation milestones.

The disclosed system is operable across multiple verticals, including food ordering, shared retail experiences, and digital service bundling. It improves upon conventional ordering models by enabling asynchronous participation, structured compatibility resolution, and shared fulfillment orchestration, all without requiring linear menu selection or static cart-based flows. The architecture supports scalable, distributed collaboration across asynchronous participant sets, while providing deterministic matching and fulfillment logic based on structured schema rules.

One or more different embodiments may be described in the present application. Further, for one or more of the embodiments described herein, numerous alternative arrangements may be described; it should be appreciated that these are presented for illustrative purposes only and are not limiting of the embodiments contained herein or the claims presented herein in any way. One or more of the arrangements may be widely applicable to numerous embodiments, as may be readily apparent from the disclosure. In general, arrangements are described in sufficient detail to enable those skilled in the art to practice one or more of the embodiments, and it should be appreciated that other arrangements may be utilized and that structural, logical, software, electrical and other changes may be made without departing from the scope of the embodiments. Particular features of one or more of the embodiments described herein may be described with reference to one or more particular embodiments or figures that form a part of the present disclosure, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an aspect with several components in communication with each other does not imply that all such components are required. To the contrary, a variety of optional components may be described to illustrate a wide variety of possible embodiments and in order to more fully illustrate one or more embodiments. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the embodiments, and does not imply that the illustrated process is preferred. Also, steps are generally described once per aspect, but this does not mean they must occur once, or that they may only occur once each time a process, method, or algorithm is carried out or executed. Some steps may be omitted in some embodiments or some occurrences, or some steps may be executed more than once in a given aspect or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of various embodiments in which, for example, functions may be executed out of order from that shown or discussed, including substantially concurrently or in reverse order, depending on the functionality involved, as would be understood by those having ordinary skill in the art.

The detailed description set forth herein in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

### Network Architecture

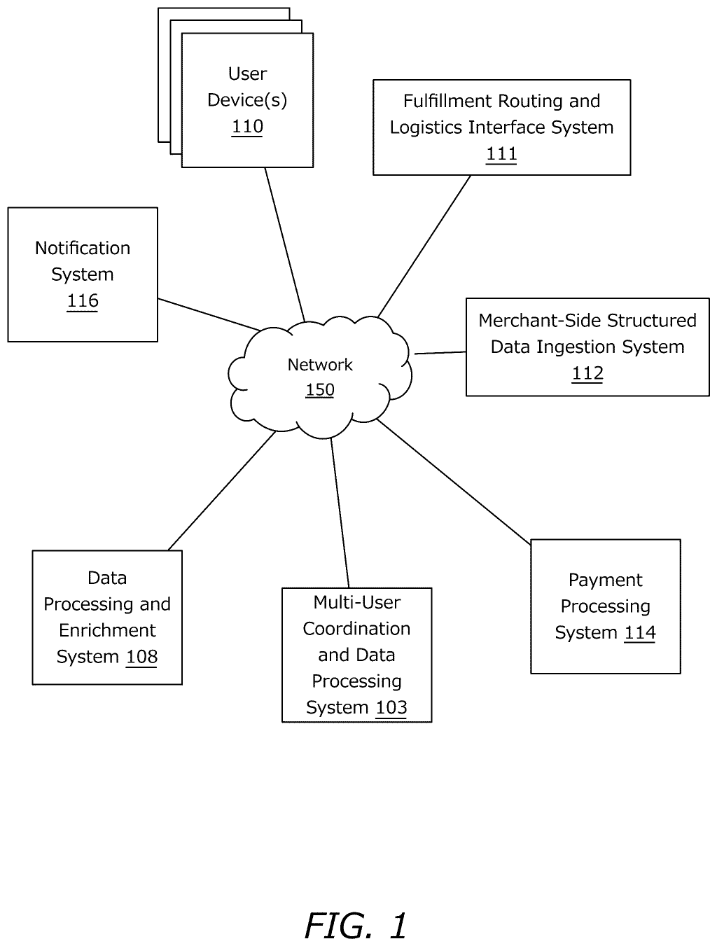

FIG. 1 illustrates a system architecture for coordinating item-based fulfillment sessions using tokenized item data and user participation inputs, in accordance with various embodiments. As shown in FIG. 1, the system includes multi-user coordination and data processing system 103, data enrichment and schema mapping system 108, user device(s) 110, fulfillment routing and logistics interface system 111, merchant-side structured data ingestion system 112, notification system 116, payment processing system 114, and a network 150 over which the various systems communicate and interact. The various components described herein are exemplary and for illustration purposes only and any combination or subcombination of the various components may be used as would be apparent to one of ordinary skill in the art. The system may be reorganized or consolidated, as understood by a person of ordinary skill in the art, to perform the same tasks on one or more other servers or computing devices without departing from the scope of the invention.

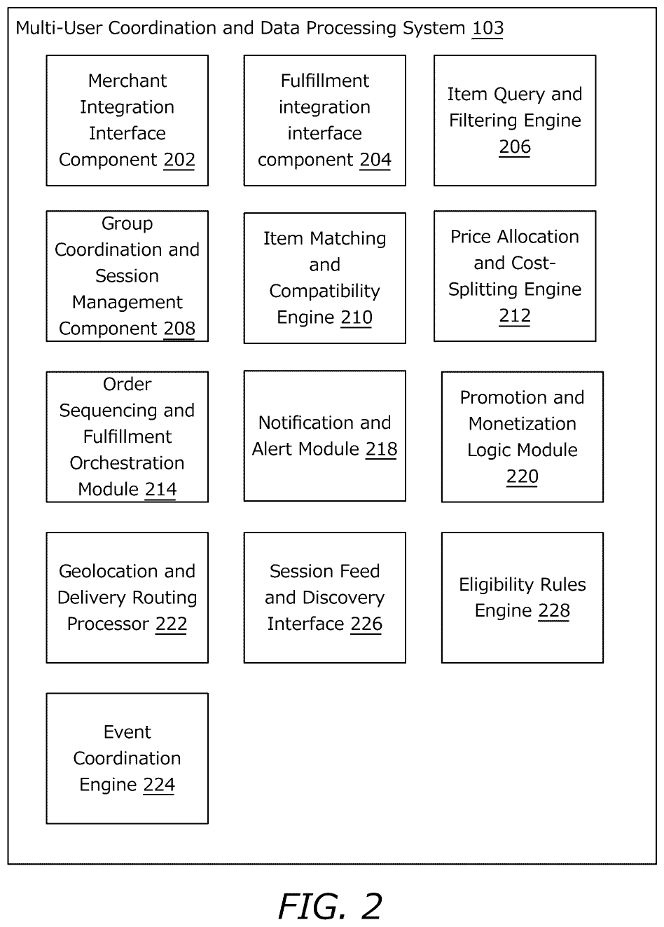

Multi-user coordination and data processing system 103 is operable to manage structured compatibility resolution, session state tracking, and distributed orchestration for shared fulfillment of tokenized item offerings. As will be described in FIG. 2, multi-user coordination and data processing system 103 includes subcomponents for receiving user-submitted item selection data, instantiating coordination sessions, evaluating compatibility thresholds, and allocating cost and fulfillment logic across participants. User-submitted item selection data refers to schema-aligned representations of item preferences submitted by users, each including structured metadata such as item identifiers, splittability constraints, fulfillment modality (e.g., dine-in, delivery), scheduling preferences, and quantity targets. A coordination session refers to a managed instance of multi-user interaction in which item-level selections are evaluated collectively to determine if group-based fulfillment criteria are met.

More specifically, multi-user coordination and data processing system 103 aggregates user-submitted item tokens and applies rule-based and model-based evaluation techniques to determine compatibility. Compatibility thresholds may include explicit match rules—such as quantity matching, minimum participation count, or merchant-defined constraints—and implicit match criteria derived from user embeddings, prior participation, or inferred vector similarity. These thresholds are used by the item matching and compatibility engine 210 (see FIG. 2) to evaluate whether the collective item submissions across participants can satisfy a valid group fulfillment condition.

When compatibility is confirmed—such as when a minimum quantity threshold is met for a splittable item and user delivery preferences align with merchant availability—the system invokes fulfillment orchestration workflows. A price allocation and cost-splitting engine 212 generates a structured representation of participant-level cost contributions based on item metadata and shareable units. The order sequencing and fulfillment orchestration module 214 then applies routing rules, schedules delivery or pickup, and prepares dispatch metadata. Fulfillment instructions are issued to fulfillment routing and logistics interface system 111, which communicates with third-party logistics or merchant systems for physical execution.

In certain embodiments, multi-user coordination and data processing system 103 includes deferred fulfillment logic, allowing partial matches to be held until additional users join or until an alternate fulfillment path becomes available. The system supports both user-initiated and system-suggested sessions, and includes logic for event promotion, participant invitation, and threshold-based unlocks. Coordination sessions may be ephemeral or persistent based on match success, timeout parameters, or merchant availability.

As shown in FIG. 2, multi-user coordination and data processing system 103 includes subcomponents such as group coordination and session management component 208, item matching and compatibility engine 210, price allocation and cost-splitting engine 212, and orchestration module 214. These components collectively implement the real-time evaluation, cost modeling, and fulfillment decisioning required to coordinate multi-user ordering workflows in structured, schema-aligned environments.

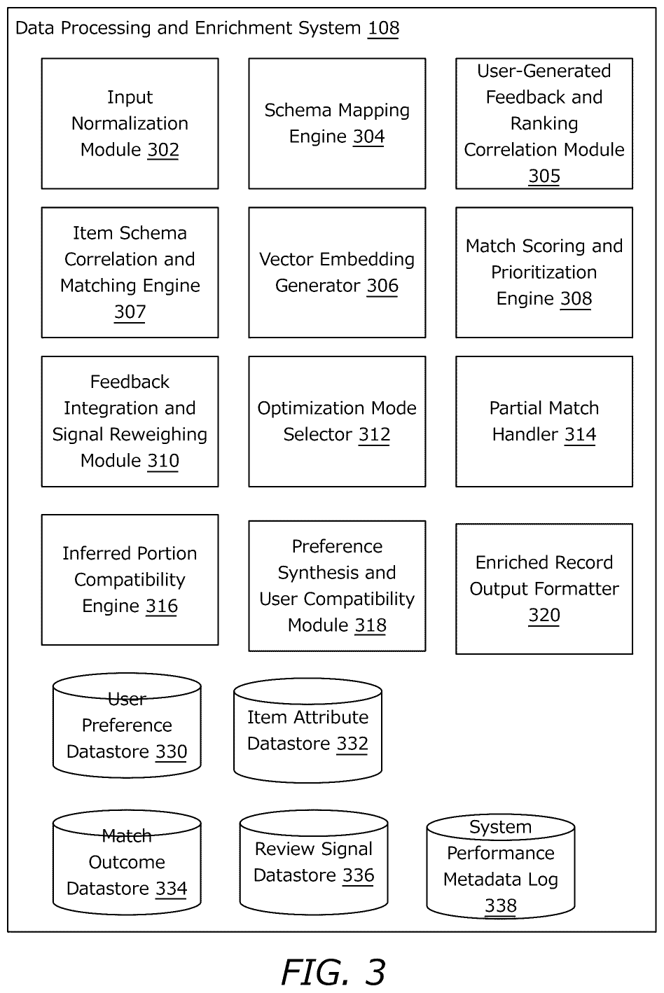

Data processing and enrichment system 108 is operable to receive user-submitted item selection data, normalize those inputs into schema-aligned representations, and generate enriched records that support compatibility evaluation and downstream fulfillment orchestration. As used herein, user-submitted item selection data refers to data entered by users through interfaces rendered on user device(s) 110, including selected item identifiers, quantity preferences, fulfillment modalities (e.g., dine-in, pickup, delivery), timing constraints, and optional annotations. This data is processed into standardized records to support collaborative session coordination, as further described in connection with FIG. 3.

More specifically, data processing and enrichment system 108 includes subcomponents operable to tokenize, map, and score item records using real-time metadata. A tokenized item record refers to a structured data object derived from a user-submitted item, aligned to a common schema encompassing attributes such as portion size, splittability, availability windows, and merchant-imposed constraints. A schema-aligned representation allows disparate item inputs to be normalized into a form compatible with compatibility modeling across participants.

In certain embodiments, data processing and enrichment system 108 generates a compatibility vector for each tokenized item record. A compatibility vector is a weighted representation that encodes item characteristics, fulfillment constraints, and user-aligned preferences to support multidimensional matching. These vectors are used by subcomponents including vector embedding generator 306 and preference synthesis and user compatibility module 318 to assess alignment across active coordination sessions. A coordination session refers to a bounded grouping of item records from multiple users being evaluated for possible shared fulfillment.

In various embodiments, the system dynamically adjusts compatibility scoring using signal reweighting and feedback ingestion. For example, match scoring and prioritization engine 308 and feedback integration and signal reweighing module 310 may apply post-fulfillment outcomes, delivery telemetry, and engagement metrics to modify vector weights. For example, item tokens with consistently low match rates or delivery issues may receive reduced priority in future sessions.

Following enrichment and scoring, enriched record output formatter 320 prepares structured item tokens for downstream orchestration. These schema-conformant outputs are transmitted to multi-user coordination and data processing system 103, where they are evaluated against session thresholds to determine whether group fulfillment conditions have been satisfied, as shown in FIG. 3.

In various embodiments, user device(s) 110 comprise one or more network-connected computing devices operable to render interface components for participating in multi-user coordination sessions. User device(s) 110 may include smartphones, tablets, laptops, or other devices configured to execute native or browser-based applications that communicate with the systems described herein. Through these interfaces, users may submit item selection data, specify fulfillment preferences, and receive compatibility feedback and fulfillment notifications. In certain embodiments, user device(s) 110 render schema-aligned item records retrieved from merchant-side structured data ingestion system 112 and transmit selection inputs to multi-user coordination and data processing system 103 for session instantiation and compatibility evaluation.

User device(s) 110 include, generally, a computer or computing device including functionality for communicating (e.g., remotely) over a network 150. Data may be collected from user device(s) 110, and data requests may be initiated from each user device. User device(s) 110 may be a server, a desktop computer, a laptop computer, personal digital assistant (PDA), an in- or out-of-car navigation system, a smart phone or other cellular or mobile phone, or mobile gaming device, among other suitable computing devices. User devices 110 may execute one or more applications, such as a web browser (e.g., Microsoft Windows Internet Explorer, Mozilla Firefox, Apple Safari, Google Chrome, and Opera, etc.), or a dedicated application to submit user data, or to make prediction queries over a network 150.

In particular embodiments, each user device may be an electronic device including hardware, software, or embedded logic components or a combination of two or more such components and capable of carrying out the appropriate functions implemented or supported by the user device. For example and without limitation, a user device may be a desktop computer system, a notebook computer system, a netbook computer system, a handheld electronic device, or a mobile telephone. The present disclosure contemplates any user device. A user device may enable a network user at the user device to access network 150. A user device may enable its user to communicate with other users at other user devices.

A user device may have a web browser, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user device may enable a user to enter a Uniform Resource Locator (URL) or other address directing the web browser to a server, and the web browser may generate a Hyper Text Transfer Protocol (HTTP) request and communicate the HTTP request to server. The server may accept the HTTP request and communicate to the user device 110 one or more Hyper Text Markup Language (HTML) files responsive to the HTTP request. The user device 110 may render a web page based on the HTML files from server for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

The user device 110 may also include an application that is loaded onto the user device 110. The application obtains data from the network 150 and displays it to the user within the application interface.

Exemplary user devices are illustrated in some of the subsequent figures provided herein. This disclosure contemplates any suitable number of user devices, including computing systems taking any suitable physical form. As example and not by way of limitation, computing systems may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computing system may include one or more computer systems; be unitary or distributed; span multiple locations; span multiple machines; or reside in a cloud, which may include one or more cloud components in one or more networks. Where appropriate, one or more computing systems may perform without substantial spatial or temporal limitation one or more steps of one or more methods described or illustrated herein. As an example, and not by way of limitation, one or more computing systems may perform in real time or in batch mode one or more steps of one or more methods described or illustrated herein. One or more computing system may perform at different times or at different locations one or more steps of one or more methods described or illustrated herein, where appropriate.

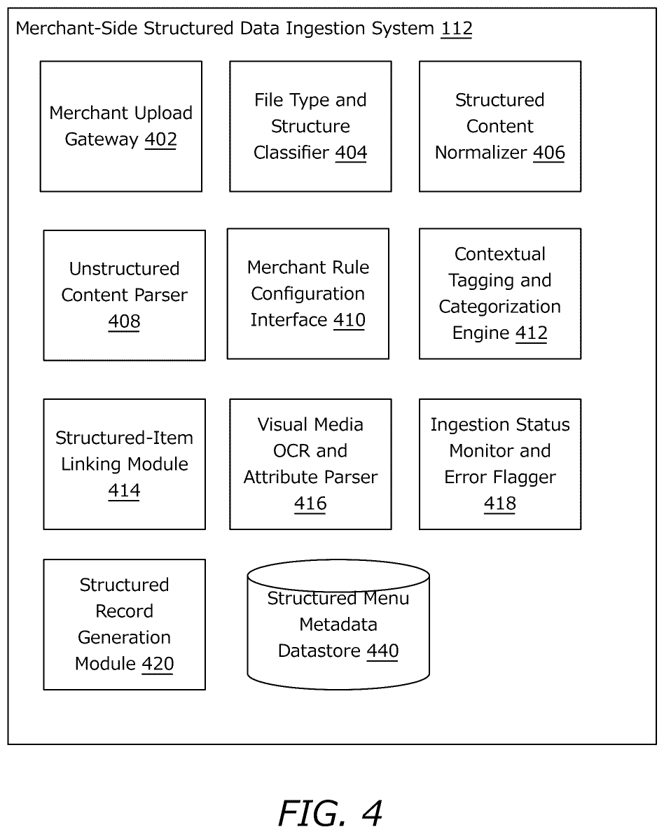

Merchant-side structured data ingestion system 112 is operable to ingest and normalize merchant-defined item configurations, fulfillment constraints, and availability parameters. In various embodiments, merchant-side structured data ingestion system 112 receives structured or semi-structured menu records, including item attributes (e.g., portion sizes, splittability flags), scheduling restrictions, and price rules from merchant systems such as point-of-sale (POS) platforms, menu APIs, or static data exports. These inputs are transformed into schema-aligned item records consumable by multi-user coordination and data processing system 103. In certain embodiments, this ingestion and normalization process is performed using subcomponents described further in FIG. 4, which transform merchant-originating formats into internal tokenized item representations conformant with system schema constraints.

Once user compatibility thresholds are met, merchant-side structured data ingestion system 112 receives execution payloads specifying selected item tokens, quantity groupings, and fulfillment preferences. These payloads are dispatched to kitchen orchestration endpoints or other operational interfaces, enabling merchants to execute group-specific preparation logic. For example, preparation records may include instructions to partition shared items into labeled portions for distinct users or apply merchant-defined constraints, such as weekday-only fulfillment or limited-time combos.

In certain embodiments, merchant-side structured data ingestion system 112 includes inventory synchronization logic that receives updates from kitchen operations and propagates real-time availability signals to user interfaces. These updates inform item eligibility during user selection and matching. Structured responses may include out-of-stock flags, fulfillment delays, or dynamic pricing updates that influence compatibility scoring.

Alternatively, merchants may configure rule constraints through schema-conformant configuration interfaces. These constraints may include item-specific split limits (e.g., a dish that may only be split across three participants), fulfillment modalities (e.g., dine-in only), or excluded windows. These constraints are enforced during match evaluation and fulfillment orchestration by downstream components.

In alternate embodiments, merchants may deploy supplemental logic such as visual item recognition, QR-labeled packaging systems, or modular preparation kits. These configurations enable enriched preparation, traceability, and portion delivery workflows and may be integrated with external systems or feedback channels.

Merchant-side structured data ingestion system 112 is described further in FIG. 4.

Fulfillment routing and logistics interface system 111 is operable to coordinate distributed delivery workflows across matched item groupings and participant locations. In various embodiments, fulfillment routing and logistics interface system 111 receives fulfillment instructions from multi-user coordination and data processing system 103 and initiates delivery session formation based on user proximity, item readiness, and merchant constraints. These fulfillment sessions may include handoff schedules, routing parameters, and multi-user drop-off logic derived from compatibility resolution processes described in FIG. 2 and fulfillment orchestration logic described in FIG. 3.

The system is operable to interact with external delivery providers—including third-party APIs, merchant-linked fleets, and user-selected logistics services—to transmit structured routing instructions, monitor fulfillment status, and respond to dynamic timing changes. For example, once a shared item grouping reaches its execution threshold, fulfillment routing and logistics interface system 111 may initiate route selection workflows that incorporate real-time location data, merchant-defined prep windows, and delivery modality constraints (e.g., no split deliveries after business hours). In certain embodiments, the system supports multi-destination fulfillment by allocating route segments across users in a shared event, optionally consolidating deliveries at predefined drop points.

In accordance with various embodiments, fulfillment routing and logistics interface system 111 applies constraint validation logic before releasing a delivery instruction, including minimum order thresholds, supported service regions, and batchability of temperature-sensitive items. System telemetry—such as fulfillment delays, failed handoffs, or rerouting events—are recorded and relayed back to multi-user coordination and data processing system 103 for performance feedback and future route planning. These operations support dynamic routing decisions and conditional fulfillment execution without relying on preassigned logistics flows.

The system is further operable to track fulfillment status across active delivery sessions, monitor updates from logistics partners, and trigger user or system alerts based on delivery progression. Fulfillment events—such as pickup confirmations, en route transitions, and delivery completions—are propagated to user device(s) 110 and reflected in the coordination interface, enabling participants to receive status updates in real time. Exceptions or delays may trigger fallback workflows or retry logic, depending on session constraints and item compatibility across affected participants.

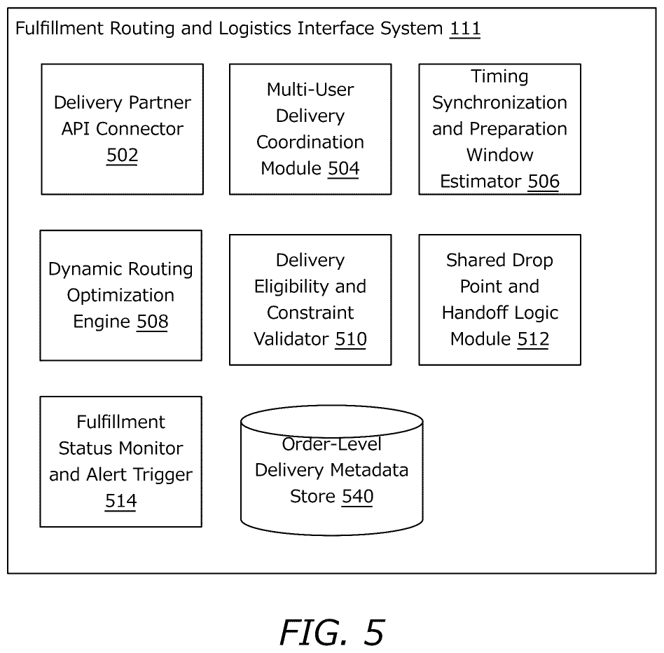

Fulfillment routing and logistics interface system 111 is described further in FIG. 5.

Notification system 116 comprises a multi-channel communication platform integrated with the multi-user coordination and data processing system 103. This system is designed to keep users informed and engaged by sending timely updates and alerts related to their shared food orders and other relevant events.

Notification system 116 functions as the primary means of communication between the platform and its users. It generates and delivers notifications about order status changes, upcoming food order events, personalized recommendations, and promotional offers. The system aims to provide users with valuable information while minimizing disruption and notification fatigue.

The system operates by continuously monitoring various data sources within the multi-user coordination and data processing system 103. It tracks the status of ongoing food order events, analyzing data from restaurant vendors, delivery services, and user interactions. When predefined conditions are met, such as an order being prepared or delivered, the system triggers a notification event.

Notification system 116 is operable to generate, format, and distribute system-triggered alerts based on event state changes, fulfillment milestones, and participant session activity. In various embodiments, notification system 116 receives status and event updates from multi-user coordination and data processing system 103 and evaluates delivery conditions based on user preferences, event type, and communication channel constraints. These updates may include item match confirmation, fulfillment orchestration triggers, participant join events, or delivery path deviations.

Notification system 116 includes dynamic content generation logic operable to format outgoing messages using system-defined templates and runtime data payloads. For example, a fulfillment match event may populate a predefined message structure with tokenized item names, estimated readiness windows, and group assignment identifiers. These formatted messages are serialized into appropriate output formats for transmission over in-app interfaces, push notification services, or external messaging APIs.

In certain embodiments, notification system 116 routes messages based on user-configured delivery preferences. For example, users may receive push notifications via their associated mobile device, fallback SMS messages via a third-party messaging gateway, or structured event updates through in-app user interface elements of user device(s) 110. System logic maps user identifiers to eligible channels and enforces frequency or timing rules based on user-defined thresholds or historical interaction signals.

Notification system 116 is further operable to apply feedback-based signal adjustment to notification behavior. User interaction metadata—such as message open timestamps, suppression toggles, or delivery failures—may be logged and evaluated to refine channel selection and message timing for future events. In certain embodiments, notification system 116 supports integration with downstream delivery systems, such that fulfillment delays or partner-reported exceptions automatically trigger updated delivery notifications or status re-broadcasts to all participants within the affected event session.

Payment processing system 114 is operable to facilitate multi-party transaction coordination, structured cost allocation, and payment finalization for shared item fulfillment sessions. In various embodiments, payment processing system 114 receives item allocation data and participant commitments from multi-user coordination and data processing system 103 and initiates distributed payment workflows based on schema-aligned price breakdowns and merchant-imposed rules. For example, once compatibility thresholds are satisfied and fulfillment orchestration is triggered, payment processing system 114 partitions cost shares using data from the price allocation and cost-splitting engine 212 (described in FIG. 2), incorporating parameters such as portion sizes, promotional modifiers, and system-defined surcharges. Each participant's payment record is linked to the finalized fulfillment payload and stored for downstream reconciliation and delivery eligibility validation.

In certain embodiments, payment processing system 114 integrates with external payment gateways, tokenized billing services, or in-app payment SDKs to authorize and settle transactions across multiple users. The system is operable to apply payment holds during session coordination, release or reallocate funds upon session failure or partial resolution, and issue refund instructions based on real-time delivery exception signals from fulfillment routing and logistics interface system 111. In accordance with various embodiments, structured payment metadata—including participant identities, portion mappings, transaction references, and settlement timestamps—are stored in association with fulfillment logs to support auditability and cross-session consistency.

In an embodiment, payment processing system 114 includes logic for coordinating payment sequencing based on partial match outcomes and deferred fulfillment conditions. For instance, when an item grouping meets a threshold for compatibility but not for fulfillment viability (e.g., delivery minimum not met), payment holds may be retained in escrow-like staging states. If fulfillment becomes viable within a time-bound window, transactions are finalized; otherwise, the system initiates automatic rollback, partial refund, or credit issuance. All such operations are schema-conformant and executed via structured instructions tied to orchestration state transitions, ensuring that fulfillment logic and financial logic remain synchronized. This architecture enables deterministic resolution of multi-party commitments even in partially successful or dynamically evolving sessions.

Network cloud 150 generally represents a network or collection of networks (such as the Internet or a corporate intranet, or a combination of both) over which the various components illustrated in FIG. 1 (including other components that may be necessary to execute the system described herein, as would be readily understood to a person of ordinary skill in the art). In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. One or more links connect the systems and databases described herein to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable network 150, and any suitable link for connecting the various systems and databases described herein.

The network 150 connects the various systems and computing devices described or referenced herein. In particular embodiments, network 150 is an intranet, an extranet, a virtual private network (VPN), a local area network (LAN), a wireless LAN (WLAN), a wide area network (WAN), a metropolitan area network (MAN), a portion of the Internet, or another network 150 or a combination of two or more such networks 150. The present disclosure contemplates any suitable network 150.

One or more links couple one or more systems, engines or devices to the network 150. In particular embodiments, one or more links each includes one or more wired, wireless, or optical links. In particular embodiments, one or more links each includes an intranet, an extranet, a VPN, a LAN, a WLAN, a WAN, a MAN, a portion of the Internet, or another link or a combination of two or more such links. The present disclosure contemplates any suitable links coupling one or more systems, engines or devices to the network 150.

In particular embodiments, each system or engine may be a unitary server or may be a distributed server spanning multiple computers or multiple datacenters. Systems, engines, or modules may be of various types, such as, for example and without limitation, web server, news server, mail server, message server, advertising server, file server, application server, exchange server, database server, or proxy server. In particular embodiments, each system, engine or module may include hardware, software, or embedded logic components or a combination of two or more such components for carrying out the appropriate functionalities implemented or supported by their respective servers. For example, a web server is generally capable of hosting websites containing web pages or particular elements of web pages. More specifically, a web server may host HTML files or other file types, or may dynamically create or constitute files upon a request, and communicate them to client/user devices or other devices in response to HTTP or other requests from client devices or other devices. A mail server is generally capable of providing electronic mail services to various client devices or other devices. A database server is generally capable of providing an interface for managing data stored in one or more data stores.

In particular embodiments, one or more data storages may be communicatively linked to one or more servers via one or more links. In particular embodiments, data storages may be used to store various types of information. In particular embodiments, the information stored in data storages may be organized according to specific data structures. In particular embodiments, each data storage may be a relational database. Particular embodiments may provide interfaces that enable servers or clients to manage, e.g., retrieve, modify, add, or delete, the information stored in data storage.

The system may also contain other subsystems and databases, which are not illustrated in FIG. 1, but would be readily apparent to a person of ordinary skill in the art. For example, the system may include databases for storing data, storing features, storing outcomes (training sets), and storing models. Other databases and systems may be added or subtracted, as would be readily understood by a person of ordinary skill in the art, without departing from the scope of the invention.

### Multi-User Coordination and Data Processing System

FIG. 2 illustrates an example configuration of multi-user coordination and data processing system 103 in accordance with an embodiment of the present disclosure. In this example, multi-user coordination and data processing system 103 includes merchant integration interface component 202, fulfillment integration interface component 204, item query and filtering engine 206, group coordination and session management component 208, item matching and compatibility engine 210, price allocation and cost-splitting engine 212, order sequencing and fulfillment orchestration module 214, notification and alert module 218, promotion and monetization logic module 220, geolocation and delivery routing processor 222, session feed and discovery interface 226, eligibility rules engine 228, and event coordination engine 224.

The various components described herein are exemplary and for illustration purposes only and any combination or subcombination of the various components may be used as would be apparent to one of ordinary skill in the art. Other systems, interfaces, modules, engines, databases, and the like, may be used, as would be readily understood by a person of ordinary skill in the art, without departing from the scope of the invention. Any system, interface, module, engine, database, and the like may be divided into a plurality of such elements for achieving the same function without departing from the scope of the invention. Any system, interface, module, engine, database, and the like may be combined or consolidated into fewer of such elements for achieving the same function without departing from the scope of the invention. All functions of the components discussed herein may be initiated manually or may be automatically initiated when the criteria necessary to trigger action have been met.

Merchant integration interface component 202 is operable to transmit, receive, and manage schema-aligned merchant item data exchanged between merchant-side structured data ingestion system 112 and multi-user coordination and data processing system 103. n an embodiment, merchant integration interface component 202 may comprise an interface to one or more merchants, such as restaurant vendors or other fulfillment entities More specifically, merchant integration interface component 202 is operable to receive merchant-originating item records, fulfillment constraints, and scheduling rules and route them to internal processing pipelines for compatibility resolution, session configuration, and item availability presentation.

Merchant integration interface component 202 is operable to transmit, receive, and manage schema-aligned merchant item data exchanged between merchant-side structured data ingestion system 112 and multi-user coordination and data processing system 103. More specifically, merchant integration interface component 202 is operable to receive merchant-originating item records, fulfillment constraints, and scheduling rules and route them to internal processing pipelines for compatibility resolution, session configuration, and item availability presentation.

In various embodiments, merchant integration interface component 202 operates asynchronously to support deferred parsing workflows. For instance, visual media files (e.g., scanned menus) uploaded through merchant upload gateway 402 may be queued for OCR and metadata extraction using visual media OCR and attribute parser 416, with merchant integration interface component 202 maintaining tracking state and acknowledging final schema alignment once normalized tokens are confirmed. The resulting structured records are routed to structured menu metadata datastore 440 and become available for user-facing discovery, portion matching, and compatibility processing.

In certain embodiments, merchant-specified constraints—such as splittability flags, preparation modality restrictions, or batch timing rules—are submitted via merchant configuration interface 410 and linked to structured item records via contextual tagging engine 412. Interface 202 ensures that these constraints are properly routed for downstream enforcement during compatibility modeling and fulfillment orchestration. Merchant-side updates or overrides (e.g., disabling an item, adjusting availability) are propagated through interface 202 and reflected in user-facing selection interfaces.

Interface to merchant-side structured data ingestion system 202 is further operable to support reconciliation workflows between live item state and previously ingested versions. In an embodiment, structured-item linking module 414 evaluates merchant-submitted tokens against prior canonical entries to determine whether a record should be updated, versioned, or ignored, based on delta thresholds or attribute confidence scores. Interface 202 then updates lineage tracking or triggers downstream updates in active ordering sessions if affected items are part of an unresolved match.

In accordance with various embodiments, merchant integration interface component 202 provides the primary linkage between merchant ingestion logic (as shown in FIG. 4) and the compatibility, ordering, and fulfillment logic of FIGS. 2 and 3, enabling continuous ingestion, item availability propagation, and structured merchant interaction within the system's schema-aligned data framework.

Fulfillment integration interface component 204 is operable to transmit delivery-related routing data and fulfillment parameters between multi-user coordination and data processing system 103 and fulfillment routing and logistics interface system 111. In an embodiment, fulfillment integration interface component 204 may comprise an interface to one or more delivery vendors. More specifically, fulfillment integration interface component 204 is operable to encode structured fulfillment instructions for split orders, route assignments, pickup timing, and user-specific delivery metadata, and transmit those instructions in a format consumable by external logistics platforms or partner APIs.

In various embodiments, fulfillment integration interface component 204 generates schema-aligned delivery payloads by transforming internal fulfillment records—generated by order sequencing and fulfillment orchestration module 214—into normalized message structures that conform to the capabilities and constraints of third-party logistics endpoints. These message structures may include route configurations, user drop point coordinates, preparation window buffers, and fulfillment session identifiers. The component supports conditional payload generation based on delivery eligibility checks and merchant-defined timing restrictions, which are evaluated using internal delivery constraint metadata received from fulfillment routing and logistics interface system 111.

For example, when a matched group ordering session is confirmed and scheduled for delivery, fulfillment integration interface component 204 retrieves relevant delivery metadata (e.g., merchant readiness window, user address tokens, session ID) and initiates fulfillment handoff by transmitting the compiled payload to the appropriate routing system. A delivery partner's response—including confirmation, reassignment, or delay notification—is received, parsed, and routed to fulfillment orchestration module 214 to update execution timing or trigger notification system 116 alerts to affected users.

In certain embodiments, fulfillment integration interface component 204 also monitors delivery status updates streamed from fulfillment routing and logistics interface system 111 and synchronizes real-time fulfillment events—such as carrier assignment, en route progress, or drop-point exceptions—back to the session record maintained by multi-user coordination and data processing system 103. These updates are logged in the order-level delivery metadata store 540 described in FIG. 5 and used to trigger system-wide alerts, fallbacks, or exception workflows.

Item query and filtering engine 206 is operable to receive structured user input and contextual parameters and execute schema-aligned search and filtering logic to identify one or more tokenized item records accessible by multi-user coordination and data processing system 103. More specifically, item query and filtering engine 206 is operable to receive search terms, fulfillment preferences (e.g., dine-in, delivery, or pickup), scheduling constraints, or compatibility-affecting filters (e.g., dietary flags, splittability, cuisine type), and construct a query pipeline across the indexed data structures within structured menu metadata datastore 440.

In various embodiments, item query and filtering engine 206 retrieves and filters merchant item records ingested by merchant-side structured data ingestion system 112 and normalized by structured content normalizer 406, contextual tagging and categorization engine 412, and structured record generation module 420 as shown in FIG. 4. Item query and filtering engine 206 may evaluate compatibility-related item metadata such as splittability flags, dietary tags (e.g., vegan, gluten-free), scheduling rules, pricing tiers, or portion size configurations. In an example, item query and filtering engine 206 may identify a vegetarian entrée tagged for lunchtime availability that supports 3-way sharing and meets a user-defined price ceiling and delivery window.

In certain embodiments, item query and filtering engine 206 supports progressive filtering across live inventory updates and user refinement actions. For example, a user operating user device 110 may initially filter by cuisine type (e.g., Indian), and after viewing results, further constrain the query to only include shareable portions suitable for pickup. As the user session evolves, item query and filtering engine 206 may reprioritize filtering behavior to surface previously matched high-compatibility items or enforce schema constraints from merchant-defined fulfillment restrictions.

Item query and filtering engine 206 may interface with compatibility workflows described in FIG. 3, such as match scoring and prioritization engine 308 and inferred portion compatibility engine 316, to ensure filtering logic supports downstream resolution workflows. For example, item records with known compatibility conflicts—such as overlapping fulfillment windows or incompatible portion definitions—may be excluded or deprioritized within query results.

Item query and filtering engine 206 may include search and filtering capabilities previously attributed to a food item search component in the provisional specification. For example, users may enter search terms, apply price range filters, select dietary restrictions, or view portion-level details on which items are flagged as splittable and under what constraints. Search logic may include real-time availability checks against merchant APIs or fallback to cached entries in structured menu metadata datastore 440.

In various embodiments, item query and filtering engine 206 is operable to process user-submitted selection criteria—such as cuisine type, dietary constraints, fulfillment modality, portion shareability, and pricing thresholds—and construct schema-aligned search queries across tokenized item representations. Item records retrieved by item query and filtering engine 206 may include structured metadata attributes such as splittability flags, meal type tags (e.g., lunch, dinner), allergen indicators, merchant-defined availability windows, or fulfillment constraints. For example, a user may search for items flagged as dairy-free, priced below a defined threshold, and available for same-day pickup within a defined service window. Search results may be dynamically re-ranked as users apply or remove filters, or as inventory and compatibility data evolve across active coordination sessions.

In various embodiments, item query and filtering engine 206 supports optional recommendation logic using user profile signals. This may include prioritization of certain merchants based on prior engagement or display of filtered results ranked by inferred compatibility for upcoming coordination sessions.

Group coordination and session management component 208 is operable to instantiate, track, and manage multi-user coordination sessions based on structured item selections and compatibility signals. More specifically, group coordination and session management component 208 is operable to receive schema-aligned item selections and associated participation parameters from multiple user devices 110, evaluate session eligibility based on participation thresholds, and manage lifecycle state transitions (e.g., pending, matched, locked) for active coordination sessions.

For example, a first participant using user device 110 may select an item token representing a large sharable entrée and indicate availability for a lunch window on Saturday. A second participant may independently select the same item token, specify a desired portion size of 25%, and opt into public coordination sessions within a five-mile radius. Upon receiving these inputs, group coordination and session management component 208 evaluates whether the session satisfies minimum participation thresholds (e.g., minimum 50% share commitment to activate the session), and determines that a compatible grouping is possible based on shared availability, fulfillment modality (e.g., pickup), and item-level splittability flags. The session state is updated from “pending” to “matched,” and downstream fulfillment orchestration flags are initialized. If additional participants join, the session may dynamically transition to a “locked” state once all fulfillment and allocation conditions are met, triggering cost allocation and routing instructions.

In an embodiment, group coordination and session management component 208 maintains active coordination sessions by associating compatible item tokens with user-defined session metadata, such as group size limits, fulfillment modality preferences, temporal constraints, and visibility settings (e.g., public or invite-only). For example, a user may initiate a coordination session for a shared meal that requires a minimum of three participants, must be fulfilled by 7:00 p.m., and is limited to takeout-only items. Group coordination and session management component 208 stores this metadata and monitors compatibility signals across other participants' inputs until the session transitions to a resolvable state.

In certain embodiments, group coordination and session management component 208 is further operable to expose coordination sessions to eligible users via structured queries, event feeds, or proximity-based session recommendations. For example, if a coordination session is initiated by a user seeking to split a family-style dish requiring a minimum of four participants, the system may surface the session to other users within a five-mile radius who have enabled public session visibility and whose dietary tags match the item attributes (e.g., vegetarian, nut-free). Upon receiving compatible join requests, the component evaluates the updated participation state, confirms schema-conformant alignment of item preferences and availability constraints, and locks the session state. Once locked, group coordination and session management component 208 generates a structured session summary comprising user assignments (e.g., who is responsible for which portion), cost allocation stubs mapped to fulfillment shares, and orchestration flags that initiate delivery scheduling, pickup instructions, or dine-in reservation prompts within fulfillment routing and logistics interface system 111.

Item matching and compatibility engine 210 is operable to evaluate submitted item tokens from multiple participants for compatibility resolution. More specifically, item matching and compatibility engine 210 is operable to compare schema-aligned item selections across users, apply vector-based similarity metrics, and determine whether grouping thresholds and constraint criteria are satisfied to support shared fulfillment. Compatibility evaluation may include direct item token matches, derived preference overlaps, or latent vector proximity derived from past selections and system-weighted interest vectors.

In an embodiment, item matching and compatibility engine 210 applies structured compatibility rules based on item metadata, including splittability flags, fulfillment modality compatibility (e.g., dine-in versus delivery), dietary constraints, and portion granularity. Matching logic may include a weighted scoring system incorporating static merchant-defined compatibility parameters and dynamic system-learned user vectors. Threshold logic is enforced to ensure only groupings with sufficient alignment trigger session resolution.

For example, a portion threshold may be satisfied when a first user selects a 50% portion of a shared entrée, a second user selects 25%, and a third user selects the remaining 25%, reaching 100% of the item's defined portion capacity. The item metadata indicates that three-way splitting is permitted, and all participants select the same fulfillment modality (e.g., delivery), enabling the session to be confirmed.

In another example, a vector similarity threshold may be satisfied when two users select different but thematically similar items (e.g., tofu pad thai and vegetable lo mein) with overlapping dietary tags and historical ordering vectors within a cosine similarity margin above a predefined threshold (e.g., 0.85). The engine treats this as a latent compatibility and includes the users in a flexible item match group subject to merchant approval.

In yet another example, a direct item token match may be satisfied when two or more users independently select the exact same item token—such as “Spicy Tuna Roll—8 piece (ItemID: RST001-293)”—with identical fulfillment modality (e.g., dine-in) and matching portion selection (e.g., 50% share each). Because the selected item token, fulfillment constraints, and quantity specifications are fully aligned across users, the engine confirms compatibility without requiring vector approximation or additional reconciliation logic.

In yet another example, a scheduling threshold may be satisfied when three participants select an item with a “weekday lunch” constraint, and their individual availability parameters include a shared window (e.g., Tuesday from 11:30 AM to 1:00 PM). The engine confirms that all scheduling constraints are aligned and flags the match as a candidate for coordination.

In yet another example, a mixed threshold may be satisfied when multiple compatibility conditions are met across different dimensions. For instance, a first user selects a “Family Size Chicken Biryani (ItemID: MCH045-BY4)” for delivery with a 50% share and an available delivery window of 6:00-7:00 PM. A second user independently selects the same item with a 30% share and overlapping delivery availability, while a third user selects a vegetarian side dish with a compatible flavor profile and historically co-ordered tags. The system confirms (i) a direct item token match for the chicken biryani between the first two users, (ii) fulfillment modality alignment across all three users, and (iii) vector-based compatibility between the third user's selection and the group context. Based on aggregate quantity thresholds (≥80% share), schedule alignment, and latent vector match, the system finalizes a grouped coordination session.

In certain embodiments, item matching and compatibility engine 210 supports partial match retention and requeuing logic. If a user initiates a selection that fails to reach a compatibility threshold, the item token and associated parameters may be held in a pending queue and re-evaluated as new participants join or additional selections are made. The component may incorporate runtime telemetry, learned preference signals, or merchant-driven prioritization weights to adjust match scoring dynamically over time.

Price allocation and cost-splitting engine 212 is operable to compute per-user cost distributions based on structured item groupings resolved during coordination. More specifically, price allocation and cost-splitting engine 212 is operable to receive structured item tokens from group coordination and session management component 208, along with portioning metadata, merchant-defined pricing constraints, and user-specific selection records, and calculate the proportional cost responsibility for each participant.

In an embodiment, price allocation and cost-splitting engine 212 computes cost shares using schema-aligned pricing logic, which includes, for example, item base price, optional modifiers (e.g., extra toppings), split factor (e.g., ½, ⅓), and merchant-imposed fees (e.g., split surcharge or minimums). It should be noted other logic known in the art may also be utilized. For example, the engine may also evaluate rounding rules, tax distributions, and cost padding if required by the merchant configuration stored in structured menu metadata datastore 440 of FIG. 4.

For example, a structured item token may represent a single large pizza priced at $24.00 with a splittability flag of 3 and equal portion metadata. If a first user selects one portion, a second user selects two portions, and a third user opts out, price allocation and cost-splitting engine 212 calculates the share as $8.00 for the first user and $16.00 for the second user. In another example, a shared platter priced at $30.00 may include merchant-defined tiered pricing where two users splitting the item pay $15.00 each, but three users trigger a $33.00 total price due to additional packaging overhead, resulting in a $11.00 per-user allocation. Additional logic may account for opt-in fees, such as a user selecting gluten-free substitution at an extra $2.00, or allocating per-user delivery cost adjustments based on location-derived delivery effort.

In various embodiments, price allocation and cost-splitting engine 212 applies merchant-defined floor pricing rules or bundled incentives that are reflected in the cost distribution outputs. For instance, when a split meal exceeds a minimum number of participants, the system may reduce the per-user price according to a rebate schema defined during item ingestion. All cost allocations are returned as structured payment stubs, which include item references, user identifiers, calculated totals, and fulfillment flags. These stubs are passed downstream for orchestration by order sequencing and fulfillment orchestration module 214.

In certain embodiments, price allocation and cost-splitting engine 212 is further operable to reconcile shared item totals with individual user checkout flows. This includes generating cost allocation stubs that are transmitted to downstream orchestration modules (e.g., order sequencing and fulfillment orchestration module 214), such that the fulfillment logic maintains alignment with the computed pricing logic. The engine may also support preview simulations or deferred execution modes, in which allocations are presented to users for confirmation prior to final lock-in.

Order sequencing and fulfillment orchestration module 214 is operable to generate structured fulfillment instructions based on the finalized coordination session state and computed cost allocation outputs. More specifically, order sequencing and fulfillment orchestration module 214 is operable to receive locked session records, item group assignments, user fulfillment preferences, and payment stubs from price allocation and cost-splitting engine 212, and transform these inputs into executable fulfillment flows routed through fulfillment integration interface component 204 and downstream into fulfillment routing and logistics interface system 111.

In various embodiments, order sequencing and fulfillment orchestration module 214 applies dependency logic across user preferences and merchant-side readiness constraints to determine the execution sequence of the fulfillment pipeline. This includes ordering of kitchen prep times, coordination of delivery windows, synchronization of split item packaging, and consolidation of user-specific drop-off instructions. In an embodiment, orchestration logic considers dynamic factors such as merchant-provided prep time estimates, user location clustering, and delivery partner availability to prioritize dispatch order and select appropriate routing paths.

For example, in a coordination session involving four users who have split two dishes from the same restaurant, order sequencing and fulfillment orchestration module 214 may compute a sequencing plan that staggers prep start times across items to align with the availability of a delivery partner assigned to serve a three-block radius. The module may designate a shared drop-off location (e.g., workplace lunchroom) and embed those logistics into a dispatch payload that includes item identifiers, user names, packaging labels, and timing constraints. If a user has requested dine-in and another has requested delivery from the same grouping, orchestration logic may separate the instructions into parallel fulfillment branches to prevent cross-mode conflicts.

In certain embodiments, order sequencing and fulfillment orchestration module 214 generates orchestration stubs per user-item combination that include: (1) routing priority flags, (2) fallback delivery instructions, (3) carrier-specific delivery tokens, and (4) user-specific confirmation checkpoints (e.g., PIN code or photo receipt). These stubs are transmitted via fulfillment integration interface component 204 and used by fulfillment routing and logistics interface system 111 to dispatch delivery partners or update merchant terminals.

In an embodiment, order sequencing and fulfillment orchestration module 214 is further operable to manage conditionally deferred fulfillment flows. For instance, if a coordination session has met the minimum match threshold but lacks a committed delivery partner, the module may queue the orchestration request with a retry interval and alternate routing fallback (e.g., splitting drop-off across two smaller carriers). If a required item becomes unavailable before orchestration lock-in, the module may invalidate the session state and trigger a partial refund operation or rematch flow.

The orchestration output format conforms to a structured schema including session ID, user identifiers, item tokens, portion metadata, pricing attributes, fulfillment mode, delivery timing block, and routing constraints. This format enables downstream systems to validate orchestration integrity, audit fulfillment decisions, and dynamically adapt fulfillment execution based on real-time telemetry from logistics networks.

In various embodiments, order sequencing and fulfillment orchestration module 214 operates in conjunction with structured menu metadata datastore 440 of FIG. 4 and order-level delivery metadata store 540 of FIG. 5 to align orchestration plans with merchant-defined constraints and historical delivery performance.

Notification and alert module 218 is operable to generate, transmit, and manage structured event-based notifications and user alerts across the coordination, pricing, and fulfillment pipeline. More specifically, notification and alert module 218 is operable to monitor lifecycle transitions from group coordination and session management component 208, pricing outcomes from price allocation and cost-splitting engine 212, and fulfillment status from order sequencing and fulfillment orchestration module 214, and to deliver structured alert payloads to eligible user devices 110 and participating merchant endpoints.

In an embodiment, notification and alert module 218 generates message objects from a structured template system that incorporates real-time session metadata, including item groupings, user assignments, match status, fulfillment timing, and routing state. These message objects are assembled in response to system events such as session creation, match confirmation, cost share finalization, item availability updates, and fulfillment exceptions.

For example, when a coordination session reaches a locked state and order sequencing and fulfillment orchestration module 214 emits fulfillment instructions, notification and alert module 218 may generate user-specific messages that include the item split summary, individual cost responsibility, and estimated fulfillment time block. These messages are routed to user devices 110 via multiple channels, including in-app push notifications, SMS alerts (via integrated gateway), or email payloads depending on user-configured preferences.

In certain embodiments, notification and alert module 218 is further operable to detect fulfillment events propagated by fulfillment routing and logistics interface system 111, such as driver dispatch, delivery acceptance, delay triggers, or proof-of-delivery confirmation. These events are mapped to predefined status codes and rendered into alert payloads aligned with user device display formats. Alert frequency, format, and delivery path are modulated based on user interaction history, session urgency, and coordination priority flags.

Notification and alert module 218 may also include escalation and redundancy logic. For instance, if a push notification fails due to a user's device being unreachable, the module may fall back to SMS delivery or generate an email alert. Escalation thresholds may be configured per alert type or per user tier.

In an embodiment, notification and alert module 218 is operable to generate merchant-side alerts using integration paths defined in fulfillment integration interface component 204. These alerts may include partial order confirmations, timing readiness checks, or dynamic preparation window adjustments based on evolving session conditions.

Additionally, notification and alert module 218 may incorporate scheduling logic that governs when alerts are queued, sent, or withheld based on system load, user timezone, or user-defined quiet periods. Notifications are logged and stored in association with the relevant coordination session for downstream analysis, system telemetry, or audit purposes.

Promotion and monetization logic module 220 is operable to evaluate, apply, and manage monetization pathways and promotional offers within coordination sessions initiated via multi-user coordination and data processing system 103. More specifically, promotion and monetization logic module 220 is operable to receive structured session state data, item token metadata, and merchant-configured rules, and determine whether promotional offers, pricing incentives, or monetization triggers apply to a given set of participants, items, or session conditions.

In certain embodiments, promotion and monetization logic module 220 is operable to execute promotion eligibility rules using merchant-submitted conditions—such as minimum order thresholds, time-bound discounts, or promotional bundles—and map those conditions to schema-aligned session data. For example, if a merchant specifies that a “family-style” shared entrée is eligible for a $5 discount when at least three users opt into a dine-in event before 7:00 PM, the module evaluates the session tokens, user roles, fulfillment modality, and timestamps to determine eligibility. If satisfied, the discount is applied to the aggregate order total and passed downstream to price allocation and cost-splitting engine 212.

Promotion and monetization logic module 220 is further operable to coordinate platform-driven monetization pathways, including event promotion fees, slotting fees, or session-tier monetization logic. In an embodiment, premium merchants may configure boosted visibility rules, which cause eligible items or coordination events to be promoted within session feeds or search results based on internal ranking heuristics. The module stores event engagement signals and promotion performance metrics to inform future monetization strategies.

In various embodiments, promotion and monetization logic module 220 may trigger promotional alerts via notification and alert module 218 when participation thresholds are near a configured reward milestone. For example, if a 15% discount is unlocked when five users join a coordination session, and four users are currently active, the module can trigger a push notification encouraging additional participants to join.

Promotion and monetization logic module 220 may interface with structured menu metadata datastore 440 (FIG. 4) and order-level delivery metadata store 540 (FIG. 5) to track promotional redemptions, enforce usage constraints (e.g., one-time use per user), and maintain accurate auditing for billing and settlement purposes. In certain embodiments, promotion and monetization logic module 220 supports A/B testing of promotion strategies by assigning variant conditions across coordination sessions and recording performance data for iterative refinement.

Geolocation and delivery routing processor 222 is operable to analyze, resolve, and apply location-based constraints, coordinates, and routing logic across multi-user fulfillment workflows. More specifically, geolocation and delivery routing processor 222 is operable to receive user location data, merchant geocoordinates, and session-level fulfillment intents, and to compute dynamic delivery configurations and routing pathways suitable for distributed fulfillment orchestration.

In an embodiment, geolocation and delivery routing processor 222 receives device-level geolocation data from user devices 110, structured pickup and drop-off coordinates from merchant-side structured data ingestion system 112, and proximity-based session recommendations from group coordination and session management component 208. Using this data, geolocation and delivery routing processor 222 computes whether a particular user is within a viable delivery radius for a selected merchant and evaluates whether shared routing is feasible across multiple matched participants.

For example, in a coordination session involving three users located at different drop points, geolocation and delivery routing processor 222 may generate a prioritized delivery sequence based on travel time, traffic data, and delivery modality constraints. If one user is outside the service area defined by delivery eligibility and constraint validator 510 (FIG. 5), that user may be flagged for manual override or excluded from the current session. The routing output is passed to fulfillment integration interface component 204 for encoding into actionable instructions.

In certain embodiments, geolocation and delivery routing processor 222 is further operable to evaluate alternative fulfillment strategies based on user-defined delivery preferences or constraints. For instance, when multiple users are located within a shared drop radius (e.g., university campus, office complex), the processor may recommend a shared drop point and pass the suggestion to shared drop point and handoff logic module 512 (FIG. 5). Fulfillment coordination logic is adapted accordingly to support consolidated packaging and streamlined handoff.

Geolocation and delivery routing processor 222 may interface with external geolocation services and delivery APIs to maintain real-time accuracy, resolve geocoding anomalies, and support fallback logic in low-precision environments. Location data and route decisions are stored in order-level delivery metadata store 540 (FIG. 5) for subsequent auditing, rerouting logic, or preference adjustment in future sessions.

Session feed and discovery interface 226 is operable to surface coordination sessions for review, selection, or participation by eligible users. More specifically, session feed and discovery interface 226 is operable to retrieve structured coordination session records from group coordination and session management component 208 and format those records into personalized, filterable, or location-aware session feeds. Session records may include metadata such as session type (e.g., public, invite-only), merchant identity, item configuration summary, fulfillment modality, and time constraints. In certain embodiments, session feed and discovery interface 226 applies priority rules to sort and rank sessions based on match proximity, compatibility likelihood, or user participation history.

For example, a first user device 110 may issue a discovery request based on current location and a preference for splitable vegetarian items. Session feed and discovery interface 226 retrieves coordination session summaries matching those filters and applies scoring logic to prioritize sessions where the user is already partially matched or invited. The resulting feed includes only sessions that pass eligibility rules and visibility constraints as enforced by eligibility rules engine 228.

Eligibility rules engine 228 is operable to evaluate coordination session eligibility based on user attributes, merchant constraints, item restrictions, and session-level configuration parameters. More specifically, eligibility rules engine 228 is operable to apply schema-conformant rulesets that assess whether a given user device 110 or structured item token is permitted to participate in a coordination session, based on real-time system context. Rules may evaluate delivery zones, participation caps, user dietary flags, merchant availability windows, or exclusion policies defined in merchant-side structured data ingestion system 112.

In an embodiment, eligibility rules engine 228 receives a candidate match submission from group coordination and session management component 208 and applies validation logic to confirm that the submitted item token, user metadata, and session status conform to all applicable constraints. If the submission fails a rule (e.g., item not available in user's delivery zone), the match is rejected, and a constraint violation flag is returned. Eligibility rules engine 228 may operate in batch or real-time modes and may support rule override logic for system-defined exceptions or promotions.

Event coordination engine 224 is operable to instantiate, configure, and manage coordination events based on schema-aligned item offerings, session logic, and platform-defined engagement workflows. More specifically, event coordination engine 224 is operable to receive structured coordination event creation requests from user device(s) 110 or merchant-side structured data ingestion system 112, assign event-level metadata (e.g., event title, session rules, timing windows), and associate those events with an active coordination session managed by group coordination and session management component 208.

In an embodiment, event coordination engine 224 supports creation of both public and private coordination events, each associated with parameters including allowable items, maximum participants, visibility constraints, and scheduling rules. For public events, event coordination engine 224 may expose the event via session feed and discovery interface 226, subject to eligibility validation from eligibility rules engine 228. For private events, the engine may restrict participation to invited users or authenticated groups.

For example, a merchant may submit an event creation request specifying a lunch-only group order for a fixed-price platter that supports up to four participants. Event coordination engine 224 associates the event with a merchant-defined coordination session, attaches timing metadata that limits participation to a weekday window from 11:00 AM to 1:30 PM, and enforces a lock-in threshold of three confirmed users. Once these parameters are registered, the event is surfaced in the discovery interface if designated public, or held in a pending state until invited users confirm participation.

In certain embodiments, event coordination engine 224 integrates with promotion and monetization logic module 220 to apply incentives or targeted campaigns. For instance, a merchant may define a promotional flag that offers reduced split fees for coordination events tied to specific item categories or times of day. These configurations are encoded in the coordination event metadata and propagated through group coordination and session management component 208 to ensure consistency across eligibility, pricing, and fulfillment orchestration modules.

In various embodiments, multi-user coordination and data processing system 103 includes additional subcomponents that enable structured compatibility resolution workflows based on item token metadata and learned user preference embeddings. These subcomponents interface with compatibility vector modeling logic (see FIG. 3) to support latent preference alignment, enabling match resolution even when user selections are only partially aligned. For example, a coordination session may be finalized when multiple users select different but vector-compatible item tokens, based on co-occurrence patterns or historical ordering behavior. These matching events are propagated to item matching and compatibility engine 210 and influence the session resolution thresholds enforced by group coordination and session management component 208.

In an embodiment, promotion and monetization logic module 220 is operable to trigger social incentive workflows when participation thresholds are met or exceeded. These workflows may include automatic discount application, item unlock events, or priority placement within the session feed and discovery interface 226. For example, when a coordination session includes four or more users, and the item configuration supports additional users without exceeding splittability limits, the system may expose the session to expanded discovery zones or trigger a “group unlocked” incentive that applies to eligible item tokens. These updates are propagated to notification and alert module 218 and reflected in user-facing coordination interfaces.

In certain embodiments, geolocation and delivery routing processor 222 interacts with session telemetry from prior fulfillment events to dynamically adjust routing logic based on system load, traffic conditions, and merchant preparation reliability. For example, if a merchant location has a historical delay distribution exceeding configured tolerances, the system may automatically insert a preparation buffer into future fulfillment orchestration plans. This adjustment is reflected in the orchestration instructions generated by order sequencing and fulfillment orchestration module 214 and recorded in the order-level delivery metadata store 540 (see FIG. 5).

### Data Processing and Enrichment System

FIG. 3 illustrates an example configuration of data processing and enrichment system 108 in accordance with various embodiments of the present disclosure. In the illustrated embodiment, data processing and enrichment system 108 includes input normalization module 302, schema mapping engine 304, item schema correlation and matching engine 307, user-generated feedback and ranking correlation module 305, vector embedding generator 306, match scoring and prioritization engine 308, feedback integration and signal reweighing module 310, optimization mode selector 312, partial match handler 314, inferred portion compatibility engine 316, preference synthesis and user compatibility module 318, enriched record output formatter 320, user preference datastore 330, item attribute datastore 332, match outcome datastore 334, review signal datastore 336, and system performance metadata log 338.

Input normalization module 302 is operable to receive raw item records, user-submitted selections, and merchant-originating data and transform them into schema-conformant representations compatible with downstream matching and scoring processes. More specifically, input normalization module 302 is operable to parse incoming item inputs—whether from merchant-side structured data ingestion system 112, user device(s) 110, or event coordination engine 224—and standardize them to a unified attribute schema that supports vector embedding and compatibility resolution.

For example, input normalization module 302 may receive a merchant item record that includes freeform modifiers (e.g., “gluten-free option,” “half portion available”) and normalize these into structured flags aligned to the system schema (e.g., {splittable: true, dietary_tags: [‘gluten_free’], portion_variants: [0.5, 1.0]}). Similarly, a user-submitted item selection with notes such as “prefer delivery after 7 pm” may be converted into structured session attributes (e.g., {preferred_modality: ‘delivery’, scheduling_constraints: {after: 19:00}}). The normalized records are emitted in a canonical format used across downstream components including schema mapping engine 304 and vector embedding generator 306.

In certain embodiments, input normalization module 302 applies domain-specific transformations to support multi-format ingestion. For instance, when receiving JSON from a merchant API, the module applies field mapping rules and type coercion (e.g., converting string-based numeric values into float-based price fields). When processing user selection records from frontend interfaces, the module maps selection UI states to internal enum keys (e.g., “Pickup”→FULFILLMENT_MODALITY_PICKUP). Normalization may further include default population (e.g., defaulting quantity to 1 when unspecified), constraint validation, and sanitization of ambiguous fields using schema-bound heuristics.

Input normalization module 302 serves as an initial stage of the structured data processing pipeline shown in FIG. 3. Input normalization module 302 is operable to ensure that received item records and user selection data conform to expected attribute types, required fields, and formatting constraints used by downstream components. More specifically, input normalization module 302 validates field presence, converts variant encodings into consistent types, and applies system-defined formatting rules to numerical, categorical, and temporal fields. For example, string-based quantity values may be converted to numeric representations, unstructured dietary notes may be mapped to controlled tags, and malformed timestamps may be corrected using merchant-specific configuration parameters. These normalized item and selection records are passed to schema mapping engine 304 for alignment with system-recognized schema structures.

Schema mapping engine 304 is operable to align normalized item and selection records with an internal attribute schema used for token generation, compatibility modeling, and downstream orchestration logic. More specifically, schema mapping engine 304 is operable to assign structured field keys, resolve semantic ambiguities, and apply schema-bound transformations that convert normalized records into schema-aligned tokens consumable by vector embedding generator 306 and match scoring and prioritization engine 308.

In an embodiment, schema mapping engine 304 receives a set of normalized attributes from input normalization module 302, such as {item_name: “Pad Thai”, splittable: true, dietary_tags: [“vegetarian”], price: 14.50}, and maps these fields to schema-specific keys and representations (e.g., token_type: ITEM, attributes.diet: VEGETARIAN, pricing_model: FIXED_UNIT). The engine resolves conflicts and ambiguity using lookup tables, rule-based field mappings, or domain-specific synonym classes. For example, input variants such as “gluten free,” “GF,” or “no gluten” may be unified under a standard GLUTEN_FREE dietary tag defined in the schema.

Schema mapping engine 304 may further support multi-schema compatibility. In certain embodiments, the system includes multiple schema templates—such as RESTAURANT_MENU_SCHEMA, RETAIL_BUNDLE_SCHEMA, and DIGITAL_SERVICE_SCHEMA—to enable cross-domain item modeling. Schema mapping engine 304 selects the appropriate template based on the source context or declared item category and maps field inputs accordingly. For instance, a RETAIL_BUNDLE_SCHEMA may require variant group handling (e.g., sizes, flavors) whereas RESTAURANT_MENU_SCHEMA may use portion scaling and fulfillment modality tags.

In certain embodiments, schema mapping engine 304 interacts with merchant rule configuration interface 410 (see FIG. 4) to ingest merchant-specific overrides, mapping rules, or exclusion constraints. These mappings are persisted and reused for future ingestion sessions. Additionally, schema mapping engine 304 outputs schema-conformant tokens to be stored in structured menu metadata datastore 440 or emitted directly into the embedding and scoring pipeline.

By enforcing canonical field structures and aligning diverse inputs to a unified schema, schema mapping engine 304 outputs schema-conformant item tokens suitable for scoring, compatibility evaluation, and fulfillment rule enforcement. This structured alignment enables downstream components to evaluate token-level metadata deterministically based on predefined schema logic. For example, fulfillment orchestration modules may interpret splittability attributes, portion sizing parameters, and modality constraints as structured decision points rather than freeform user inputs. The use of a unified schema ensures that item tokens carry consistent attributes across merchants and data sources, supporting compatibility scoring and fulfillment workflows executed across modular components of the system.

Item schema correlation and matching engine 307 is operable to evaluate the structural and semantic alignment between multiple item records submitted by different users, merchants, or systems. More specifically, item schema correlation and matching engine 307 is operable to compare tokenized item records received from schema mapping engine 304 and determine whether they correspond to the same or comparable items based on schema-aligned attributes, attribute weights, and system-defined correlation rules.

For example, item schema correlation and matching engine 307 may determine that a “half pepperoni pizza” selected from one restaurant's digital menu corresponds to a “large pizza with custom toppings” selected from another source, where the system recognizes overlapping attributes such as base item type (pizza), topping vector (pepperoni), and portion size tags (½, large). In another example, two users may submit records referencing the same menu item using differently formatted identifiers or partial descriptors. Item schema correlation and matching engine 307 applies attribute-level tokenization, value normalization, and probabilistic alignment logic to determine if the records refer to the same item.

In certain embodiments, item schema correlation and matching engine 307 invokes canonical reference checks to align variant item records against a known item catalog or merchant-specific schema registry. Schema-derived matching rules may incorporate attribute weightings, confidence thresholds, and context-aware modifiers (e.g., location, merchant ID, fulfillment mode) to enhance precision. The correlation process produces a set of canonicalized item identifiers and correlation scores for use by downstream scoring and orchestration components.

In an embodiment, item schema correlation and matching engine 307 further supports conflict resolution across ambiguous matches. For example, when two item tokens exhibit partial overlap but diverge in key dimensions—such as ingredient exclusions or incompatible portioning—item schema correlation and matching engine 307 may output a null correlation status or defer matching until additional user clarification is received. These conflict outcomes are encoded as part of the session state tracked by group coordination and session management component 208 of FIG. 2.

Item schema correlation and matching engine 307 thereby enables system-level item equivalency resolution based on structured metadata and alignment logic, without relying on static string-matching or user-provided normalization. This supports consistent compatibility modeling across merchant-divergent item data sources that lack consistent field definitions or schema conformity.

User-generated feedback and ranking correlation module 305 is operable to ingest, structure, and correlate user-generated review signals, observed fulfillment outcomes, and external ranking metadata to reweight item compatibility vectors and influence match prioritization. More specifically, user-generated feedback and ranking correlation module 305 is operable to receive post-fulfillment review data (e.g., ratings, comments, flags), delivery performance metrics (e.g., delays, packaging issues), and third-party metadata (e.g., star ratings, social recommendations), and correlate these signals with structured item records and user compatibility vectors generated by item schema correlation and matching engine 307.

In an embodiment, user-generated feedback and ranking correlation module 305 semantically parses freeform user comments using natural language processing and maps relevant sentiment indicators to structured tags associated with the reviewed item. For example, a comment indicating poor packaging quality may be translated into a structured signal under a “delivery integrity” dimension, while a positive note about portion accuracy may reinforce the “portion trustworthiness” vector for that item. These tags are aligned with compatibility scoring attributes used in match scoring and prioritization engine 308.

In certain embodiments, user-generated feedback and ranking correlation module 305 applies weighting adjustments to item vectors or user preference embeddings based on signal consistency, recency, and reviewer reliability. For example, if multiple users submit high-confidence feedback on an item's shareability or delivery reliability, the associated compatibility weights may be increased system-wide. Conversely, anomalous patterns—such as repeated late deliveries or frequent portion mismatches—may trigger downgrade signals or feedback audits. These adjustments are stored in review signal datastore 336 for downstream integration.

In an embodiment, the module supports confidence scoring and traceability tagging, associating each reweighting event with a corresponding feedback artifact, timestamp, and data provenance marker. This traceability ensures that system-level prioritization decisions remain auditable and explainable, particularly in edge cases where feedback signals diverge from prior compatibility expectations.

User-generated feedback and ranking correlation module 305 further supports feedback loop closure by propagating adjusted vectors to match scoring and prioritization engine 308 and preference synthesis and user compatibility module 318. In certain embodiments, structured feedback may also be surfaced to merchants through external interfaces to influence future configuration of item portioning, availability flags, or pricing constraints.

Vector embedding generator 306 is operable to transform normalized and schema-aligned item records into numerical vector representations used for compatibility scoring and match evaluation. More specifically, vector embedding generator 306 receives structured item tokens from schema mapping engine 304 and applies deterministic encoding logic to generate feature vectors that represent key attributes of each item, including portion type, cuisine classification, splittability constraints, fulfillment modality, and merchant-defined tags.

In certain embodiments, vector embedding generator 306 applies rule-based or model-assisted embedding strategies. For example, a splittable entrée with vegetarian tags and dine-in-only availability may be encoded as a vector with binary, categorical, and numerical dimensions reflecting these structured fields. These vectors are generated consistently across all users and merchants to ensure downstream compatibility modeling is computed on a uniform vector space.

In an embodiment, vector embedding generator 306 also receives user selection vectors from input normalization module 302, transforming user-specific preferences and selection records into aligned embedding representations. These embeddings may include inferred or historical preference signals, derived from prior coordination sessions or ranked feedback inputs processed by user-generated feedback and ranking correlation module 305.

The output of vector embedding generator 306 includes system-aligned feature vectors that represent both item attributes and user selections, which are then supplied to match scoring and prioritization engine 308 for evaluation of compatibility, threshold fulfillment, and ranking prioritization across candidate coordination sessions.

Match scoring and prioritization engine 308 is operable to evaluate the compatibility of item selection vectors and user preference embeddings to determine match eligibility, fulfillment readiness, and prioritization across coordination sessions. More specifically, match scoring and prioritization engine 308 receives item and user vectors from vector embedding generator 306 and computes scalar similarity scores based on schema-aligned feature dimensions, weighted participation signals, and fulfillment constraints.

In an embodiment, match scoring and prioritization engine 308 applies configurable scoring logic that accounts for item-level features (e.g., splittability, dietary compatibility, fulfillment modality), user alignment vectors, and coordination session parameters (e.g., portion availability, time windows, merchant constraints). The engine evaluates whether a proposed item grouping satisfies defined matching thresholds such as minimum user participation, required item combinations, or total order value bounds.

For example, in a coordination session involving a splittable menu item marked with a two-user minimum and vegetarian dietary flag, match scoring and prioritization engine 308 may compute a compatibility score by comparing user preference embeddings against item vectors and aggregating fulfillment feasibility metrics. If multiple coordination sessions are available, match scoring and prioritization engine 308 ranks the sessions based on aggregate score and fulfillment readiness, returning top-ranked matches for downstream orchestration.

In certain embodiments, match scoring and prioritization engine 308 supports session-level re-evaluation logic, wherein updated user entries or additional participants trigger recomputation of compatibility scores across pending coordination sessions. The engine also flags borderline matches for deferred evaluation by partial match handler 314 and transmits confirmed matches to orchestration logic for fulfillment preparation.

Feedback integration and signal reweighing module 310 is operable to incorporate user-generated feedback, delivery performance signals, and external metadata into dynamic scoring adjustments across compatibility modeling workflows. More specifically, feedback integration and signal reweighing module 310 receives structured feedback records from user interactions, delivery outcomes, and session-level telemetry, and applies those signals to reweight feature importance within vector scoring and compatibility evaluation logic.

In an embodiment, feedback integration and signal reweighing module 310 receives post-fulfillment signals such as user satisfaction scores, rating-based attribute feedback, delivery punctuality metrics, and match dropout frequency. These signals are stored in review signal datastore 336 and are aligned with structured schema fields used in match scoring and prioritization engine 308. Reweighted importance factors may be applied to downstream session matching, reranking of item results, or prioritization of routing options during orchestration.

For example, if a particular item has a high dropout rate in past coordination sessions due to excessive preparation time, feedback integration and signal reweighing module 310 may reduce its default selection weight in future compatibility modeling workflows. Similarly, if a user consistently downvotes shared portions involving specific modifiers (e.g., “extra spicy”), the system may reweight those attribute vectors downward for that user profile during matching.

In certain embodiments, feedback integration and signal reweighing module 310 supports reinforcement-based feedback propagation. This includes using positively rated fulfilled sessions to incrementally reinforce vector weights for participating items or session structures, and penalizing items, modifiers, or configurations correlated with negative outcomes. Reweighted vectors are supplied back to vector embedding generator 306 and match scoring and prioritization engine 308 to continuously refine future compatibility predictions.

In an embodiment, the system supports merchant-defined upsell configurations embedded into orchestration payloads. For example, a restaurant may define an upsell promotion that triggers when a combo exceeds two participants: “Add shrimp for $2 extra to any pad thai split 3 ways.” This logic is injected at the matching stage and surfaced in the user interface pre-checkout. Upsell performance telemetry is stored per item and used in adaptive pricing strategy tuning, which may trigger revised cost allocation during high-match-density periods.

Optimization mode selector 312 is operable to adjust the compatibility evaluation strategy, prioritization logic, and coordination behavior of the system based on system-level runtime conditions, session attributes, and user-defined preferences. More specifically, optimization mode selector 312 selects between predefined optimization modes—such as throughput-first, user-priority, merchant-constrained, or fulfillment-latency-minimized—and activates corresponding parameter sets used by match scoring and prioritization engine 308, partial match handler 314, and group coordination and session management component 208 of FIG. 2.

In an embodiment, optimization mode selector 312 receives runtime signals including user density, active session counts, route congestion indicators, and fulfillment resource availability. Based on system-defined thresholds or configuration logic, optimization mode selector 312 selects an appropriate operating mode and propagates weighted instruction sets across the compatibility modeling pipeline. For example, under a throughput-first mode, the system may prioritize sessions with the greatest number of partially compatible users to maximize resource usage. Under a latency-minimized mode, session matching may favor geographic proximity and simpler item configurations to reduce orchestration time.

In certain embodiments, optimization mode selector 312 also incorporates merchant-defined constraints or user-preference metadata. For instance, a merchant may opt into a “weekday batch” mode, where compatible groupings are only finalized if they include three or more participants before 11:30 AM. Alternatively, a user may define a personal “fast match” mode, which causes the system to bypass waiting for additional participants and accept partial matches sooner.

Optimization mode selector 312 outputs its selected mode parameters to downstream components, including partial match handler 314, inferred portion compatibility engine 316, and enriched record output formatter 320, enabling the system to dynamically tailor fulfillment readiness, cost allocation logic, and notification behaviors according to the selected coordination strategy.

Partial match handler 314 is operable to manage coordination sessions that do not yet meet system-defined fulfillment thresholds. More specifically, partial match handler 314 evaluates user-submitted item tokens and compatibility scores received from match scoring and prioritization engine 308, and determines whether a partial grouping satisfies intermediate criteria for deferred fulfillment, waitlist promotion, or partial execution workflows.

In an embodiment, partial match handler 314 applies rule-based logic to determine whether incomplete matches may be retained in a pending state. This includes evaluating participation counts, match density ratios, item-level splittability attributes, and timing constraints derived from session metadata. Partial match handler 314 may initiate deferral timers, associate a session with a waitlist pool, or trigger targeted notifications to eligible users for session promotion. Deferred sessions may also be re-evaluated as new users join the platform or as item availability changes.

For example, if a coordination session has accumulated three out of a required four participants for a meal kit with a four-way split flag, partial match handler 314 may defer execution for a defined duration while surfacing the session to nearby users with matching profiles. In another example, a split item with a two-person threshold and one committed participant may be temporarily moved to a regional waitlist queue while enabling the system to continue accepting new inputs for potential match completion.

In certain embodiments, partial match handler 314 also tracks historical resolution rates for pending sessions and adjusts retry logic or promotion strategies accordingly. For instance, sessions with low likelihood of completion based on past engagement patterns may be deprioritized, while sessions nearing fulfillment may be prioritized with proactive notifications and dynamic fee adjustments to incentivize final matches.

Outputs generated by partial match handler 314 are transmitted to group coordination and session management component 208 and event coordination engine 224 for status synchronization, session display logic, and routing of deferred coordination opportunities.

Inferred portion compatibility engine 316 is operable to evaluate implicit user compatibility with structured item tokens based on portion configuration attributes and inferred participation vectors. More specifically, inferred portion compatibility engine 316 is operable to determine whether a user, despite not having explicitly selected a particular item or portion configuration, aligns with a current session's item grouping based on prior behavior, schema-conformant preferences, and real-time engagement signals.

In an embodiment, inferred portion compatibility engine 316 receives normalized user profile vectors from preference synthesis and user compatibility module 318, along with structured item tokens annotated with portion attributes (e.g., shareability flags, split ratios, partial claim windows). The engine applies compatibility heuristics and model-driven alignment logic to determine whether a given user would accept or contribute to a partially configured shared item.

For example, if a session includes a three-way split for a family-style entrée with a known maximum split factor of four, and a candidate user has not actively selected the item but has historically participated in similar groupings with aligned cuisine types, dietary tags, and portion sizes, inferred portion compatibility engine 316 may surface this session as a high-probability match. In such a case, the engine may flag the user as eligible for automatic suggestion, deferred opt-in, or implicit recommendation.

In another example, if a user historically avoids items flagged as “contains dairy” and a partially matched item includes dairy as a minor attribute, the engine may down-rank compatibility or eliminate the user from consideration. These evaluations are not based on direct selection behavior but on vector distance scoring across item metadata and latent user preference clusters.

In certain embodiments, inferred portion compatibility engine 316 supports fallback logic where high-confidence inferences may trigger automatic inclusion in preview sessions, especially when session thresholds are nearly satisfied. For instance, when an item requires four participants and three confirmed participants are already present, the engine may temporarily include a fourth inferred participant for coordination display purposes, with backend constraints preventing final execution unless that user confirms.

Outputs generated by inferred portion compatibility engine 316 are routed to group coordination and session management component 208 for eligibility confirmation, compatibility logs, and real-time session display updates. These inferred signals may also be logged in system performance metadata log 338 for tracking inference precision, recall, and resolution convergence across similar scenarios.

Preference synthesis and user compatibility module 318 is operable to generate structured user preference vectors and evaluate user-to-item compatibility using schema-aligned representations of user behavior, explicit settings, and historical coordination patterns. More specifically, preference synthesis and user compatibility module 318 is operable to ingest explicit user selection data, parse past participation logs, extract preference indicators from ranking and feedback signals, and output compatibility vectors for downstream matching components.

In an embodiment, preference synthesis and user compatibility module 318 receives structured data from user preference datastore 330 and review signal datastore 336. This data includes positive and negative feedback on prior shared sessions, selection frequencies across item categories, cuisine types, fulfillment modes (e.g., dine-in, delivery), and time-based participation patterns. The module applies vectorization logic to convert this data into structured user embeddings that are used in real-time compatibility scoring.

For example, if a user has previously joined group sessions involving vegan items during weekday lunch windows, the system may weight future vegan item sessions during similar timeframes higher in compatibility. The vector for that user may include positive weights for the ‘vegan’ tag, moderate weights for ‘gluten-free’ due to occasional selection, and negative weights for ‘seafood’ based on exclusion history or negative feedback in prior matches.

In certain embodiments, preference synthesis and user compatibility module 318 incorporates ranking correlation signals from user-generated feedback and ranking correlation module 305. This allows compatibility vectors to reflect not only item selection frequency but satisfaction scores, allowing the system to bias future matches toward not only likely participation but successful prior experiences.

In an embodiment, this module is operable to produce comparative user-to-user alignment scores in addition to item-level vectors. For example, in high-traffic session environments (e.g., office buildings or campus zones), preference synthesis and user compatibility module 318 may determine that a user's pattern most closely aligns with another high-frequency participant and bias session suggestions toward those in which both users have historically co-participated with positive outcomes.

Compatibility vectors generated by preference synthesis and user compatibility module 318 are used by match scoring and prioritization engine 308, inferred portion compatibility engine 316, and group coordination and session management component 208 to resolve active and latent matches. Vectors may be continuously refined based on telemetry inputs and user-specific event outcomes stored in system performance metadata log 338.

In accordance with various embodiments, the components of data processing and enrichment system 108 described above—including input normalization module 302, schema mapping engine 304, vector embedding generator 306, match scoring and prioritization engine 308, partial match handler 314, inferred portion compatibility engine 316, and preference synthesis and user compatibility module 318—are operable to support tokenization and compatibility modeling across a broad range of merchant-defined, splittable item types. While certain examples reference food-based menu items, the underlying architecture is not limited to any particular domain. Item records may represent physical goods, bundled services, fractional access products, or any partitionable resource capable of being structured into schema-aligned tokens with compatibility-relevant metadata. For example, a shared retail product (e.g., multi-pack electronics), fractional service (e.g., split subscription), or co-owned asset (e.g., vehicle rental block) may be tokenized and processed through the same data pipeline. These tokenized items may include custom portioning rules, fulfillment constraints, or domain-specific allocation logic, which are preserved throughout the compatibility resolution and orchestration workflow.

Enriched record output formatter 320 is operable to compile, structure, and serialize compatibility results, pricing data, and session metadata into a system-aligned output format for downstream consumption. More specifically, enriched record output formatter 320 is operable to receive matched item groupings, user allocation stubs, fulfillment constraints, and orchestration triggers from upstream components—including match scoring and prioritization engine 308, price allocation and cost-splitting engine 212, and order sequencing and fulfillment orchestration module 214—and serialize these data into enriched record structures that conform to a predefined output schema.

In an embodiment, enriched record output formatter 320 generates record bundles that include a compatibility result vector, an item-token-to-user mapping, fulfillment timing flags, split item metadata, and external routing attributes. The record bundles may be structured as protocol-conformant payloads, such as JSON or Avro messages, and may include embedded references to delivery identifiers, event session IDs, and merchant configuration hashes. These formatted records are operable to be transmitted to fulfillment routing and logistics interface system 111, stored in match outcome datastore 334, and used by notification and alert module 218 to trigger user-specific alerts.

For example, enriched record output formatter 320 may output a structured order package that specifies: (i) item token ID 1007 (e.g., “large vegetarian pizza”) matched between two users, (ii) participant A is assigned a ½ portion with added toppings and a modified pickup time, (iii) participant B is assigned a ½ portion with default configuration, (iv) the matched group meets a delivery threshold configured by the merchant, and (v) the downstream orchestration status is set to “ready for lock.” The resulting formatted record includes references to user profile tokens, merchant system IDs, route preference vectors, and allocation summaries, enabling end-to-end orchestration without requiring additional reconciliation.

In certain embodiments, enriched record output formatter 320 is further operable to anonymize or abstract sensitive data fields prior to export, enabling integration with third-party analytics platforms, audit systems, or merchant dashboards. The formatter may include modular formatting templates that are dynamically selected based on target system capabilities (e.g., POS system version, logistics provider format, or internal archive policy), and may embed cryptographic hashes or digital signatures for traceability.

Enriched record output formatter 320 ensures consistency across downstream modules by generating canonical payload structures that align with schema definitions enforced by schema mapping engine 304. The formatting process supports traceable, reproducible fulfillment records, aligning real-time user participation signals with deterministic output generation used in distributed fulfillment workflows.

User preference datastore 330 is operable to store structured representations of user-submitted preferences, compatibility signals, historical ordering activity, and system-generated inference vectors used across coordination, matching, and personalization workflows. More specifically, user preference datastore 330 maintains schema-aligned records that associate user identifiers with selection behaviors, fulfillment modality choices, portioning tolerances, dietary constraints, and previously confirmed match sessions.

In an embodiment, user preference datastore 330 includes persistent user preference vectors constructed from explicit input (e.g., selected cuisines, item exclusions, or split preferences) and implicit signals (e.g., historical acceptance of vegetarian matches, avoidance of delivery orders over 30 minutes, or repeated participation in group sessions with shared modifiers). These vectors may be structured into weighted embeddings or rule-based attribute profiles for use by vector embedding generator 306, preference synthesis and user compatibility module 318, and feedback integration and signal reweighing module 310.

For example, a given user record may reflect: (i) a preference weight of 0.8 for “dine-in” orders, (ii) a historical tolerance for ⅓ split portions on entrees, (iii) a high match reliability with users from a defined social graph or location radius, and (iv) a feedback-derived aversion to matches involving high-sodium items. This structured preference data is referenced during compatibility evaluation, match scoring, and user-specific alert generation to improve outcome alignment and reduce drop-out or match failures.

User preference datastore 330 may be updated continuously or on defined system events (e.g., session completion, preference reconfiguration, or delivery review submission), and may include timestamped metadata for versioned inference across time-sensitive workflows. In certain embodiments, the datastore supports user-defined privacy constraints, exclusion rules, or override policies, which are enforced during read or write access by relevant system components.

User preference datastore 330 operates in conjunction with item attribute datastore 332 and match outcome datastore 334 to enable longitudinal learning, inferred compatibility modeling, and real-time personalization across session lifecycle phases. The stored data is indexed for efficient retrieval during high-throughput match evaluation and may support hybrid deployments across edge and cloud environments to optimize latency in mobile interface interactions.

In another embodiment, the system supports opt-in social discovery via a feature known as “Tivott Meet” or other appropriate name. Users may allow compatibility-based session exposure based on taste vectors, dietary tags, and profile visibility. A match may be considered a “Meet candidate” when latent vector alignment exceeds a confidence threshold (e.g., cosine similarity >0.90) and both users have enabled public discovery for at least one matching cuisine tag. In an embodiment, these sessions are surfaced in a discovery interface that highlights food-based alignment and includes features for chat initiation, mutual dish review history, and opt-in physical co-pickup or dine-in options.

Item attribute datastore 332 is operable to store schema-aligned representations of merchant-provided item configurations, structured metadata derived during ingestion, and system-generated compatibility indicators associated with each item. More specifically, item attribute datastore 332 maintains normalized records that include item-level attributes such as splittability flags, portioning configurations, pricing constraints, fulfillment modality restrictions, dietary classifications, and promotion eligibility markers.

In an embodiment, item attribute datastore 332 receives structured input records from merchant-side structured data ingestion system 112 (via the ingestion pipeline of FIG. 4) and stores each item as a structured entity with canonical field alignment. For example, a record for a given item may include: (i) a splittability setting of 4, indicating a maximum of four participants may share the item; (ii) valid fulfillment modalities set to “pickup” and “delivery”; (iii) a set of dietary tags including “vegetarian” and “gluten-free”; (iv) a portion-size price mapping indicating ½=$6.50, ⅓=$4.75; and (v) a promotion flag indicating inclusion in a weekend group bundle.

During system operation, item attribute datastore 332 is accessed by components such as item schema correlation and matching engine 307, match scoring and prioritization engine 308, and inferred portion compatibility engine 316 to evaluate structured compatibility thresholds, filter out ineligible item-user combinations, and determine viable fulfillment workflows. Item records are stored in a format that supports both direct lookup by item ID and attribute-based filtering, enabling efficient integration with real-time query and match resolution workflows.

In certain embodiments, item attribute datastore 332 includes versioning metadata that allows the system to differentiate between historical item configurations and currently active attributes. This enables longitudinal analysis of match outcomes over time and supports reprocessing workflows when items are reintroduced or when schema definitions are updated.

Item attribute datastore 332 may be configured for scalable access across distributed coordination sessions and is structured to support high-concurrency read operations in response to user queries, session evaluations, and fulfillment orchestration triggers. The datastore may also include merchant-defined override parameters that govern availability windows, temporary exclusions, or limited-time constraints, all of which are enforced during orchestration and cost-splitting processes.

Match outcome datastore 334 is operable to store records of resolved compatibility evaluations, user participation thresholds, and coordination session outcomes generated by group coordination and session management component 208 and associated scoring components. More specifically, match outcome datastore 334 maintains structured data representing item-level match events, resolved user groupings, assigned fulfillment instructions, and associated threshold metadata.

In an embodiment, match outcome datastore 334 receives finalized compatibility groupings after execution by match scoring and prioritization engine 308, partial match handler 314, or inferred portion compatibility engine 316. Each stored outcome includes the resolved item token(s), participating user IDs, applied compatibility metrics, evaluated fulfillment constraints, and execution flags such as whether the session proceeded to orchestration or was deferred.

For example, a stored match record may indicate that a three-user coordination session resolved compatibility for a 3-way split of a merchant-provided meal bundle, using a combination of direct item token overlap and preference synthesis logic. The record may include: (i) the normalized item ID; (ii) user IDs and their associated portion shares; (iii) compatibility score breakdown by evaluation method; (iv) the timestamp and session ID; and (v) the resulting fulfillment mode (e.g., delivery).

Match outcome datastore 334 is referenced by downstream components such as order sequencing and fulfillment orchestration module 214 to generate routing instructions and preserve alignment with resolved cost shares. It is also accessed by feedback integration and signal reweighing module 310 to associate post-fulfillment feedback with historical session characteristics, enabling learning-based updates to future match weighting or eligibility logic.

In certain embodiments, match outcome datastore 334 includes deferred match attempts that did not yet reach a compatible threshold, with metadata allowing the system to reattempt resolution when new user activity or updated item availability is detected. The datastore may also support audit views to surface historical match performance metrics and identify repeated coordination bottlenecks.

In an embodiment, the system tracks session-level referral and initiation metadata for reward distribution. For example, if User A initiates a matchable combo and User B accepts the invite through a shared link, User A is attributed a referral credit. Credits may be session-based (e.g., “complete 5 matches, get $5”) or streak-based (e.g., “match every week for a month”). Rewards may be structured as flat monetary credits, point-based accruals, tokenized assets for redemption or trading, or badges and leaderboard placement.

In an embodiment, the system surfaces coordination sessions to users based on geographic proximity and shared item preferences. Geographic telemetry associated with a user profile or device may be evaluated against coordination session metadata to determine local session eligibility. Session exposure may be conditioned on alignment between latent preference vectors, session item tokens, and geographic radius parameters, such as shared ZIP code, delivery zone, or merchant-defined boundaries.

In an embodiment, the system supports fallback execution logic that enables a coordination session to convert to solo fulfillment when configured thresholds remain unmet. The system tracks timing metadata, active participation counts, and eligibility conditions for each coordination session. If a session does not satisfy the required fulfillment constraints within a configured timeout interval, the orchestration instructions are revised to generate a solo fulfillment flow for the initiating user, preserving original selection parameters and adjusting price shares accordingly.

Review signal datastore 336 is operable to store structured review data, user-generated feedback, and external performance signals associated with previously fulfilled coordination sessions. More specifically, review signal datastore 336 stores enriched feedback records mapped to structured item tokens, delivery metadata, merchant identifiers, and user interaction metrics for use by feedback integration and signal reweighing module 310 and other components of data processing and enrichment system 108.

In various embodiments, review signal datastore 336 includes direct user ratings, semantic interpretations of free-text comments, post-order reaction tags (e.g., “arrived cold,” “portion too small”), and third-party delivery performance indicators. Each record is linked to a match outcome ID from match outcome datastore 334 and includes schema-aligned references to items, merchants, and session participants. This structure allows the system to propagate signal weight updates through matching and ranking workflows.

For example, a record may include: (i) a 3-star rating from a user indicating dissatisfaction with portion sizing; (ii) structured tags derived from the text comment; (iii) a late delivery flag received from the fulfillment routing and logistics interface system 111; and (iv) the associated item ID and merchant ID. This record is processed and stored in review signal datastore 336 for downstream compatibility signal updates and session reweighting.

In certain embodiments, review signal datastore 336 supports signal aging, aggregation across time windows, and stratification by session type, delivery mode, or user profile segment. The datastore may also store anomaly detection metadata, such as user reports that diverge from expected session outcomes, which can trigger feedback loops for merchant moderation or fulfillment partner review.

In an embodiment, the system computes clustering metadata based on historic user selections and geographic telemetry, enabling discovery of taste-compatible coordination sessions within a defined radius. For example, users who frequently order Thai noodle dishes in ZIP code 78209 may be clustered and promoted similar dish combos (e.g., pad see ew, khao soi) during peak lunch hours. This enables hyper-local coordination and increases fulfillment density within delivery windows.

Review signal datastore 336 enables machine-level adaptation of future compatibility modeling and item visibility. It ensures that user experience feedback is transformed into structured signals that inform scoring logic in match scoring and prioritization engine 308 and influence future recommendations in item query and filtering engine 206.

System performance metadata log 338 is operable to store operational telemetry, processing diagnostics, and execution metadata generated by components of data processing and enrichment system 108. More specifically, system performance metadata log 338 records performance metrics associated with item normalization, compatibility resolution, match execution, fulfillment orchestration, and feedback propagation, enabling auditability, error tracing, and adaptive optimization of session workflows.

In various embodiments, system performance metadata log 338 stores structured entries tagged by coordination session ID, user ID, processing component ID, timestamp, and event outcome. Logged metadata includes latency metrics (e.g., normalization time, scoring delay, routing computation duration), processing success or failure codes, invocation parameters, and component-level outputs or exceptions.

For example, a log entry may include: (i) timestamped invocation of match scoring and prioritization engine 308 with input vector count and normalized token count; (ii) execution time for preference synthesis and user compatibility module 318; and (iii) success/failure flags from downstream fulfillment trigger operations initiated by order sequencing and fulfillment orchestration module 214. These entries are used to trace anomalies, evaluate load balancing efficiency, and inform dynamic throttling or fallback routines.

In certain embodiments, system performance metadata log 338 supports structured rollups by time window, component, merchant, or user cohort, and can trigger alerts or system parameter adjustments when deviations exceed system-defined thresholds. For instance, a surge in match computation latency beyond an SLA limit may trigger the optimization mode selector 312 to shift to a simplified scoring model or batch evaluation mode.

System performance metadata log 338 provides persistent, queryable records of system execution history. It supports audit functions, offline model tuning, and reliability assessments, ensuring that computational operations underlying tokenization, match resolution, and fulfillment orchestration are measurable and adaptable over time.

Although the datastores described above are illustrated as distinct components—such as user preference datastore 330, item attribute datastore 332, match outcome datastore 334, review signal datastore 336, and system performance metadata log 338—the underlying data may be maintained in a consolidated or distributed storage architecture. In various embodiments, the data may be stored in co-located systems, partitioned by function, or maintained remotely from data processing and enrichment system 108. For instance, one or more datastores may be hosted by third-party infrastructure providers or integrated into merchant or delivery partner systems, depending on deployment configuration and data access policies.

### Configuration of Merchant-Side Structured Data Ingestion System

FIG. 4 illustrates an example configuration of merchant-side structured data ingestion system 112 in accordance with one or more embodiments of the present disclosure. In the illustrated embodiment, merchant-side structured data ingestion system 112 includes merchant upload gateway 402, file type and structure classifier 404, structured content normalizer 406, unstructured content parser 408, merchant rule configuration interface 410, contextual tagging and categorization engine 412, structured-item linking module 414, visual media OCR and attribute parser 416, ingestion status monitor and error flagger 418, structured record generation module 420, and structured menu metadata datastore 440.

Merchant upload gateway 402 is operable to receive and route merchant-provided item data to merchant-side structured data ingestion system 112 for downstream processing. More specifically, merchant upload gateway 402 is operable to accept structured, semi-structured, or unstructured content originating from merchant platforms, point-of-sale (POS) systems, menu APIs, data exports, or manual submissions. In an embodiment, merchant upload gateway 402 supports multiple input channels, including API endpoints, partner-facing dashboards, direct file uploads, and webhook-based integrations for automated content synchronization.

For example, merchant upload gateway 402 may receive a JSON-based menu export from a third-party POS provider, a CSV spreadsheet manually uploaded through a merchant portal, or a PDF version of a printed menu submitted via email or partner interface. In each case, merchant upload gateway 402 encodes an initial metadata envelope describing the source, ingestion type, and merchant ID, and queues the content for file type classification and schema normalization by file type and structure classifier 404 and structured content normalizer 406.

In certain embodiments, merchant upload gateway 402 further includes request throttling and authentication mechanisms to enforce usage limits, validate request signatures, and log ingestion events for auditing purposes. Upload activity may be logged and cross-referenced with merchant account configuration data to ensure alignment with participation agreements and ingestion scheduling rules.

Accordingly, merchant upload gateway 402 serves as the ingress point for diverse merchant-originating menu and configuration data, enabling schema-conformant ingestion workflows that underpin multi-user compatibility modeling and fulfillment coordination described throughout the present disclosure.

File type and structure classifier 404 is operable to determine the structural characteristics and content modality of merchant-uploaded files received by merchant upload gateway 402. More specifically, file type and structure classifier 404 is operable to identify the file format (e.g., JSON, XML, CSV, PDF, HTML, PNG, JPEG) and classify whether the input contains structured, semi-structured, or unstructured data. This classification informs routing logic for subsequent parsing and normalization by downstream ingestion components.

In an embodiment, file type and structure classifier 404 uses file extension heuristics, MIME type analysis, and embedded metadata inspection to determine the base type. For unstructured or ambiguous files, file type and structure classifier 404 may further apply pattern-based detectors or lightweight content sampling to infer whether tabular data, tagged structures, or visual layouts are present. For example, a file containing JSON keys and values may be routed to structured content normalizer 406, whereas a PDF with minimal embedded text and image-heavy content may be routed to unstructured content parser 408 or visual media OCR and attribute parser 416.

In certain embodiments, file type and structure classifier 404 supports confidence scoring or fallback routing, enabling the system to defer ambiguous classifications to manual review or multi-path ingestion strategies. Additionally, classifier outputs are stored with metadata envelopes that propagate classification results through the remaining ingestion pipeline for logging, debugging, and ingestion traceability.

File type and structure classifier 404 provides the necessary structural awareness that enables ingestion pipelines to dynamically adapt to diverse merchant content formats, reducing ingestion failure rates and enabling higher fidelity parsing workflows. By frontloading classification logic and encoding file structure attributes into subsequent payloads, the system ensures that downstream parsing and transformation modules execute with format-specific expectations and validation constraints.

Structured content normalizer 406 is operable to process merchant-uploaded files identified as structured or semi-structured by file type and structure classifier 404 and to convert such content into schema-conformant intermediate records. More specifically, structured content normalizer 406 is operable to parse structured item entries, extract attribute fields, and transform vendor-specific representations into canonical field types and value ranges recognized by downstream components of multi-user coordination and data processing system 103.

In an embodiment, structured content normalizer 406 receives JSON or CSV payloads containing menu items, availability flags, pricing configurations, portion options, and scheduling constraints. Structured content normalizer 406 applies parsing rules to extract fields such as item name, description, price, splittability indicator, fulfillment modality, and active time windows. For example, a field labeled “SplitOption” in a vendor's CSV export may be mapped to a Boolean splittability attribute in the system schema, while a pricing tier expressed in nested JSON objects may be flattened and normalized into price-per-portion records.

Structured content normalizer 406 performs field normalization using system-maintained mapping dictionaries, data type coercion logic, and validation routines. For instance, textual representations of availability windows (“Lunch Only”) may be normalized into standard timestamp intervals; pricing values in various currencies or units may be converted using predefined exchange rate tables or merchant configuration preferences.

In accordance with various embodiments, structured content normalizer 406 also validates the presence of required fields, flags missing or malformed entries, and emits intermediate item records for downstream tagging, enrichment, and linking operations. Structured normalization may include logic for deduplicating repeated items, resolving field aliases, and applying default values based on merchant profiles stored in structured menu metadata datastore 440.

By providing a reliable transformation layer between merchant-defined structured data and internal schema-conformant item records, structured content normalizer 406 enables downstream ingestion components to operate deterministically and with predictable field integrity. This supports efficient tokenization, compatibility modeling, and fulfillment orchestration across all components of the system.

Unstructured content parser 408 is operable to extract structured item data from unstructured or semi-structured sources including freeform HTML, plain-text menus, or non-schema-aligned merchant item descriptions. More specifically, unstructured content parser 408 is operable to apply rule-based logic, pattern recognition methods, and natural language parsing techniques to detect item groupings, attribute boundaries, and associated modifiers from merchant-originated content that lacks explicit schema alignment. In certain embodiments, unstructured content parser 408 receives input from merchant upload gateway 402 that has been classified by file type and structure classifier 404 as unstructured. In response, unstructured content parser 408 tokenizes the input, applies text segmentation rules, and extracts candidate values for base price, dietary tags, timing restrictions, and splittability. For example, given a text string such as “Spicy Tofu Bowl—$9.99. Vegan, gluten-free. Available for lunch only. Shareable for up to 3 people,” unstructured content parser 408 is operable to extract the item name (“Spicy Tofu Bowl”), base price (9.99), dietary flags (“vegan,” “gluten-free”), time restriction (“lunch only”), and splittability constraint (“up to 3 people”). In certain embodiments, unstructured content parser 408 may also incorporate machine learning-based named entity recognition (NER) to identify and classify embedded attributes using context-aware language models trained on historical ingestion data. The resulting structured item records may include extracted attribute values, inferred metadata, and field-level confidence scores, which are then passed to contextual tagging and categorization engine 412 for enrichment. Outputs from unstructured content parser 408 enable consistent downstream processing of item records within data processing and enrichment system 108, regardless of the original format or labeling structure provided by the merchant.

Merchant rule configuration interface 410 is operable to receive, manage, and apply merchant-defined fulfillment constraints and item-level configuration parameters within the ingestion pipeline of merchant-side structured data ingestion system 112. More specifically, merchant rule configuration interface 410 is operable to enable merchants to define schema-conformant rules governing item splittability, availability windows, pricing constraints, portioning logic, and fulfillment modality restrictions. These rules are received through a structured interface, which may comprise an API endpoint, graphical rule editor, or structured file import utility.

In an embodiment, merchant rule configuration interface 410 supports the specification of constraints at both the item-level and category-level granularity. For example, a merchant may configure a rule stating that “Family Combo Meal A” can only be split by up to four users and only between the hours of 11:00 AM and 2:00 PM on weekdays. Another rule may define that certain items are not eligible for delivery and must be fulfilled via pickup or dine-in. These rules are encoded into system-compatible structures and passed to contextual tagging and categorization engine 412 and structured-item linking module 414 to ensure consistency throughout the ingestion workflow.

Merchant rule configuration interface 410 also includes logic for validating rule conformance and evaluating conflicts. For example, when a merchant uploads a new rule set, the interface may verify whether defined scheduling constraints overlap with existing system-level blackout periods or whether declared split factors conflict with the item's portioning metadata. In certain embodiments, merchant rule configuration interface 410 integrates with merchant user interfaces and dashboard tools, allowing real-time adjustment of rule parameters and triggering immediate downstream reprocessing of affected item records. These enriched rule definitions are preserved in structured menu metadata datastore 440 for use in compatibility modeling and fulfillment orchestration processes.

Contextual tagging and categorization engine 412 is operable to assign semantic labels, operational flags, and rule-based categories to normalized item records processed through the merchant-side structured data ingestion system 112. More specifically, contextual tagging and categorization engine 412 is operable to analyze structured or semi-structured item representations and apply classification labels, dietary flags, cuisine tags, merchant-defined item groups, and pricing tiers based on attribute patterns, merchant configuration rules, and contextual signals derived from prior ingestion cycles.

In various embodiments, contextual tagging and categorization engine 412 performs deterministic classification using field-level matching logic, such as mapping “Margherita Pizza” to an Italian cuisine category, tagging “Gluten-Free Pasta” with a dietary restriction label, or assigning “Lunch Combo #3” to a fixed-price category. These labels are generated using internal rule sets and are cross-referenced with merchant rule configuration interface 410 to enforce merchant-defined overrides or constraint-specific exclusions. For example, a merchant may define that “Combo A” should not be tagged as vegetarian, even if individual ingredients suggest otherwise.

In certain embodiments, contextual tagging and categorization engine 412 incorporates ML-assisted classification techniques, such as vector-based similarity scoring against a training set of previously tagged items. For instance, a newly uploaded item labeled “Spicy Chickpea Wrap” may be automatically assigned the “Vegan” and “Indian” tags based on historical embeddings derived from item title, description, and merchant category profiles. These tag assignments are persisted alongside the item record and may be used during compatibility evaluation and discovery workflows.

The tag and category metadata generated by contextual tagging and categorization engine 412 is stored in structured menu metadata datastore 440 and is used to guide downstream processing in FIG. 3 (e.g., preference matching, eligibility enforcement), FIG. 2 (e.g., query filtering, session discovery), and FIG. 5 (e.g., fulfillment constraint resolution). This tagging process ensures schema-conformant, machine-readable classification of merchant-uploaded content across heterogeneous input formats.

Structured-item linking module 414 is operable to identify, associate, and unify item records that correspond to previously ingested entries from the same or related merchants. More specifically, structured-item linking module 414 is operable to compare incoming structured item records-processed by earlier ingestion stages including normalization and tagging-against canonicalized menu records already stored in structured menu metadata datastore 440, enabling version control, merchant-driven updates, and item reuse across ingestion sessions.

In various embodiments, structured-item linking module 414 applies deterministic and probabilistic matching logic to assess record similarity. Deterministic logic may include exact or partial string matching on item titles, SKU codes, or merchant-defined item IDs. Probabilistic techniques may include similarity scoring based on tokenized title embeddings, vector comparisons of normalized attribute fields, or fuzzy matching of pricing and portion metadata. For example, if a merchant re-uploads “Veggie Bowl (Lunch)” with a new description and updated price, structured-item linking module 414 may resolve the new entry to the prior canonical record, linking them under a single internal identifier with versioned attributes.

In an embodiment, structured-item linking module 414 generates linking metadata such as change deltas, last updated timestamps, and linkage confidence scores. These linkage records allow the system to preserve continuity of historical item performance (e.g., click rates, match outcomes, fulfillment reliability) even when merchants periodically revise item details. This also enables consistent downstream behavior in compatibility modeling (e.g., ensuring that user preference vectors trained on a previous item version still apply to the revised variant).

In certain embodiments, structured-item linking module 414 also supports alias resolution and merchant-level override logic. For instance, two visually distinct menu items—“Spicy Lentil Wrap” and “Chili Chickpea Roll”—may be explicitly linked by a merchant through the merchant rule configuration interface 410 to treat them as fulfillment equivalents during compatibility evaluation or matching logic. These merchant-defined associations are stored as structured equivalence rules and applied across ingestion sessions.

The structured-item linking process improves system continuity and reduces duplication within structured menu metadata datastore 440, enabling components in FIG. 3 and FIG. 2 to operate on stable, referenceable item records even across multiple ingestion events or merchant configuration changes.

Visual media OCR and attribute parser 416 is operable to extract structured item data from image-based uploads, such as menu photographs, promotional flyers, or scanned documents. More specifically, visual media OCR and attribute parser 416 is operable to detect and isolate visual content, apply optical character recognition (OCR) to extract textual data, and parse the extracted content into structured attribute fields that conform to internal ingestion schemas.

In various embodiments, visual media OCR and attribute parser 416 receives media uploads through merchant upload gateway 402 or associated webhook integrations, and applies preprocessing routines such as resolution normalization, contrast enhancement, and layout detection. Image segmentation algorithms are used to identify text blocks, headers, tabular regions, or annotated price indicators, which are then passed to an OCR engine for text extraction. The extracted content may include item names, pricing information, modifiers, or availability flags.

Visual media OCR and attribute parser 416 is further operable to apply layout-informed parsing logic to infer relationships between extracted elements. For example, if a price appears to the right of an item name across multiple rows, the parser will assign the price to the corresponding item record. Font size and alignment may be used to distinguish categories, such as section headers (“Appetizers,” “Entrees”) versus individual items. In certain embodiments, rule-based heuristics or machine learning classifiers are used to identify and label fields such as dietary indicators (e.g., “GF,” “V”), quantity suggestions, or item modifiers (e.g., “add chicken +$2”).

Parsed item elements are then passed to structured content normalizer 406 for schema alignment, and may optionally be linked to canonical menu entries via structured-item linking module 414. In an embodiment, extracted records are enriched with context tags from contextual tagging and categorization engine 412 before being serialized by structured record generation module 420.

The inclusion of visual media OCR and attribute parser 416 allows the system to ingest merchant offerings from unstructured visual sources where structured data is unavailable or incomplete. This capability broadens merchant participation, reduces onboarding friction, and enables ingestion continuity in cases where menus are distributed primarily in non-digital or image-based formats.

Ingestion status monitor and error flagger 418 is operable to monitor ingestion workflows across merchant-provided data sources and flag ingestion anomalies, schema mismatches, or transformation errors for resolution. More specifically, ingestion status monitor and error flagger 418 is operable to track ingestion pipeline execution across components of FIG. 4, identify incomplete or inconsistent data structures, and generate diagnostic output used for automated correction or human-in-the-loop review.

In various embodiments, ingestion status monitor and error flagger 418 subscribes to pipeline telemetry generated by structured content normalizer 406, unstructured content parser 408, visual media OCR and attribute parser 416, and structured record generation module 420. For each ingestion attempt, the module receives metadata describing source format, ingestion time, schema conformity scores, and field coverage completeness. Status entries are stored alongside the generated record in structured menu metadata datastore 440.

In an embodiment, ingestion status monitor and error flagger 418 is further operable to evaluate completeness rules and schema constraints. For example, if a required attribute such as item name, base price, or fulfillment modality is missing, the module flags the record as incomplete and either withholds it from further propagation or routes it to a human review queue. Similarly, if a schema-aligned record contains a field with unexpected type (e.g., non-numeric value in a numeric price field), the module applies type coercion rules or flags the field for manual override.

The module is also operable to detect record duplication, structural drift, or field-level inconsistencies across previously ingested entries from the same merchant. For example, if a merchant's previously submitted “Combo Meal A” record includes different components or price values in a new submission, ingestion status monitor and error flagger 418 logs a differential analysis and invokes version reconciliation logic as needed.

In certain embodiments, ingestion status monitor and error flagger 418 provides an interface for support users to view ingestion outcomes, inspect flagged records, and perform corrective edits prior to downstream usage. These corrections may then be fed back into parsing and normalization modules to improve future accuracy for that merchant.

By enabling runtime validation and structured error signaling, ingestion status monitor and error flagger 418 supports system reliability, data consistency, and ingestion completeness across a wide range of merchant input formats and ingestion channels.

Structured record generation module 420 is operable to generate finalized, schema-conformant internal item records based on the normalized, enriched, and linked data outputs received from upstream ingestion components. More specifically, structured record generation module 420 is operable to consolidate outputs from structured content normalizer 406, contextual tagging and categorization engine 412, structured-item linking module 414, and ingestion status monitor and error flagger 418 into a fully structured item representation suitable for downstream consumption by components of the multi-user coordination and data processing system 103 and data processing and enrichment system 108.

In various embodiments, structured record generation module 420 receives validated and tagged item data from the prior modules and assembles a composite data structure that conforms to the internal item schema used by tokenization and matching workflows. This includes assigning system-generated item identifiers, encoding merchant-specific rules (e.g., splittability constraints, fulfillment modality restrictions), and embedding contextual tags such as dietary labels, cuisine type, or service availability windows.

For example, structured record generation module 420 may generate an item record for a “Family-Style Pad Thai” dish with the following fields: base price, maximum share count (e.g., 4 users), allowed fulfillment modalities (e.g., pickup, delivery), merchant-defined preparation window (e.g., 11 a.m.-2 p.m. only), dietary tags (e.g., vegetarian), and a structured description object comprising both parsed item text and merchant-verified custom notes.

Structured record generation module 420 also establishes linkages between generated item records and the corresponding merchant profile, including internal identifiers, ingestion source metadata, and version control information. In certain embodiments, the module further generates tokenization instructions or schema transformation metadata that are later consumed by item schema correlation and matching engine 307 and vector embedding generator 306.

In an embodiment, structured record generation module 420 is also operable to generate batch summaries and ingestion manifests for indexing within structured menu metadata datastore 440. These summaries may include record-level validity flags, rule adherence scores, and processing history for auditability and downstream analytics.

In accordance with various embodiments, by consolidating heterogeneous ingestion outputs into canonicalized item records, structured record generation module 420 enables consistent token generation, compatibility modeling, and fulfillment orchestration. This structured output forms the boundary between ingestion pipelines (FIG. 4) and core multi-user coordination workflows (FIG. 2 and FIG. 3), and supports traceability, schema conformity, and system-wide alignment of item representations.

Structured menu metadata datastore 440 is operable to persist the finalized structured item records, ingestion metadata, and merchant-defined configuration rules generated during the ingestion pipeline shown in FIG. 4. More specifically, structured menu metadata datastore 440 stores schema-aligned item representations, contextual tagging outputs, ingestion status indicators, and rule-based constraints in a canonical format suitable for downstream use by data processing and enrichment system 108 and multi-user coordination and data processing system 103.

In various embodiments, structured menu metadata datastore 440 includes tables or collections corresponding to item-level attributes (e.g., item name, portion size, splittability flag, price rules), merchant-specific fulfillment constraints (e.g., allowed modalities, time windows, blackout periods), and derived metadata (e.g., cuisine type, dietary tags, inferred share count). Each stored record is associated with one or more merchant identifiers and includes lineage information tracing the record's origin to a specific upload session or ingestion source.

For example, an ingested item labeled “Combo Sushi Platter” may be stored with fields indicating: base price of $22.00, splittable among three users, delivery only, available after 5:00 p.m., and dietary tags including “contains seafood” and “gluten-free option available.” The corresponding structured record may also include a reference to a prior ingestion attempt flagged with partial parsing status and later resolved through merchant rule configuration interface 410.

Structured menu metadata datastore 440 also supports indexed querying by downstream components. For instance, item query and filtering engine 206 may retrieve only those items marked as splittable and available for delivery within a defined time window. Compatibility workflows in FIG. 3 may access merchant-defined minimum order values or item-level pricing constraints during cost-splitting and match evaluation.

In certain embodiments, structured menu metadata datastore 440 is further operable to maintain historical versions of menu records, enabling temporal queries or auditing of how merchant offerings have changed over time. This supports features such as trend analysis, menu drift detection, or rollback of erroneous item definitions.

In certain embodiments, by maintaining a structured, schema-conformant representation of merchant menus, structured menu metadata datastore 440 enables consistent item access across ingestion, matching, coordination, and fulfillment layers. It ensures that downstream systems interact only with fully validated, normalized, and tagged item records, which improves accuracy, reduces coordination overhead, and supports platform scalability across diverse merchant integrations.

### Fulfillment Routing and Logistics Interface System

FIG. 5 illustrates fulfillment routing and logistics interface system 111 in accordance with an embodiment of the present disclosure. In this example, fulfillment routing and logistics interface system 111 includes delivery partner API connector 502, multi-user delivery coordination module 504, timing synchronization and preparation window estimator 506, dynamic routing optimization engine 508, delivery eligibility and constraint validator 510, shared drop point and handoff logic module 512, fulfillment status monitor and alert trigger 514, and order-level delivery metadata store 540. Fulfillment routing and logistics interface system 111 is operable to receive fulfillment instructions originating from orchestration workflows of multi-user coordination and data processing system 103 and execute corresponding routing operations using external logistics providers, merchant delivery integrations, or internal dispatch services. In various embodiments, fulfillment routing and logistics interface system 111 processes structured delivery metadata associated with split orders, matched user groupings, and merchant timing constraints to support coordinated, route-aware fulfillment across multiple delivery contexts.

Delivery partner API connector 502 is operable to transmit structured delivery instructions, status queries, and routing metadata between fulfillment routing and logistics interface system 111 and one or more external delivery services. More specifically, delivery partner API connector 502 is operable to establish and maintain programmatic communication channels with third-party logistics platforms, merchant-operated dispatch services, or hybrid fulfillment networks. These external services may include, for example, integrated APIs provided by commercial delivery vendors (e.g., DoorDash, Uber Eats), merchant-owned logistics systems, or custom carrier endpoints registered with the system.

In various embodiments, delivery partner API connector 502 receives fulfillment execution instructions from multi-user coordination and data processing system 103, including item-level routing tokens, participant drop-off metadata, and merchant-preparation readiness signals. Delivery partner API connector 502 translates these payloads into API-conformant request bodies aligned with the requirements of each delivery service integration, including pickup location details, packaging metadata, route grouping flags, and service-tier constraints.

For example, given a matched coordination session with multiple user participants and split-order items from a common merchant, delivery partner API connector 502 may encode the aggregated delivery request as a batchable dispatch order, structured to align with the selected partner's delivery API schema. In an embodiment, the connector is further operable to register webhooks or polling endpoints for delivery status updates, enabling fulfillment routing and logistics interface system 111 to receive asynchronous status events such as “accepted,” “en route,” “arrived,” or “delivered.” These status updates are passed to downstream components including fulfillment status monitor and alert trigger 514 for real-time user notification or exception handling.

In certain embodiments, delivery partner API connector 502 includes protocol adapters or gateway middleware that support schema translation across RESTful APIs, GraphQL endpoints, or webhook-based status feeds. The connector may apply authentication handling, retry logic, and rate-limit compliance when communicating with third-party services, ensuring resilience across variable network conditions and heterogeneous vendor systems. In an embodiment, delivery partner API connector 502 may support fallback routing logic when a primary delivery vendor declines a request, invoking alternate APIs or escalating to merchant-configured delivery workflows.

Multi-user delivery coordination module 504 is operable to group, sequence, and optimize delivery fulfillment operations across multiple users participating in a matched coordination session. More specifically, multi-user delivery coordination module 504 is operable to identify opportunities for shared routing, overlapping destination proximities, or synchronized pickup windows associated with a common merchant or order event. This grouping supports efficient delivery execution for split orders originating from the same merchant but destined for multiple participants.

In various embodiments, multi-user delivery coordination module 504 receives finalized match outputs and routing tokens from order sequencing and fulfillment orchestration module 214 of FIG. 2. Each routing token includes structured metadata identifying user-specific delivery endpoints, shared item assignments, and session-level fulfillment parameters (e.g., delivery modality, temperature constraints, or coordination timing rules). Using this metadata, multi-user delivery coordination module 504 evaluates whether one or more participants can be serviced within a common delivery path while maintaining item quality thresholds and service-level guarantees.

For example, if three users located within the same office complex participate in a shared lunch coordination session involving split dishes from a nearby restaurant, multi-user delivery coordination module 504 may group their items into a single dispatch run. The module generates a delivery grouping object that specifies a common pickup node, segmented drop-off metadata, and user-specific identifiers for proper portion allocation. This object is passed to delivery partner API connector 502 for dispatching to the external delivery service, while also being logged within order-level delivery metadata store 540 for traceability.

In certain embodiments, multi-user delivery coordination module 504 applies rule-based or ML-based scoring functions to determine optimal grouping configurations. These scoring functions may account for historical delivery success rates, travel time constraints, item packaging compatibility, or merchant-defined grouping preferences (e.g., opt-out from group delivery for high-value or time-sensitive items). In another embodiment, multi-user delivery coordination module 504 supports dynamic re-evaluation of grouped deliveries based on real-time status updates, enabling route reconfiguration or reassignment if delays or dropouts are detected.

Timing synchronization and preparation window estimator 506 is operable to calculate optimal pickup and dispatch windows for matched item groupings based on kitchen preparation estimates, user confirmation timestamps, delivery service availability, and merchant-defined readiness parameters. More specifically, timing synchronization and preparation window estimator 506 is operable to align order batching, delivery coordination, and resource assignment with the operational timing constraints of merchant fulfillment environments and external logistics partners.

In various embodiments, timing synchronization and preparation window estimator 506 receives structured item records and session lock events from order sequencing and fulfillment orchestration module 214 of FIG. 2. Each locked session includes a fulfillment token specifying estimated preparation time ranges, earliest pickup eligibility, and user-provided scheduling preferences. Timing synchronization and preparation window estimator 506 uses these inputs to generate a candidate pickup window for dispatch coordination.

For example, if a matched session includes three split items from a restaurant with a 25-minute average prep time and two users have confirmed participation within the past 5 minutes, timing synchronization and preparation window estimator 506 may output a pickup window beginning 20 minutes from the current timestamp. The window accounts for the preparation buffer, confirmation delay, and merchant-specific rules (e.g., prep throttling during peak hours). The estimated window is then transmitted to delivery partner API connector 502 and stored in order-level delivery metadata store 540 for monitoring.

In certain embodiments, timing synchronization and preparation window estimator 506 supports merchant configuration inputs including preparation delay thresholds, concurrent order batching allowances, or override conditions (e.g., fixed pickup windows during promotions). The module may also retrieve historical performance metrics from system performance metadata log 338 of FIG. 3 to adjust prep window calculations based on prior variability or deviation trends. Timing synchronization and preparation window estimator 506 operates in conjunction with multi-user delivery coordination module 504 to ensure synchronization between fulfillment readiness and downstream routing execution.

Dynamic routing optimization engine 508 is operable to compute and revise delivery paths for one or more fulfillment sessions based on routing constraints, user drop-off locations, merchant readiness indicators, and system-defined service rules. More specifically, dynamic routing optimization engine 508 is operable to determine optimal dispatch sequences, fallback paths, and rerouting conditions using a combination of structured delivery metadata, live telemetry, and stored service coverage rules.

In various embodiments, dynamic routing optimization engine 508 receives pickup readiness indicators from timing synchronization and preparation window estimator 506, order-specific metadata from order-level delivery metadata store 540, and user location data from geolocation and delivery routing processor 222 of FIG. 2. Based on these inputs, dynamic routing optimization engine 508 generates a structured routing plan for one or more delivery agents assigned to matched fulfillment sessions. Routing plans include delivery priority order, estimated time of arrival (ETA) per user, and expected route deviation tolerances.

For example, dynamic routing optimization engine 508 may compute that for a session involving three users located in adjacent neighborhoods, the delivery path should sequence User A→User C→User B based on traffic data and predicted drop-point readiness, even if User B confirmed first. The routing plan may further include a fallback condition to reroute to an alternate driver or pause dispatch if User A's location becomes temporarily inaccessible or if the prep time for one item exceeds its threshold.

In certain embodiments, dynamic routing optimization engine 508 integrates with third-party map and traffic APIs and retrieves historical performance metrics from system performance metadata log 338 of FIG. 3. These metrics may include prior ETA variance by region, failed drop attempts, or zone-based carrier performance differentials. The routing engine uses this data to apply scoring weights to candidate paths and select those that maximize session fulfillment efficiency under current load and traffic conditions.

Dynamic routing optimization engine 508 operates as a modular computation service invoked during fulfillment orchestration, enabling the system to adaptively coordinate multi-user deliveries and maintain consistency between merchant preparation state and delivery routing execution. Routing decisions and adjustments are logged in order-level delivery metadata store 540 to support post-fulfillment auditing and future route learning.

Delivery eligibility and constraint validator 510 is operable to evaluate delivery feasibility for each user-item fulfillment pairing based on service-level constraints, merchant-defined delivery rules, and user-specific delivery metadata. More specifically, delivery eligibility and constraint validator 510 is operable to assess whether a matched fulfillment session satisfies routing zone coverage, batchability thresholds, order minimums, temperature constraints, and time-window eligibility defined by merchant and platform policies.

In an embodiment, delivery eligibility and constraint validator 510 receives structured session payloads from order sequencing and fulfillment orchestration module 214 of FIG. 2, which include item assignments, fulfillment modality (e.g., delivery, pickup), and participant-specific preferences. Delivery eligibility and constraint validator 510 accesses configuration rules provided by merchants via structured menu metadata datastore 440 of FIG. 4, including fields such as minimum delivery value, delivery radius, excluded times, or non-batchable item flags.

For example, a merchant may specify that hot entrees requiring insulated transport cannot be grouped with cold items for users located more than five miles apart. Delivery eligibility and constraint validator 510 evaluates the active fulfillment group against these constraints. If the proposed group includes both a hot entrée and a cold beverage assigned to users in different zip codes, the validator flags the configuration as ineligible for unified delivery and prompts orchestration logic to either split fulfillment or defer execution.

In certain embodiments, delivery eligibility and constraint validator 510 also evaluates delivery agent availability, fulfillment region limits, or live network load retrieved via delivery partner API connector 502. These runtime constraints are incorporated into eligibility scoring models that assign a confidence score or binary eligibility flag to each candidate route. Constraint mismatches may trigger fallback logic or rebalancing workflows executed by dynamic routing optimization engine 508.

Delivery eligibility and constraint validator 510 enables deterministic enforcement of fulfillment policies by evaluating item and participant configurations against structured delivery rule sets. Constraint evaluation results may be stored in order-level delivery metadata store 540 for downstream exception handling or compliance auditing.

Shared drop point and handoff logic module 512 is operable to identify, validate, and assign neutral delivery locations shared by multiple participants within a matched fulfillment session. More specifically, shared drop point and handoff logic module 512 is operable to compute candidate drop locations based on user proximity vectors, delivery route feasibility, and predefined handoff point constraints configured by merchants, platform operators, or users.

In an embodiment, shared drop point and handoff logic module 512 receives user location metadata from user preference datastore 330 of FIG. 3 and evaluates geospatial alignment across matched participants. When multiple users in a shared order are located within a defined clustering threshold, shared drop point and handoff logic module 512 initiates a drop point recommendation process that queries a location ruleset database containing permissible handoff zones, such as curbside lockers, office kitchens, residential lobbies, or designated pickup kiosks.

For example, if a first participant and a second participant are matched to the same shared lunch order and both indicate proximity to a downtown office building with an authorized delivery locker, shared drop point and handoff logic module 512 selects that locker as the handoff point. The module associates a locker ID and delivery access window with the fulfillment instruction payload and transmits the updated routing configuration to dynamic routing optimization engine 508.

In certain embodiments, shared drop point and handoff logic module 512 receives override inputs from users selecting preferred shared locations via event coordination engine 224 of FIG. 2. The module is further operable to enforce constraints on drop point types based on item characteristics—for example, perishable or temperature-sensitive items may be excluded from unmanned drop locations unless enhanced packaging metadata indicates sufficient insulation duration.

Assignment of shared drop points is reflected in the structured fulfillment payload transmitted via delivery partner API connector 502 and is logged in order-level delivery metadata store 540. Ineligible or suboptimal drop locations may be flagged by delivery eligibility and constraint validator 510, triggering reevaluation or fallback to direct-to-user delivery.

Fulfillment status monitor and alert trigger 514 is operable to track delivery progress, detect fulfillment anomalies, and trigger system-level alerts or user-facing notifications in response to fulfillment state changes or timing deviations. More specifically, fulfillment status monitor and alert trigger 514 is operable to monitor real-time delivery status updates received via delivery partner API connector 502 and to evaluate those updates against expected fulfillment schedules and routing configurations.

In an embodiment, fulfillment status monitor and alert trigger 514 receives delivery event messages (e.g., “pickup confirmed,” “in transit,” “delivered”) from third-party logistics providers, each associated with a specific fulfillment session ID. These messages are parsed and mapped to corresponding fulfillment stages using internal state transition rules. Fulfillment status monitor and alert trigger 514 compares the received event sequence and timestamps against the expected timeline generated by timing synchronization and preparation window estimator 506 to identify delays, missed pickups, or delivery outliers.

For example, if an order assigned a 12:45 PM pickup window has not received a corresponding “pickup confirmed” status by 1:00 PM, fulfillment status monitor and alert trigger 514 may classify the session as at-risk. The component is then operable to trigger escalation workflows, which may include alerting the user through notification system 116 of FIG. 1, reassigning the delivery to an alternate provider, or flagging the event for manual intervention.

In certain embodiments, fulfillment status monitor and alert trigger 514 is further operable to evaluate delivery provider reliability profiles stored in order-level delivery metadata store 540 to adjust future provider selection weighting or to notify platform administrators of repeat exception patterns. Additionally, status monitor 514 may support multi-modal alert channels, including push notifications, SMS, or merchant dashboard indicators, with customizable rules for severity thresholds and response triggers.

Fulfillment status monitor and alert trigger 514 thereby ensures that fulfillment deviations are captured in near real-time and surfaced to relevant system components for corrective action, contributing to higher completion rates and improved synchronization across distributed order sessions.

Order-level delivery metadata store 540 is operable to persist delivery-related telemetry, routing decisions, and exception records for each fulfillment session processed by fulfillment routing and logistics interface system 111. More specifically, order-level delivery metadata store 540 is operable to store structured metadata associated with routing paths, provider assignments, delivery timing events, and fulfillment state transitions, enabling downstream analysis, auditability, and optimization feedback loops.

In various embodiments, order-level delivery metadata store 540 receives structured payloads generated by delivery partner API connector 502, dynamic routing optimization engine 508, and fulfillment status monitor and alert trigger 514. These payloads may include attributes such as selected delivery provider ID, estimated and actual pickup/drop-off timestamps, route deviation indicators, fallback rerouting flags, and user-specific handoff instructions (e.g., curbside handoff, contactless delivery location).

For example, when a matched fulfillment session is executed using a multi-user delivery coordination module 504 flow, metadata store 540 may log the full delivery graph, including the sequence of user drop-offs, actual arrival times, travel durations between nodes, and any delivery exceptions (e.g., failed handoff, incorrect address). In an embodiment, metadata store 540 also captures merchant-defined constraints (e.g., delivery blackout windows, item temperature sensitivity), enabling correlation with fulfillment deviations or delay incidents.

Order-level delivery metadata store 540 supports time-series indexing and session-level grouping, allowing system administrators or machine learning components to perform retrospective delivery analysis, detect systemic bottlenecks, or train prediction models for future routing optimization. In certain embodiments, metadata records stored in metadata store 540 are used by system performance metadata log 338 of FIG. 3 to generate platform-wide efficiency metrics and inform real-time orchestration adjustments.

In accordance with various embodiments, order-level delivery metadata store 540 may be implemented as a dedicated structured database, event log archive, or streaming data sink, and may reside on centralized cloud infrastructure, edge processing nodes, or merchant-local appliances depending on the deployment configuration. The component provides a centralized source of truth for historical fulfillment telemetry, supporting consistency and traceability across distributed delivery operations.

### A. Computer Implemented Process

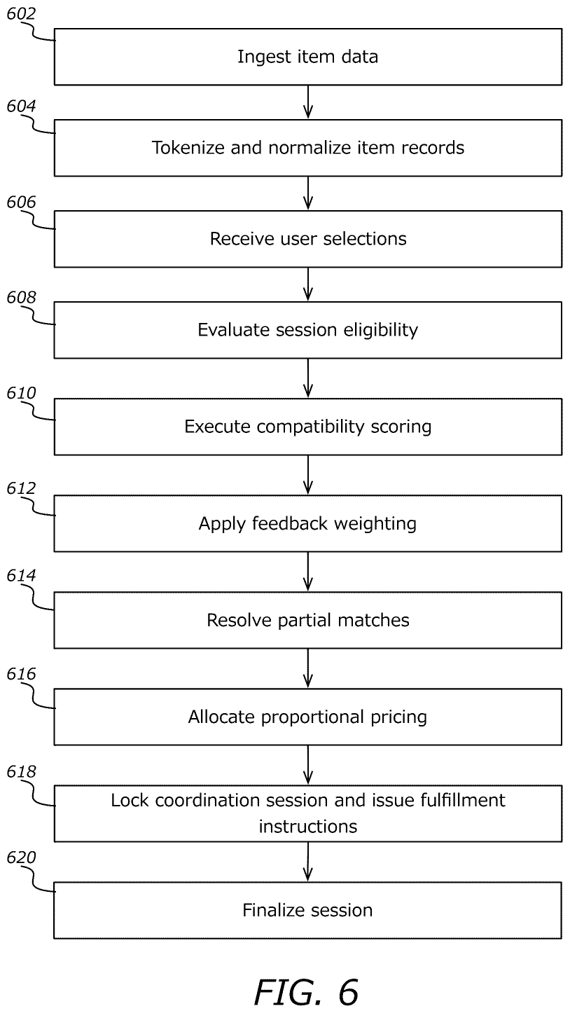

FIG. 6 illustrates an exemplary process flow for distributed item selection, compatibility resolution, cost allocation, and fulfillment coordination in a shared ordering environment, in accordance with various embodiments of the present disclosure. The illustrated steps represent machine-executed operations performed by components such as data processing and enrichment system 108, multi-user coordination and data processing system 103, and fulfillment routing and logistics interface system 111, as shown in FIG. 1 through FIG. 5. The process flow begins with merchant item ingestion and continues through tokenization, match evaluation, orchestration, and order finalization. Steps may be added, removed, or reordered without departing from the scope of the invention, as would be apparent to one of ordinary skill in the art.

At step 602, item data is ingested into the system. This item data includes structured and unstructured representations of merchant-defined offerings, which may include food menu items, retail goods, digital services, or other splittable physical products. In various embodiments, the item data may originate from point-of-sale (POS) systems, inventory databases, menu management tools, partner APIs, static data exports, or digital assets uploaded by merchants. Formats may include structured files (e.g., CSV, JSON), semi-structured formats (e.g., XML, HTML), or unstructured content such as PDFs, scanned images, promotional flyers, and freeform text listings. The system is operable to accept these inputs via direct upload, webhook ingestion, scheduled scraping, or real-time API synchronization.

The ingested item data may include structured or embedded metadata attributes indicating portion sizes, price points, splittability flags (e.g., maximum number of users per item), dietary or categorical tags, availability windows, and fulfillment modalities. For example, a menu item may indicate that a “Family Pasta Platter” is available for dinner only, splittable among three users, and restricted to dine-in. In another embodiment, a shared tool rental listing may include constraints such as “available for up to 4 users per day, refundable deposit required, pickup only,” while a digital subscription bundle may define access tiers across a shared billing group.

In cases where the item data is presented in image-based formats—such as scanned menus, handwritten order forms, or promotional flyers—the ingestion process may invoke visual media OCR and attribute parser 416 described in FIG. 4. This component applies optical character recognition (OCR), layout detection, and token segmentation logic to extract candidate fields from visual content, including item names, prices, tags (e.g., “gluten-free,” “shareable”), and structured modifiers. For example, a photo of a chalkboard menu reading “Spicy Ramen—$12—shareable for 2—lunch only” may be parsed to extract a tokenized item record with pricing, splittability constraints, and availability metadata. These heterogeneous inputs—whether structured or unstructured, textual or visual—are routed into the normalization and schema alignment stages described in step 604.

At step 604, the ingested item data is normalized and tokenized into schema-aligned item tokens suitable for downstream compatibility modeling and session-based coordination. The normalization process is carried out using structured transformation logic, including canonicalization of attribute names, enforcement of expected data types, and alignment of item-level metadata with the system schema. For example, unstructured portion size descriptions (e.g., “feeds 2-3” or “half platter”) may be mapped to standardized fractional share values, while availability tags such as “weekends only” or “after 5 pm” are converted into time-slot constraints. Tokenization may additionally include assigning unique identifiers, tagging splittability flags, encoding price tiers, and capturing preparation modality (e.g., dine-in only, eligible for delivery). These structured item tokens are passed to the next stage for user alignment and coordination session formation.

The normalization process is operable to standardize field names, resolve unit discrepancies (e.g., “oz” vs. “ounces”), and enforce type conformity for each item attribute. For example, string-based prices are converted to floating-point numbers, Boolean splittability tags are normalized from variant expressions (e.g., “shareable,” “split OK,” “yes”), and dietary modifiers are mapped to controlled taxonomy labels (e.g., “vegan,” “nut-free”). Where multiple items refer to conceptually identical offerings across different merchants, structured-item linking module 414 may be invoked to unify or cross-reference tokens to canonicalized item references.

Following normalization, each item is converted into a tokenized data object, encapsulating the merchant-defined offering and its associated structured attributes. These item tokens include, but are not limited to: base price, splittability constraints, fulfillment modality (e.g., dine-in, delivery), supported portion sizes, scheduling rules, and merchant-defined restrictions. For example, a normalized and tokenized record for a shared appliance rental might include: {“item”: “Power Drill”, “splittable”: true, “maxUsers”: 3, “portion Type”: “per-day”, “pricePerPortion”: 7.00, “fulfillment”: “pickup-only”}.

In certain embodiments, tokenization may also include the assignment of vector representations or internal item identifiers to support downstream similarity comparison, schema mapping, or item correlation. These structured tokens form the basis for all subsequent compatibility modeling, grouping, and fulfillment orchestration workflows.

At step 606, the system receives user-submitted item selections and associated participation parameters via a user interface operating on user device(s) 110. The received input includes one or more selected item tokens, preferred portion quantities, desired fulfillment modality (e.g., delivery, pickup, dine-in), availability windows, and optionally geolocation data or dietary preferences. Each submission is associated with a unique user identifier and stored within a coordination session record instantiated by group coordination and session management component 208 of FIG. 2. In various embodiments, submissions may originate from public browsing of available split-eligible items, direct invitations to an active session, or targeted recommendations triggered by proximity-based event detection or user profile matches.

For example, a first user may select half of a tokenized entrée item and indicate availability for pickup between 6:00 and 7:00 PM. A second user, using a different device, may select the remaining half of the same tokenized item and indicate a delivery preference to a nearby address within a five-mile radius. The system captures these selections as session inputs and routes them to compatibility evaluation workflows to determine whether a match threshold has been met. The coordination session remains active until fulfilled, timed out, or manually closed by the system or the user. In certain embodiments, coordination sessions may include expiration rules, maximum participant limits, or merchant-imposed constraints governing eligibility for fulfillment orchestration.

At step 608, the system evaluates session eligibility by applying compatibility threshold logic to the received item selections and associated participation parameters. Group coordination and session management component 208 retrieves the active coordination session and invokes match scoring and prioritization engine 308 of FIG. 3 to determine whether the submitted item tokens and participation records satisfy one or more fulfillment initiation conditions. These conditions may include aggregate portion coverage, minimum user count, total order value, fulfillment modality alignment, or merchant-defined timing constraints.

For example, a coordination session involving a tokenized shared entrée with a defined portion split of ⅓ increments may reach threshold eligibility once three participants each request one portion and confirm availability within a common delivery window. In another example, a threshold may be based on aggregate monetary value, such that a coordination session for a tokenized bundled grocery order requires a minimum combined subtotal of $40 across all participants. In yet another embodiment, eligibility may depend on non-item constraints, such as matching dietary tags (e.g., “nut-free,” “gluten-free”) across participants or satisfying merchant-defined batch preparation constraints (e.g., “item available for group delivery only on Fridays between 5:00 and 8:00 PM”).

If session eligibility is met, the coordination session transitions from a pending state to a matched or locked state. This transition may trigger execution of compatibility modeling workflows, cost allocation logic, or fulfillment orchestration as described in subsequent steps. If eligibility is not met, the session remains in a pending state and may continue to accept new participant submissions or be terminated based on session expiration rules or system-defined timeouts.

At step 610, the system executes compatibility scoring to evaluate alignment among participant selections, session-level constraints, and merchant-defined item parameters. Match scoring and prioritization engine 308 and vector embedding generator 306 of FIG. 3 are operable to generate structured embedding vectors for user-submitted item tokens, including representations of selected portions, fulfillment modality preferences, dietary or constraint flags, and derived user preference signals. These vectors are compared using multi-factor similarity metrics to determine scoring alignment across participants.

The compatibility scoring process includes both exact match evaluation—e.g., identical item token and portion selection across multiple users—and partial or inferred compatibility modeling. For example, vector similarity computations may identify that two different user-selected item variants (e.g., “Medium Veggie Pizza” and “Large Veggie Pizza with no olives”) share overlapping core attributes, enabling the system to score them as compatible at a configurable threshold. Inferred preference synthesis from historical selection behavior or co-selection data may further adjust vector weights to reflect likelihood of user satisfaction.

Match scoring and prioritization engine 308 may also incorporate weighted signal reweighing logic from feedback integration and signal reweighing module 310, accounting for prior delivery outcomes, review signals, or constraint violations. For instance, if a past order involving the same merchant and item was rated poorly due to late delivery or improper splitting, the system may reduce that option's compatibility weight. Compatibility scores across participants are then used to select the optimal item grouping configuration and prioritize session locking candidates as described in step 614.

At step 612, the system applies feedback weighting to dynamically adjust compatibility scores and session prioritization based on historical fulfillment outcomes, user-generated reviews, and external signal metadata. Feedback integration and signal reweighing module 310 of FIG. 3 is operable to ingest structured and semi-structured feedback data, align the data with corresponding item tokens or coordination sessions, and apply reweighing logic to compatibility vectors.

In an embodiment, the reweighing process includes semantic parsing of ranked user reviews, ingestion of delivery reliability scores from logistics integrations, and evaluation of post-order signals such as confirmed portion accuracy, preparation timeliness, or reported dissatisfaction. For example, a three-star user rating indicating “portion too small for sharing” may be semantically parsed and linked to a specific item and session type, reducing the weight of that item token for future match scoring. Similarly, repeated reports of late delivery may trigger a penalty multiplier to merchant-session combinations involving the affected fulfillment path.

In an embodiment, reweighing logic is applied by adjusting the embedding vectors associated with each item or user profile, altering the compatibility scoring inputs generated in step 610. The adjustments may reflect system-defined penalty functions, decayed feedback weighting over time, or machine-learned models trained to detect latent dissatisfaction patterns. Feedback-derived adjustments are written to system performance metadata log 338 for telemetry tracking and persisted in review signal datastore 336 for longitudinal impact on future coordination outcomes.

At step 614, the system resolves partial matches or applies inferred compatibility logic to determine whether a coordination session can proceed based on incomplete or ambiguous user selections. Partial match handler 314 and inferred portion compatibility engine 316 of FIG. 3 are operable to evaluate match viability when user-submitted selections do not collectively satisfy explicit fulfillment thresholds or when direct item alignment is not observed.

The partial match resolution process includes analyzing structured item tokens, quantity constraints, and session-level participation vectors to determine whether deferral, promotion, or inferred resolution is appropriate. For example, if a coordination session includes three participants who each select a third of an item that is only splittable by four, the session may remain in a deferral state until an additional participant joins. The system tracks deferral states with timers, configurable merchant policies, and user notification triggers.

The inferred compatibility logic evaluates whether user selections—while not identical—are similar enough in embedding space to justify a resolved match. For instance, a first user may select “Paneer Tikka Wrap,” while a second selects “Spicy Tofu Wrap,” and a third selects “Grilled Veggie Wrap.” If their selections fall within a similarity threshold in vector space and align with a merchant-defined substitution class or meal bundle constraint, the system may resolve the session as an inferred group match for a generalized “Vegetarian Wrap Combo” token.

In an embodiment, inferred resolution outcomes are flagged with a confidence score and persisted to match outcome datastore 334 for auditing and performance analysis. The decision logic may include override conditions, such as user opt-in for flexible fulfillment or merchant flags permitting inferred bundling. Sessions resolved via partial or inferred logic are promoted to the orchestration stage described in step 618.

At step 616, the system allocates proportional pricing across participating users based on their item selections, portion shares, and merchant-defined pricing constraints. This operation is performed by price allocation and cost-splitting engine 212 of FIG. 2, which receives structured item tokens from group coordination and session management component 208, along with normalized metadata describing quantity, splittability, and user-specific modifications.

The cost allocation process applies schema-aligned pricing logic that includes base item price, optional modifiers (e.g., toppings or upgrades), per-user customization surcharges, and merchant-defined split fees or rounding constraints. For example, if three users commit to splitting a dish priced at $24.00 with different modifier combinations, the system calculates each user's total based on a ⅓ portion of the base item and the full cost of their individual modifiers. A merchant-defined rule may add a $1.50 fee for each participant in a split scenario, which is appended to each user's subtotal.

In certain embodiments, the system supports tiered or proportional allocation rules, such as allocating larger cost shares to users selecting more substantial portions (e.g., ½ vs. ¼). The engine may also apply rounding logic to ensure whole-number transaction amounts or to satisfy minimum order constraints. Cost allocation stubs are generated for each participant and transmitted to downstream orchestration components (e.g., order sequencing and fulfillment orchestration module 214) to maintain alignment between pricing logic and fulfillment execution.

In an embodiment, the system may support preview mode or deferred confirmation, wherein the calculated cost shares are shown to users for review prior to session lock. Cost allocation outcomes are persisted to match outcome datastore 334 and system performance metadata log 338 to support audits, recalculations, or future pricing model adjustments.

At step 618, the system locks the coordination session and issues fulfillment instructions for downstream execution. In an embodiment, this step can be performed by order sequencing and fulfillment orchestration module 214 of FIG. 2, which receives the finalized item groupings, participant assignments, and cost allocation stubs from earlier session components. Locking the coordination session prevents further modifications and transitions the session to a committed state suitable for fulfillment operations.

The orchestration process includes assigning sequencing identifiers to individual items and participants, resolving pickup or delivery modalities, and encoding scheduling metadata based on merchant-defined preparation windows and user availability signals. For example, a session involving three users with split items from two different restaurants may result in two fulfillment segments with staggered timing, each transmitted to a different restaurant system via merchant integration interface component 202.

Fulfillment instructions include structured representations of item composition, portion assignments, timing constraints, and routing tags. These are transmitted to fulfillment routing and logistics interface system 111, which distributes order details to delivery vendors or pickup coordinators. The orchestration module synchronizes these instructions with delivery readiness estimates (e.g., computed by timing synchronization and preparation window estimator 506 of FIG. 5), ensuring the preparation and handoff are aligned with system-defined service guarantees.

In certain embodiments, the system applies additional orchestration flags, including user-specific delivery metadata (e.g., access instructions, contactless delivery), proximity-based drop point rules (e.g., locker pickup coordination), or load-balancing adjustments based on system traffic. Once the instructions are issued, the session state is persisted to match outcome datastore 334 and delivery instructions are made available to the notification system 116 for alert generation and user messaging.

In various embodiments, the system is operable to incorporate merchant-defined pricing logic, minimum commitment rules, and revenue attribution metadata into the coordination session workflow. More specifically, pricing allocation data generated by price allocation and cost-splitting engine 212 may include configured split ratios, minimum spend requirements, and proportional cost constraints defined at the merchant level. For example, a merchant may configure an item token to require a minimum group subtotal of $30 before triggering coordination, or to apply asymmetric cost distribution where the first user covers a larger portion in exchange for early access.

In an embodiment, coordination session payloads generated by group coordination and session management component 208 include session-level metadata for attribution tracking, including unique referral identifiers and influencer-linked revenue distributions. For example, if a user initiates a session through a shared social link, the system may associate the originating user with a session tag that enables downstream allocation of participation-based rewards, revenue share percentages, or access-based unlocks. These attribution markers are stored in user preference datastore 330 and may be applied in connection with promotional incentive workflows or affiliate compensation engines.

In certain embodiments, compatibility scoring workflows described in match scoring and prioritization engine 308 incorporate geo-taste clustering logic and user interaction vectors to influence match ranking. For example, when evaluating multiple active sessions involving similar item tokens, the system may apply a geospatial density filter to identify candidate matches within a threshold radius and further weight compatibility scores based on location-inferred taste affinities (e.g., regional cuisine preferences, cohort co-purchases). These additional match inputs are derived from vector embedding generator 306 and refined via preference synthesis and user compatibility module 318.

The system is further operable to apply fallback orchestration logic when coordination sessions fail to meet eligibility thresholds within a predefined time window. In an embodiment, if a group session does not reach the required portion threshold or participant count within a merchant-defined timeout period, the system evaluates solo fulfillment eligibility. For example, timeout-based solo conversion logic may allow the last committed user to complete the order individually, subject to updated pricing constraints or fulfillment modality adjustments. These conditions are encoded within item token metadata and evaluated by group coordination and session management component 208.

In various embodiments, the system supports allocation of non-fiat rewards tied to participation parameters, fulfillment completion, or referral activity. For example, upon successful completion of a group coordination session, one or more participants may be allocated system-specific reward credits, merchant-defined tokens, or blockchain-linked digital assets. These rewards are calculated based on participation metadata, match quality scores, or role-specific contributions (e.g., initiator, promoter, closer). Reward metadata is recorded within system performance metadata log 338 and may influence eligibility for future incentives or personalized upselling prompts.

The system may additionally evaluate social matching indicators derived from user-generated metadata, enabling the pairing of users across distinct but compatible coordination sessions. In an embodiment, preference synthesis and user compatibility module 318 computes social affinity scores between users based on historical overlap, review similarities, or inferred intent signals. These scores are used to suggest match candidates across separate coordination threads, enabling latent matches based on shared vector proximity, session timing alignment, or common dietary or lifestyle tags. Suggested pairings are surfaced to user device(s) 110 and reflected in notification and alert module 218 triggers.

### B. Computer Implemented Process

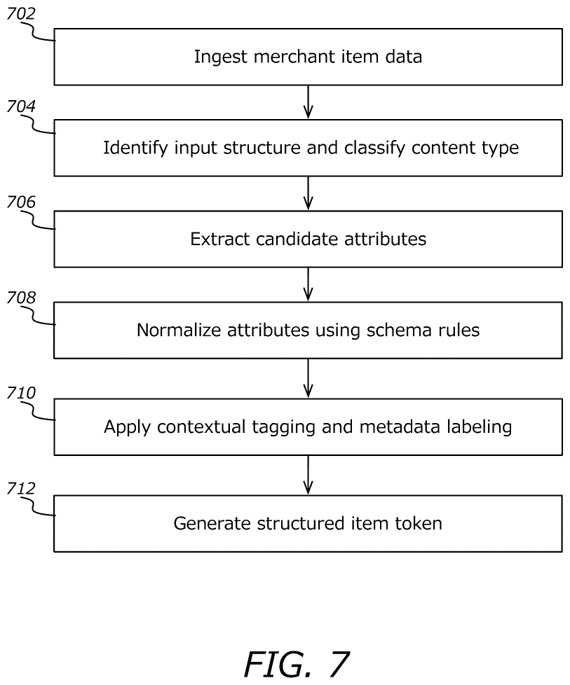

FIG. 7 illustrates a process flow for structured token generation from merchant-defined item data in accordance with various embodiments of the present disclosure. In an embodiment, the steps shown in FIG. 7 can be performed by components including merchant-side structured data ingestion system 112, data processing and enrichment system 108, and associated subcomponents described in FIG. 4 and FIG. 3. The process begins with ingestion of structured or unstructured item data, followed by schema alignment, attribute normalization, token construction, and structured encoding of splittable and configurable item representations. This tokenization framework enables downstream compatibility resolution, pricing logic, and fulfillment orchestration. The process may include additional steps, fewer steps, or a different sequence of steps without departing from the scope of the invention.

At step 702, merchant item data is ingested into the system. This ingestion may include structured, semi-structured, or unstructured item records obtained through multiple acquisition channels, such as API-based transmission, backend synchronization with merchant systems, server-side scraping of online menus, webhook notifications, bulk upload portals, or continuous data streaming from partner platforms. The system is also operable to receive manually submitted entries and static downloads from external sources, including shared spreadsheets, flat files, and scanned documents.

In an embodiment, merchant data includes one or more of the following: item names, base prices, portion sizing, splittability parameters, availability windows, dietary tags, allergens, modifiers, and merchant-defined rules or constraints. The data may also include media references such as images or promotional banners. Unstructured and image-based formats are routed through file type and structure classifier 404 and, where applicable, parsed using unstructured content parser 408 and visual media OCR and attribute parser 416.

For example, a PDF containing a seasonal catering menu may be submitted by a restaurant vendor. This file is automatically routed to the appropriate parsing pipeline, where section headers are used to segment item groupings, bold text is analyzed to infer item names, and trailing numbers with currency symbols are classified as price values. Similarly, an uploaded photograph of a whiteboard lunch menu may be processed via OCR, extracting labeled dishes and availability times for normalization. These ingestion mechanisms allow the system to support a range of item types, including but not limited to: restaurant meals, bundled event offerings, subscription-based services, or physical goods like shared picnic kits or family-size grocery bundles.

At step 704, the ingested item data is tokenized and normalized into schema-aligned item tokens. In an embodiment, this step is executed by data processing and enrichment system 108 using transformation pipelines such as input normalization module 302, schema mapping engine 304, and structured record generation module 420. Each ingested record—whether structured (e.g., JSON or POS export), semi-structured (e.g., spreadsheets or HTML tables), or unstructured (e.g., scanned flyers or promotional images)—is processed into a consistent internal format through structured attribute mapping and canonical field alignment. The normalization process is carried out using structured transformation logic that includes datatype enforcement, field coercion, unit standardization, controlled vocabulary mapping, and inferred metadata resolution.

More specifically, text-based inputs are parsed to extract attributes such as item name, base price, portion options, splittability constraints, dietary tags, and fulfillment modality restrictions. In the case of unstructured data (e.g., scanned menus or marketing flyers), visual media OCR and attribute parser 416 applies layout detection, OCR segmentation, and attribute extraction logic to identify item records from image-based sources. Image-based ingestion may include non-food items such as craft kits, meal boxes, or shareable event experiences, which are converted into structured tokens using entity recognition and spatial grouping heuristics. Each resulting item token includes a machine-readable vector or structured representation that encodes schema-aligned attributes for downstream compatibility modeling and fulfillment orchestration. These tokens are then routed to group coordination and session management component 208 and other components of FIG. 3 for distributed session processing.

At step 706, the system extracts candidate item attributes from the tokenized data. In an embodiment, this step includes field-level parsing, pattern matching, and metadata extraction across both structured and unstructured input types. For structured inputs, the system evaluates key-value pairs and schema-aligned fields to extract predefined attributes such as item name, base price, unit size, portion configuration, splittability flag, and fulfillment constraints. The extraction logic applies deterministic parsing rules to isolate attributes and verify datatype conformity (e.g., currency, numeric quantities, Boolean indicators for shareability).

For semi-structured and unstructured content—including text blocks, formatted tables, and OCR-derived strings—the system performs segmentation and candidate classification using syntactic markers, layout cues, and pattern-based recognition logic. For example, in a sentence such as “Family Pasta Bowl—$22.00. Serves 3-4. Available for pickup only,” the system extracts: name (“Family Pasta Bowl”), price (22.00), serving size range (“3-4”), and modality constraint (“pickup only”). The system may also apply dictionary lookups and rule-based logic to identify implicit attributes (e.g., detecting that “Serves 3-4” implies splittability).

In certain embodiments, the system evaluates visual proximity between text blocks (from scanned flyers or digital menus) to infer attribute boundaries. This includes identifying multi-line item descriptions, aligning associated price blocks, and classifying modifiers (e.g., “gluten-free,” “vegan,” “weekend special”) into appropriate schema categories. Extracted attributes are stored with source confidence scores and passed downstream for categorization, tagging, and correlation with historical records.

At step 708, the extracted item attributes are normalized using schema rules defined by the system's internal data model. This includes aligning each extracted attribute to a canonical field name, converting data types, and applying standard formatting consistent with downstream processing components. The normalization process accounts for variations in merchant-provided formats and enforces structural integrity across all item records.

More specifically, normalization operations include: mapping attribute labels (e.g., “price per item,” “cost,” or “unit price”) to a canonical base_price field; resolving serving size formats (e.g., “feeds 2-3”→portion_min: 2, portion_max: 3); and transforming availability constraints (e.g., “only on weekends”→schedule_rule: weekend_only). For categorical attributes such as dietary labels or cuisine type, the system applies dictionary-based standardization (e.g., mapping “veggie” or “plant-based” to vegetarian) and may apply language model-assisted resolution when dealing with ambiguous or compound tags.

Numeric values are normalized to standardized units of measurement (e.g., “8 oz”→quantity: 8, unit: oz), and date/time fields are converted into system-defined ISO formats. Free-text modifiers or merchant-defined tags are evaluated against schema-compliant enums, with unsupported values logged for downstream review. In certain embodiments, normalization includes scoring for field confidence, mapping ambiguity, and merchant-specific transformation exceptions, which are retained in metadata for auditability.

The output of this step is a structured, schema-aligned item representation in which base attributes—such as item name, portion size, price, and availability—are normalized according to the platform's canonical field definitions. These normalized item records retain positional context and intermediate parsing annotations, which are preserved for enrichment and contextual labeling operations performed in the subsequent tagging stage.

At step 710, the normalized item attributes are processed for contextual tagging and metadata labeling. This step is operable to assign supplemental descriptors, classification tags, and system-resolved metadata to each item record, based on schema rules, merchant profiles, and tagging policies. The tagging process supports downstream compatibility modeling by ensuring each token carries the full contextual footprint required for group-based resolution.

More specifically, the system applies rule-based and pattern-driven logic to derive metadata fields such as cuisine type (e.g., “Japanese,” “Tex-Mex”), dietary flags (e.g., “gluten-free,” “nut-free”), and item classification (e.g., “entree,” “side,” “beverage”). For example, if an item includes the description “Beef Bulgogi Bowl served with kimchi,” the tagging logic may apply cuisine_tag: Korean, protein_tag: beef, and side_included: true. Similarly, references to known allergens are extracted and applied to structured allergy tags, while promotional phrases (e.g., “family pack,” “lunch combo”) are translated into fulfillment modifiers or temporal constraints.

In certain embodiments, contextual tagging incorporates machine-learning inference, such as named entity recognition (NER) models trained on historical ingestion data. These models are operable to extract latent tags from freeform text, infer implicit serving sizes, and disambiguate multi-part item names. For instance, “Weekend Sushi Platter—16 pcs, Vegetarian and Seafood Mix” may be tagged with portion_servings: 2+, contains_fish: true, contains_vegetarian: true, and schedule_tag: weekend_only.

The metadata labeling process also links each item to merchant-specific fulfillment rules, pricing tier annotations, and participation eligibility constraints (e.g., splittable_by: up to 4 users, delivery_only: true). The resulting enriched item record reflects both normalized fields and layered contextual tags, enabling precise compatibility modeling and system-driven orchestration in subsequent stages.

At step 712, the system generates a structured item token for each normalized and enriched item record generated in steps 704 through 710. The token generation process is operable to consolidate canonical attributes, contextual tags, and merchant-defined constraints into a single machine-readable object that can be evaluated during compatibility resolution. The structured item token may be implemented as a JSON object, protocol buffer, or internal vector representation containing schema-conformant fields for item identifier, portion definitions, splittability flags, dietary categories, fulfillment modalities (e.g., pickup, delivery), merchant-specified limitations, and system-inferred eligibility tags.

In various embodiments, this tokenization process includes encoding field-level validation results, transformation lineage, and source metadata for auditability. For example, an item token for a “Large Veggie Pizza” may include a split factor of 4, merchant-specified rule restricting availability to weekends, and system-inferred tags such as “vegetarian” and “eligible for combo match.” The token may also include confidence scores for extracted attributes, positional provenance from OCR-processed input, and entity links to previously ingested canonical entries for match correlation.

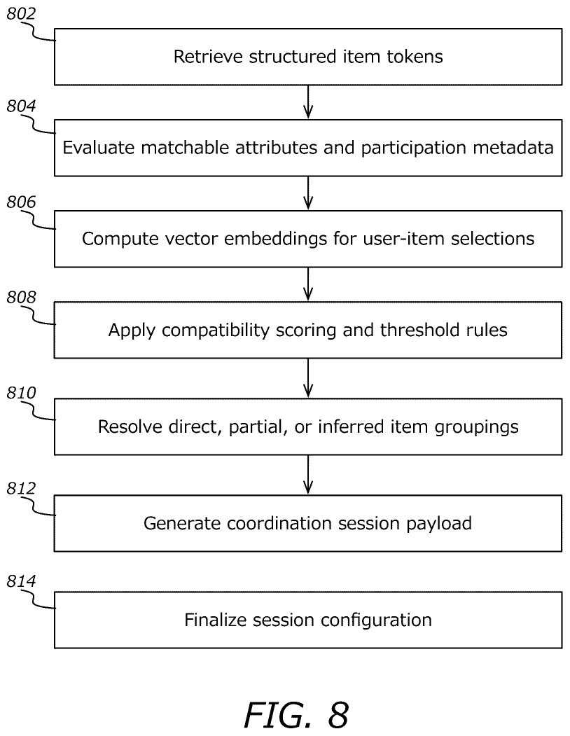

These structured tokens are indexed and stored for downstream compatibility evaluation, matching, and fulfillment orchestration processes described in FIG. 6 and FIG. 8. The item token serves as the representation used to compare across users, apply rule-based filters, and calculate alignment scores for group coordination workflows.

### C. Computer Implemented Process

FIG. 8 illustrates a process flow for compatibility grouping and coordination session resolution in accordance with various embodiments of the present disclosure. The illustrated steps may be performed by components including group coordination and session management component 208, item schema correlation and matching engine 307, match scoring and prioritization engine 308, preference synthesis and user compatibility module 318, and price allocation and cost-splitting engine 212, as described in FIG. 2 and FIG. 3. The process begins with the identification of item tokens across active sessions and proceeds through vector-based scoring, threshold evaluation, and iterative compatibility alignment, resulting in finalized session configurations. The resulting output enables the fulfillment and orchestration stages described in FIG. 6. The steps may be performed in a different order, with additional or fewer steps, as would be understood by one of ordinary skill in the art.

At step 802, structured item tokens are retrieved from the tokenization pipeline described in FIG. 7. These item tokens represent normalized, schema-aligned representations of merchant-defined offerings and serve as the input corpus for compatibility resolution. Each item token includes canonical fields encoding base attributes (e.g., item name, portion size, splittability constraints), contextual tags (e.g., dietary labels, cuisine type, availability windows), and merchant-defined fulfillment rules. The tokens may also include metadata such as confidence scores, source provenance, and compatibility eligibility flags generated during the ingestion and enrichment stages.

In various embodiments, item tokens are retrieved from intermediate memory structures or persisted item indexing systems, and may be grouped by restaurant, event ID, session state, or temporal constraints. For example, in response to a user creating or joining a coordination session, the system may retrieve a subset of item tokens associated with that session context, including both active selections and adjacent, splittable items from other users. These tokens are then supplied to the compatibility modeling components described in the following steps.

At step 804, the system evaluates each structured item token to extract matchable attributes and correlate them with current session participation metadata. Matchable attributes may include canonical fields such as portion size, dietary tags, item type, cuisine category, and splittability rules. These fields are identified by compatibility modeling logic as relevant for determining cross-user alignment. Participation metadata refers to the structured records received from user selections, including selected portions, item ranking preferences, group size indications, and session-specific constraints such as timing windows, delivery modality, or budget limits.

In various embodiments, the evaluation is performed using rule-based logic or attribute-weighted vectorization, depending on the matching mode selected for the coordination session. For example, if the session involves a shared sushi platter marked splittable-by-3, and three users have submitted intent records indicating interest in Japanese entrees, each requesting one-third of the platter, the system will extract and compare these structured declarations against the splittability constraints, availability window, and cuisine tag encoded in the item token.

This step serves as the preparation phase for vector embedding and scoring by aligning each item token with user-specific inputs and identifying dimensions over which compatibility evaluation is technically meaningful. These aligned inputs are passed forward to the vector embedding generation process at step 806.

At step 806, the system computes vector embeddings for each user-item selection record based on the aligned item token attributes and corresponding user participation metadata. These embeddings represent the structured selection intent of each user, projected into a multidimensional vector space for compatibility scoring. The vector embedding process may be performed using deterministic encoding logic, schema-aligned field mappings, or configurable feature-weighted projections depending on the token structure and session matching parameters.

In various embodiments, each embedding vector encodes scalar and categorical dimensions corresponding to canonical item token attributes (e.g., portion size=0.5, dietary_flag=vegetarian, cuisine=Thai), selection metadata (e.g., user_priority=2, price_tolerance=medium), and constraint vectors (e.g., delivery_required=true, time_window=[12:00-13:00]). These values are mapped into a normalized representation that supports pairwise similarity evaluation and alignment scoring in the subsequent step.

For example, if three users select a “Vegetarian Combo Platter” marked splittable by four, with varying portion sizes and dietary flags, the system computes an embedding for each user that reflects their declared preferences and constraints relative to the token. One user may specify a half portion with vegan-only requirements, while another may allow dairy and accept one-fourth. Each embedding reflects these distinctions in corresponding dimensions, enabling the next stage to compute degree of alignment across participants.

The resulting user-item selection embeddings form the input for compatibility vector comparison and scoring logic at step 808.

At step 808, the system applies compatibility scoring logic to the user-item selection embeddings generated in step 806 and evaluates whether the aggregated alignment across participants satisfies predefined matching thresholds. This step is operable to determine whether the current configuration of participant selections for a shared item meets the conditions for forming a valid coordination session under the system's schema and fulfillment constraints.

In an embodiment, compatibility scoring includes calculating pairwise or group-level similarity metrics across the user-item selection embeddings using vector distance functions (e.g., cosine similarity, weighted Euclidean distance), participation overlap functions, and constraint satisfaction rules. Each score represents the system-evaluated likelihood that the selections are compatible for matching, factoring in user preferences, portion share ratios, dietary restrictions, and fulfillment modality constraints encoded in the item tokens.

For example, if three users select a splittable meal item that permits up to four participants, the system evaluates whether the sum of declared portions meets the required portion total, whether all user dietary constraints are jointly satisfied by the token metadata, and whether other conditional requirements—such as time windows or delivery modality—are collectively compatible. If the alignment score exceeds a configured threshold value (e.g., ≥0.85 similarity or ≥100% portion coverage), the system considers the configuration eligible for matching.

In various embodiments, the system supports multiple threshold types, including: (i) hard constraints (e.g., sum (portion)=1.0), (ii) soft alignment thresholds (e.g., score≥threshold), and (iii) hybrid rules that incorporate both token-defined constraints and user-defined priority levels. If compatibility conditions are satisfied, the process proceeds to session assembly at step 810. Otherwise, the session remains open for continued user participation or may be re-evaluated with partial match logic as described in earlier components.

At step 810, the system resolves the final grouping of participants based on the compatibility scores and fulfillment constraints evaluated in step 808. This step is operable to generate match groupings for item tokens using direct match logic, partial overlap evaluation, or inferred compatibility based on item token metadata and participation vectors.

In an embodiment, direct grouping is performed when user selections satisfy all token-defined constraints with complete coverage. For example, if a splittable item token defines four equal portions and exactly four users each select one portion, the system groups those users into a finalized coordination session for that item.

For partial matches, the system applies logic to assess whether the current selections fall within an acceptable tolerance band for item fulfillment. For instance, if a five-portion item allows for fulfillment with at least three confirmed participants, and three users each select one portion, the system may resolve the partial match and reserve the remaining unclaimed portions using default handling rules—such as increasing the price per portion, allowing a guest participant, or returning the unmatched portion to the merchant-defined default offering.

Inferred groupings are resolved when users select different—but schema-correlated—items that share a fulfillment signature. For example, three users may independently select separate variations of a shared platter (e.g., “Combo A—Chicken,” “Combo A—Tofu,” and “Combo A—Shrimp”) that are all mapped to a shared token group via the item schema correlation and matching engine 307. The system infers compatibility based on shared fulfillment structure and allowable item variation rules, and resolves the inferred group accordingly.

In certain embodiments, resolution logic includes fallback strategies for unresolved portions, timeout thresholds for inactive sessions, and eligibility filters that apply merchant-defined policies for item availability, batchable quantity, or location-specific fulfillment. Resolved groupings are passed forward to session finalization logic at step 814.

At step 812, the system generates a coordination session payload comprising structured records that encode user assignments, item groupings, pricing responsibilities, and orchestration flags. This payload serves as the machine-readable representation of the finalized match state, enabling consistent downstream fulfillment, notification, and payment workflows.

In an embodiment, the session payload includes a session identifier, tokenized item references, per-user portion assignments, computed pricing breakdowns, and system-assigned orchestration instructions. The payload may be implemented as a structured object (e.g., JSON or protocol buffer) conforming to a schema used by downstream components such as order sequencing and fulfillment orchestration module 214, delivery partner API connector 502, and notification and alert module 218.

For example, if three users have been matched for a shared item with a split factor of 3, the payload includes a mapping of each user ID to their assigned portion index, the base item token ID, calculated cost share per participant (including optional modifiers or merchant-defined surcharges), and flags for pickup or delivery modality based on individual user preference metadata. The payload may also include delivery window constraints derived from timing synchronization module 506 or routing data from dynamic routing optimization engine 508.

In certain embodiments, the payload incorporates metadata for auditability, including timestamps, resolution logic type (e.g., direct, partial, inferred), token lineage, user selection vector hashes, and system-generated confirmation codes. These payloads are passed to orchestration engines to execute payment collection, restaurant preparation coordination, delivery scheduling, and user notification workflows.

At step 814, the system finalizes the coordination session configuration based on the generated session payload. This step includes persisting session data to appropriate datastores, confirming eligibility across all participants, and issuing orchestration instructions to downstream systems for fulfillment, payment, and status tracking.

In an embodiment, finalization includes marking the session as locked in the session lifecycle state model, committing session metadata to match outcome datastore 334, and broadcasting structured fulfillment instructions to integration components such as fulfillment integration interface component 204 and merchant-side structured data ingestion system 112. The session configuration includes encoded user-item assignments, cost allocation details, delivery or pickup modality parameters, and scheduling constraints as defined in the session payload.

For example, if a session involves four users sharing two separate items from different restaurants, the system finalizes the session by associating each user with their respective merchant assignment, transmitting item-specific fulfillment instructions with embedded portion configurations, and triggering alerts via notification and alert module 218. The system may also apply delivery constraint validation and route assignment rules using components of fulfillment routing and logistics interface system 111 (e.g., delivery eligibility and constraint validator 510, dynamic routing optimization engine 508).

In certain embodiments, finalization includes generating transactional records for payment processing, such as individual invoices linked to the pricing logic executed in step 616 of FIG. 6. The session may also include an expiration timer or reconfiguration logic in the event of non-payment or cancellation by one or more participants. Upon successful finalization, the session is marked as active or dispatched, and the corresponding orchestration workflows proceed to execution.

### D. Computer Implemented Process

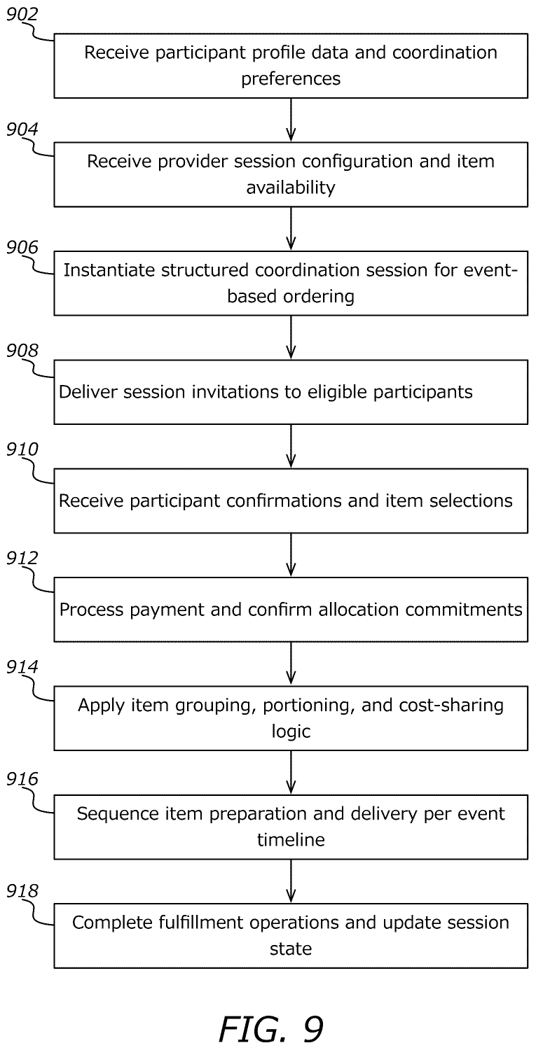

FIG. 9 illustrates a process flow for configuring, coordinating, and executing event-based order sessions in accordance with various embodiments of the present disclosure. In an embodiment, the steps shown in FIG. 9 are performed by components of multi-user coordination and data processing system 103, including event coordination engine 224, group coordination and session management component 208, price allocation and cost-splitting engine 212, order sequencing and fulfillment orchestration module 214, merchant integration interface component 202, and notification and alert module 218. The process enables structured event creation by third-party providers, tokenized item selection by users, rule-based group coordination, proportional pricing, and orchestration of fulfillment timelines. The process may include additional steps, fewer steps, or an alternative ordering of steps without departing from the scope of the invention.

At step 902, participant profile data and coordination preferences are received. This may include structured user attributes such as dietary restrictions, cost sensitivity, preferred fulfillment modality (e.g., pickup, delivery, on-site consumption), and participation windows. These inputs may be submitted during user onboarding or configured through editable profile settings and are stored within user preference datastore 330 for real-time eligibility filtering and session matchmaking. In various embodiments, preference records may include both static parameters (e.g., vegetarian preference) and dynamic intent signals (e.g., expressed interest in family-style portions for Friday evening).

At step 904, the system receives provider session configuration and item availability. In an embodiment, external providers—including but not limited to restaurants, caterers, retailers, or event hosts—submit session metadata, available item tokens, fulfillment constraints, and capacity limits. The configuration may specify temporal constraints (e.g., event start time, RSVP deadline), item-level restrictions (e.g., limited to shareable platters), or cost structures (e.g., minimum per-person spend). These submissions may be provided through merchant-side structured data ingestion system 112 and stored in structured menu metadata datastore 440 for compatibility with downstream coordination workflows.

At step 906, a structured coordination session is instantiated for the event-based ordering instance. The session includes a unique identifier, provider-defined parameters, eligible item tokens, and a list of invited participants. Session metadata may include maximum participant count, item access rules, and fulfillment modality flags. This coordination session is managed by group coordination and session management component 208 and enters a pending state until participant responses and selections are received.

At step 908, session invitations are delivered to eligible participants. In an embodiment, eligibility filtering is applied using criteria defined by the provider or system (e.g., proximity, dietary alignment, prior participation). The system formats and transmits structured invitations using notification and alert module 218 via one or more channels, such as in-app messages, push notifications, SMS, or email. Each invitation contains a session summary, available items, selection deadline, and fulfillment options. The invitation may include a deep link for immediate session joining and item selection.

At step 910, participant confirmations and item selections are received. Participants may browse available tokens for the session and submit structured selections with associated portion parameters (e.g., one-third of item X, full item Y). The system captures these submissions, updates the active session state, and marks participants as confirmed. In certain embodiments, participants may optionally specify backup choices, meal preferences, or fulfillment preferences to assist in group optimization and fallback orchestration.

At step 912, payment is processed and allocation commitments are confirmed. For each participant, the system computes a cost allocation stub using price allocation and cost-splitting engine 212 based on selected portions, applicable modifiers, and provider-defined fee logic. Participants are prompted to authorize payment using stored credentials or third-party payment gateways. Upon successful authorization, cost stubs are marked as locked, and funds are reserved or charged depending on the configuration. Payment metadata is stored for fulfillment coordination and audit logging.

At step 914, item grouping, portioning, and cost-sharing logic is applied to the confirmed selections. The system evaluates whether group threshold conditions are met (e.g., minimum total portion for a dish, minimum spend per participant) and performs compatibility modeling using match scoring and prioritization engine 308, partial match handler 314, and preference synthesis and user compatibility module 318. This step ensures that the event meets provider requirements and generates a finalized group configuration for fulfillment orchestration.

At step 916, item preparation and delivery is sequenced according to the event timeline. Order sequencing and fulfillment orchestration module 214 evaluates preparation time, pickup or delivery constraints, and location-based routing inputs to generate provider-specific fulfillment instructions. This includes timing windows, packaging instructions (e.g., split item labels), and coordination logic for group drop-offs or staggered pickup slots. Instructions are transmitted to the provider via merchant integration interface component 202 and to delivery vendors via fulfillment integration interface component 204.

At step 918, the system completes fulfillment operations and updates the coordination session state. Upon confirmation from the provider or delivery system (e.g., order packed, en route, delivered), the system logs fulfillment status, triggers user notifications, and transitions the session to a completed state. Final payment capture, refund reconciliation (if any), and feedback prompts are triggered. Metadata is persisted in session logs and system performance metadata log 338 for downstream analytics and future personalization.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments). Any of the above mentioned systems, units, modules, engines, controllers, components, process steps or the like may be and/or comprise hardware and/or software as described herein. For example, the systems, engines, and subcomponents described herein may be and/or comprise computing hardware and/or software as described herein in association with FIGS. 4-7. Furthermore, any of the above mentioned systems, units, modules, engines, controllers, components, interfaces or the like may use and/or comprise an application programming interface (API) for communicating with other systems units, modules, engines, controllers, components, interfaces or the like for obtaining and/or providing data or information.

Any of the systems, components, modules, engines, interfaces, or datastores described herein may be implemented in hardware, software, or any combination thereof. For example, the systems described in connection with merchant-side structured data ingestion system 112, fulfillment routing and logistics interface system 111, data processing and enrichment system 108, multi-user coordination and data processing system 103, payment processing system 114, and associated subcomponents illustrated across FIG. 1 through FIG. 9 may comprise one or more computing systems configured to execute machine-readable instructions, perform data processing operations, and manage data exchange. In various embodiments, the systems and components may include or utilize one or more application programming interfaces (APIs) to transmit or receive structured data, interface with external services, or coordinate internal operations among distinct modules described herein.

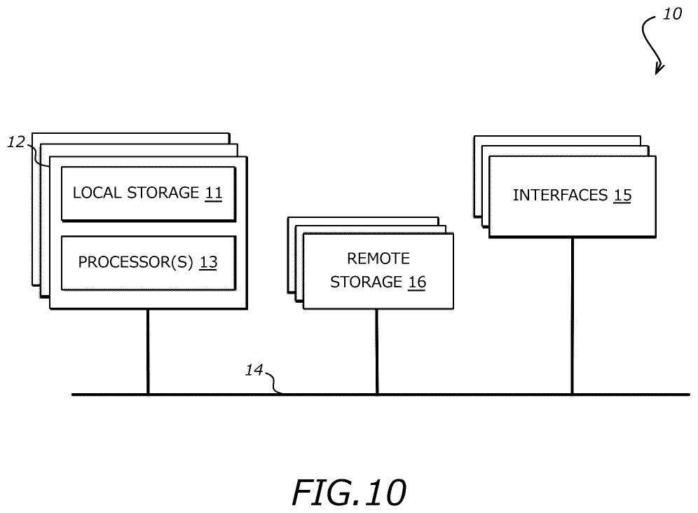

Referring now to FIG. 10, there is shown a block diagram depicting an exemplary computing device 10 suitable for implementing at least a portion of the features or functionalities disclosed herein. Computing device 10 may be, for example, any one of the computing machines listed in the previous paragraph, or indeed any other electronic device capable of executing software- or hardware-based instructions according to one or more programs stored in memory. Computing device 10 may be configured to communicate with a plurality of other computing devices, such as clients or servers, over communications networks such as a wide area network a metropolitan area network, a local area network, a wireless network, the Internet, or any other network, using known protocols for such communication, whether wireless or wired.

In one aspect, computing device 10 includes one or more central processing units (CPU) 12, one or more interfaces 15, and one or more busses 14 (such as a peripheral component interconnect (PCI) bus). When acting under the control of appropriate software or firmware, CPU 12 may be responsible for implementing specific functions associated with the functions of a specifically configured computing device or machine. For example, in at least one aspect, a computing device 10 may be configured or designed to function as a server system utilizing CPU 12, local memory 11 and/or remote memory 16, and interface(s) 15. In at least one aspect, CPU 12 may be caused to perform one or more of the different types of functions and/or operations under the control of software modules or components, which for example, may include an operating system and any appropriate applications software, drivers, and the like.

CPU 12 may include one or more processors 13 such as, for example, a processor from one of the Intel, ARM, Qualcomm, and AMD families of microprocessors. In some embodiments, processors 13 may include specially designed hardware such as application-specific integrated circuits (ASICs), electrically erasable programmable read-only memories (EEPROMs), field-programmable gate arrays (FPGAs), and so forth, for controlling operations of computing device 10. In a particular aspect, a local memory 11 (such as non-volatile random-access memory (RAM) and/or read-only memory (ROM), including for example one or more levels of cached memory) may also form part of CPU 12. However, there are many different ways in which memory may be coupled to system 10. Memory 11 may be used for a variety of purposes such as, for example, caching and/or storing data, programming instructions, and the like. It should be further appreciated that CPU 12 may be one of a variety of system-on-a-chip (SOC) type hardware that may include additional hardware such as memory or graphics processing chips, such as a QUALCOMM SNAPDRAGON™ or SAMSUNG EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one aspect, interfaces 15 are provided as network interface cards (NICs). Generally, NICs control the sending and receiving of data packets over a computer network; other types of interfaces 15 may for example support other peripherals used with computing device 10. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (WiFi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 15 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 10 illustrates one specific architecture for a computing device 10 for implementing one or more of the embodiments described herein, it is by no means the only device architecture on which at least a portion of the features and techniques described herein may be implemented. For example, architectures having one or any number of processors 13 may be used, and such processors 13 may be present in a single device or distributed among any number of devices. In one aspect, single processor 13 handles communications as well as routing computations, while in other embodiments a separate dedicated communications processor may be provided. In various embodiments, different types of features or functionalities may be implemented in a system according to the aspect that includes a client device (such as a tablet device or smartphone running client software) and server systems (such as a server system described in more detail below).

Regardless of network device configuration, the system of an aspect may employ one or more memories or memory modules (such as, for example, remote memory block 16 and local memory 11) configured to store data, program instructions for the general-purpose network operations, or other information relating to the functionality of the embodiments described herein (or any combinations of the above). Program instructions may control execution of or comprise an operating system and/or one or more applications, for example. Memory 16 or memories 11, 16 may also be configured to store data structures, configuration data, encryption data, historical system operations information, or any other specific or generic non-program information described herein.

Because such information and program instructions may be employed to implement one or more systems or methods described herein, at least some network device embodiments may include nontransitory machine-readable storage media, which, for example, may be configured or designed to store program instructions, state information, and the like for performing various operations described herein. Examples of such nontransitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a JAVA™ compiler and may be executed using a Java virtual machine or equivalent, or files containing higher level code that may be executed by the computer using an interpreter (for example, scripts written in Python, Perl, Ruby, Groovy, or any other scripting language).

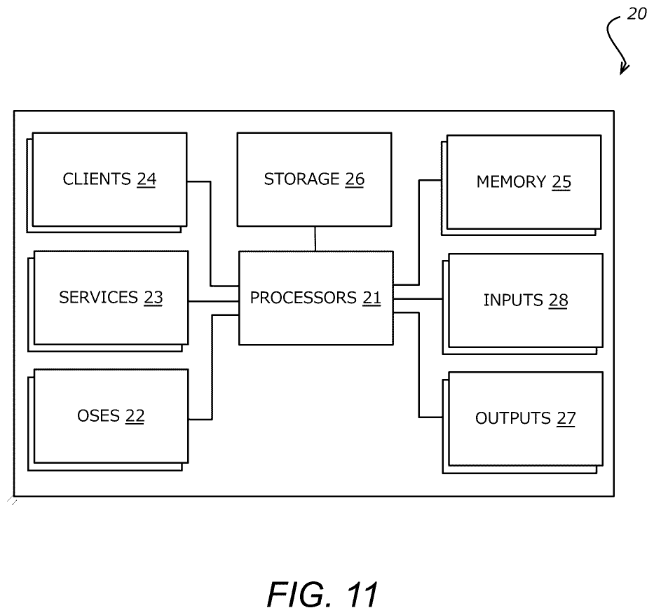

In some embodiments, systems may be implemented on a standalone computing system. Referring now to FIG. 11, there is shown a block diagram depicting a typical exemplary architecture of one or more embodiments or components thereof on a standalone computing system. Computing device 20 includes processors 21 that may run software that carry out one or more functions or applications of embodiments, such as for example a client application. Processors 21 may carry out computing instructions under control of an operating system 22 such as, for example, a version of MICROSOFT WINDOWS™ operating system, APPLE macOS™ or iOS™ operating systems, some variety of the Linux operating system, ANDROID™ operating system, or the like. In many cases, one or more shared services 23 may be operable in system 20, and may be useful for providing common services to client applications. Services 23 may for example be WINDOWS™ services, user-space common services in a Linux environment, or any other type of common service architecture used with operating system 21. Input devices 28 may be of any type suitable for receiving user input, including for example a keyboard, touchscreen, microphone (for example, for voice input), mouse, touchpad, trackball, or any combination thereof. Output devices 27 may be of any type suitable for providing output to one or more users, whether remote or local to system 20, and may include for example one or more screens for visual output, speakers, printers, or any combination thereof. Memory 25 may be random-access memory having any structure and architecture known in the art, for use by processors 21, for example to run software. Storage devices 26 may be any magnetic, optical, mechanical, memristor, or electrical storage device for storage of data in digital form (such as those described above, referring to FIG. 10). Examples of storage devices 26 include flash memory, magnetic hard drive, CD-ROM, and/or the like.

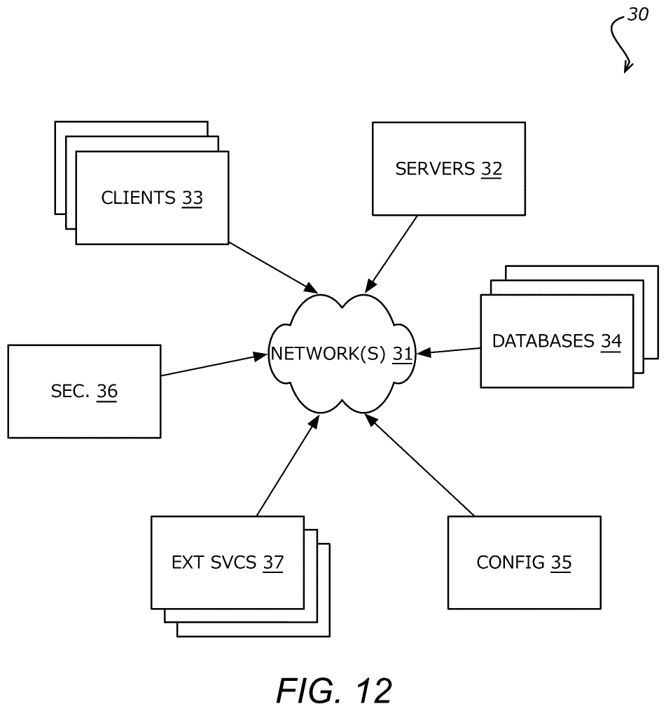

In some embodiments, systems may be implemented on a distributed computing network, such as one having any number of clients and/or servers. Referring now to FIG. 12, there is shown a block diagram depicting an exemplary architecture 30 for implementing at least a portion of a system according to one aspect on a distributed computing network. According to the aspect, any number of clients 33 may be provided. Each client 33 may run software for implementing client-side portions of a system; clients may comprise a system 20 such as that illustrated in FIG. 11. In addition, any number of servers 32 may be provided for handling requests received from one or more clients 33. Clients 33 and servers 32 may communicate with one another via one or more electronic networks 31, which may be in various embodiments any of the Internet, a wide area network, a mobile telephony network (such as CDMA or GSM cellular networks), a wireless network (such as WiFi, WiMAX, LTE, and so forth), or a local area network (or indeed any network topology known in the art; the aspect does not prefer any one network topology over any other). Networks 31 may be implemented using any known network protocols, including for example wired and/or wireless protocols.

In addition, in some embodiments, servers 32 may call external services 37 when needed to obtain additional information, or to refer to additional data concerning a particular call. Communications with external services 37 may take place, for example, via one or more networks 31. In various embodiments, external services 37 may comprise web-enabled services or functionality related to or installed on the hardware device itself. For example, in one aspect where client applications are implemented on a smartphone or other electronic device, client applications may obtain information stored in a server system 32 in the cloud or on an external service 37 deployed on one or more of a particular enterprise's or user's premises.

In some embodiments, clients 33 or servers 32 (or both) may make use of one or more specialized services or appliances that may be deployed locally or remotely across one or more networks 31. For example, one or more databases 34 may be used or referred to by one or more embodiments. It should be understood by one having ordinary skill in the art that databases 34 may be arranged in a wide variety of architectures and using a wide variety of data access and manipulation means. For example, in various embodiments one or more databases 34 may comprise a relational database system using a structured query language (SQL), while others may comprise an alternative data storage technology such as those referred to in the art as “NoSQL” (for example, HADOOP CASSANDRA™, GOOGLE BIGTABLE™, and so forth). In some embodiments, variant database architectures such as column-oriented databases, in-memory databases, clustered databases, distributed databases, or even flat file data repositories may be used according to the aspect. It will be appreciated by one having ordinary skill in the art that any combination of known or future database technologies may be used as appropriate, unless a specific database technology or a specific arrangement of components is specified for a particular aspect described herein. Moreover, it should be appreciated that the term “database” as used herein may refer to a physical database machine, a cluster of machines acting as a single database system, or a logical database within an overall database management system. Unless a specific meaning is specified for a given use of the term “database”, it should be construed to mean any of these senses of the word, all of which are understood as a plain meaning of the term “database” by those having ordinary skill in the art.

Similarly, some embodiments may make use of one or more security systems 36 and configuration systems 35. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments without limitation, unless a specific security 36 or configuration system 35 or approach is specifically required by the description of any specific aspect.

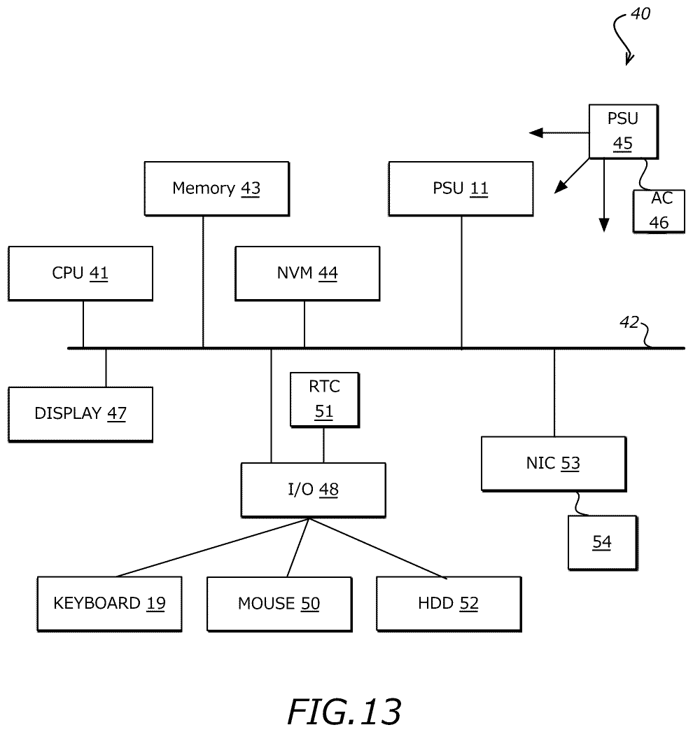

FIG. 13 shows an exemplary overview of a computer system 40 as may be used in any of the various locations throughout the system. It is exemplary of any computer that may execute code to process data. Various modifications and changes may be made to computer system 40 without departing from the broader scope of the system and method disclosed herein. Central processor unit (CPU) 41 is connected to bus 42, to which bus is also connected memory 43, nonvolatile memory 44, display 47, input/output (I/O) unit 48, and network interface card (NIC) 53. I/O unit 48 may, typically, be connected to keyboard 49, pointing device 50, hard disk 52, and real-time clock 51. NIC 53 connects to network 54, which may be the Internet or a local network, which local network may or may not have connections to the Internet. Also shown as part of system 40 is power supply unit 45 connected, in this example, to a main alternating current (AC) supply 46. Not shown are batteries that could be present, and many other devices and modifications that are well known but are not applicable to the specific novel functions of the current system and method disclosed herein. It should be appreciated that some or all components illustrated may be combined, such as in various integrated applications, for example Qualcomm or Samsung system-on-a-chip (SOC) devices, or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of various embodiments may be distributed among any number of client and/or server components. For example, various software modules may be implemented for performing various functions in connection with the system of any particular aspect, and such modules may be variously implemented to run on server and/or client components.

The skilled person will be aware of a range of possible modifications of the various embodiments described above. Accordingly, the present invention is defined by the claims and their equivalents.

### Additional Considerations

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and Bis false (or not present), A is false (or not present) and Bis true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and/or a process associated with the disclosed principles herein. Thus, while particular embodiments and applications have been illustrated and described, it is to be understood that the disclosed embodiments are not limited to the precise construction and components disclosed herein. Various apparent modifications, changes and variations may be made in the arrangement, operation and details of the method and apparatus disclosed herein without departing from the spirit and scope defined in the appended claims.

What is claimed is:

1. A computing system for generating fulfillment-ready coordination sessions based on tokenized item data and user participation inputs, the computing system comprising:
a processor; and
a memory storing instructions that, when executed by the processor, cause the computing system to:
obtain item data from one or more merchant sources, the item data comprising structured, semi-structured, or unstructured representations of physical items available for group fulfillment;
normalize the item data to generate one or more structured item representations, the one or more structured item representations comprising canonicalized attributes aligned to a predefined schema;
tokenize the one or more structured item representations into schema-aligned item tokens using machine-executed token construction logic;
receive user-submitted item selections and associated participation parameters, the associated participation parameters comprising user-submitted configuration inputs for portion selection, fulfillment modality, and eligibility conditions;
compute item and user vector embeddings based on the schema-aligned item tokens and the associated participation parameters;
apply machine-executed compatibility scoring logic to generate one or more compatibility scores based on the user vector embeddings, the machine-executed compatibility scoring logic comprising vector comparison operations, rule-based threshold evaluation, and partial match resolution;
evaluate whether the one or more compatibility scores and the associated participation parameters satisfy one or more session eligibility thresholds associated with the schema-aligned item tokens;
generate a coordination session payload comprising match results, pricing instructions, and fulfillment configuration metadata; and
issue orchestration instructions to one or more external fulfillment systems, the orchestration instructions comprising system-readable directives for routing, preparation timing, and delivery handling.

2. The computing system of claim 1, wherein normalizing the item data comprises:
receiving structured, semi-structured, or unstructured item data from merchant systems, including at least one of scanned menus, online APIs, or point-of-sale exports;
applying structured transformation logic to extract item attributes including item name, portion definition, splittability parameter, and fulfillment constraints; and
aligning extracted attributes to a schema using canonical field mapping, datatype coercion, and controlled vocabulary resolution.

3. The computing system of claim 1, wherein computing the item and the user vector embeddings comprises:
encoding the schema-aligned item tokens and the associated participation parameters into latent vector representations using a machine learning model trained on historical item selections and compatibility patterns; and
generating similarity metrics between user vectors and item vectors to determine compatibility alignment across multiple user submissions.

4. The computing system of claim 1, wherein applying the machine-executed compatibility scoring logic comprises:
executing vector comparison operations across item and user embeddings to generate match alignment scores;
evaluating each score against threshold rules comprising portion summation, configuration compatibility, and merchant-defined fulfillment constraints; and
resolving partial or incomplete matches using rule-based interpolation or inferred participation metadata.

5. The computing system of claim 1, wherein evaluating session eligibility thresholds comprises:
retrieving eligibility rules from the schema-aligned item tokens, the eligibility rules comprising minimum portion thresholds, user count constraints, or time-based participation conditions; and
determining that the eligibility rules are satisfied based on the one or more compatibility scores and the associated participation parameters associated with a proposed session.

6. The computing system of claim 1, wherein generating the coordination session payload comprises:
aggregating normalized item token attributes, resolved user selections, and compatibility results into a machine-readable session record; and
generating pricing allocation data based on configured item splits, modifiers, and merchant-defined constraints.

7. The computing system of claim 1, wherein issuing orchestration instructions comprises:
formatting the coordination session payload into a fulfillment-compatible message including routing metadata, preparation timing windows, and delivery options; and
transmitting the fulfillment-compatible message to one or more external delivery systems using an API interface.

8. The computing system of claim 1, wherein the orchestration instructions further comprise one or more of:
(i) a structured session identifier for downstream traceability,
(ii) item-to-user mapping for split item fulfillment, and
(iii) delivery routing preferences for group-coordinated handoff or drop-point consolidation.

9. The computing system of claim 1, wherein the coordination session payload further comprises:
compatibility confidence metrics, item fulfillment modality flags, and session lifecycle metadata indicating eligibility, match state, and fulfillment status.

10. The computing system of claim 1, wherein tokenizing the one or more structured item representations comprises:
constructing a machine-readable item token that encodes schema-aligned attributes, fulfillment constraints, and system-derived metadata into a structured object; and
storing the machine-readable the item token for use in compatibility evaluation and coordination session matching.

11. A computer-implemented method for generating fulfillment-ready coordination sessions based on tokenized item data and user participation inputs, the computer-implemented method comprising:
obtaining item data from one or more merchant sources, the item data comprising structured, semi-structured, or unstructured representations of physical items available for group fulfillment;
normalizing the item data to generate one or more structured item representations, the one or more structured item representations comprising canonicalized attributes aligned to a predefined schema;
tokenizing the one or more structured item representations into schema-aligned item tokens using machine-executed token construction logic;
receiving user-submitted item selections and associated participation parameters, the associated participation parameters comprising user-submitted configuration inputs for portion selection, fulfillment modality, and eligibility conditions;
computing item and user vector embeddings based on the schema-aligned item tokens and the associated participation parameters;
applying machine-executed compatibility scoring logic to generate one or more compatibility scores based on the vector embeddings, the machine-executed compatibility scoring logic comprising vector comparison operations, rule-based threshold evaluation, and partial match resolution;
evaluating whether the one or more compatibility scores and the associated participation parameters satisfy one or more session eligibility thresholds associated with the schema-aligned item tokens;
generating a coordination session payload comprising match results, pricing instructions, and fulfillment configuration metadata; and
issuing orchestration instructions to one or more external fulfillment systems, the orchestration instructions comprising system-readable directives for routing, preparation timing, and delivery handling.

12. The computer-implemented method of claim 11, wherein normalizing the item data comprises:
receiving structured, semi-structured, or unstructured item data from merchant systems, including at least one of scanned menus, online APIs, or point-of-sale exports;
applying structured transformation logic to extract item attributes including item name, portion definition, splittability parameter, and fulfillment constraints; and
aligning extracted attributes to a schema using canonical field mapping, datatype coercion, and controlled vocabulary resolution.

13. The computer-implemented method of claim 11, wherein computing the item and the user vector embeddings comprises:
encoding the schema-aligned item tokens and the associated participation parameters into latent vector representations using a machine learning model trained on historical item selections and compatibility patterns; and
generating similarity metrics between user vectors and item vectors to determine compatibility alignment across multiple user submissions.

14. The computer-implemented method of claim 11, wherein applying the machine-executed compatibility scoring logic comprises:
executing vector comparison operations across item and user embeddings to generate match alignment scores;
evaluating individual match alignment scores against threshold rules comprising portion summation, configuration compatibility, and merchant-defined fulfillment constraints; and
resolving partial or incomplete matches using rule-based interpolation or inferred participation metadata.

15. The computer-implemented method of claim 11, wherein generating the coordination session payload comprises:
aggregating normalized item token attributes, resolved user selections, and compatibility results into a machine-readable session record; and
generating pricing allocation data based on configured item splits, modifiers, and merchant-defined constraints.

16. The computer-implemented method of claim 11, wherein issuing orchestration instructions comprises:
formatting the coordination session payload into a fulfillment-compatible message including routing metadata, preparation timing windows, and delivery options; and
transmitting the fulfillment-compatible message to one or more external delivery systems using an API interface.

17. A non-transitory computer-readable storage medium storing instructions that, when executed by a processor, cause a computing system to:
obtain item data from one or more merchant sources, the item data comprising structured, semi-structured, or unstructured representations of physical items available for group fulfillment;
normalize the item data to generate one or more structured item representations, the structured item representations comprising canonicalized attributes aligned to a predefined schema;
tokenize the one or more structured item representations into schema-aligned item tokens using machine-executed token construction logic;
receive user-submitted item selections and associated participation parameters, the associated participation parameters comprising user-submitted configuration inputs for portion selection, fulfillment modality, and eligibility conditions;
compute item and user vector embeddings based on the schema-aligned item tokens and the associated participation parameters;
apply machine-executed compatibility scoring logic to generate one or more compatibility scores based on the user vector embeddings, the machine-executed compatibility scoring logic comprising vector comparison operations, rule-based threshold evaluation, and partial match resolution;
evaluate whether the machine-executed compatibility scores and the associated participation parameters satisfy one or more session eligibility thresholds associated with the schema-aligned item tokens;
generate a coordination session payload comprising match results, pricing instructions, and fulfillment configuration metadata; and
issue orchestration instructions to one or more external fulfillment systems, the orchestration instructions comprising system-readable directives for routing, preparation timing, and delivery handling.

18. The non-transitory computer-readable storage medium of claim 17, wherein the instructions further cause the computing system to:
apply structured transformation logic to extract item attributes including item name, portion definition, splittability parameter, and fulfillment constraints; and
align the item attributes to a schema using canonical field mapping, datatype coercion, and controlled vocabulary resolution.

19. The non-transitory computer-readable storage medium of claim 17, wherein the instructions further cause the computing system to:
generate geo-taste clustering metadata by correlating user location signals with historical item selections; and
apply the geo-taste clustering metadata to prioritize or promote item tokens within coordination sessions based on regional compatibility patterns.

20. The non-transitory computer-readable storage medium of claim 17, wherein the instructions further cause the computing system to:
extract vector-based user profile embeddings from social interaction metadata, including prior group sessions, friend network selections, and observed co-ordering behaviors; and
apply social vector similarity scoring to influence compatibility evaluation and grouping logic for active coordination sessions.

21. The non-transitory computer-readable storage medium of claim 17, wherein the instructions further cause the computing system to surface one or more coordination sessions to users located within a defined geographic radius based on shared item preferences and historical match behavior associated with the user vector embeddings.

22. The non-transitory computer-readable storage medium of claim 17, wherein the instructions further cause the computing system to attribute a coordination session initiation to a referring user account and to allocate one or more rewards comprising digital assets or fiat currency upon fulfillment completion of the coordination session.

23. The non-transitory computer-readable storage medium of claim 17, wherein the orchestration instructions include one or more upsell options triggered based on merchant-defined rules associated with a participant count or selected item modifiers.

24. The non-transitory computer-readable storage medium of claim 17, wherein the instructions further cause the computing system to convert a coordination session to a solo execution mode if one or more fulfillment thresholds are not satisfied within a configured timeout period.
